(19) United States
(12) Patent Application Publication
(10) Pub. No.: US 2025/0254570 A1
(43) Pub. Date: Aug. 7, 2025

(54) IAB Node Signaling

(71) Applicant: Telefonaktiebolaget LM Ericsson (publ), Stockholm (SE)

(72) Inventors: Marco Belleschi, Solna (SE); Boris Dortschy, Vendelsö (SE); Magnus Åström, Lund (SE); Mattias Bergström, Singapore (SG); Lei Bao, Göteborg (SE)

(21) Appl. No.: 18/856,935

(22) PCT Filed: Apr. 20, 2023
(86) PCT No.: PCT/SE2023/050364

§ 371 Date: Oct. 15, 2024

Related U.S. Application Data
(60) Provisional application No. 63/333,503, filed on Apr. 21, 2022.

(51) Int. Cl. H04W 28/26; H04W 72/0446; H04W 72/23

(52) U.S. Cl. CPC H04W 28/26; H04W 72/0446; H04W 72/23

(57) ABSTRACT

A method performed by a first integrated access backhaul, IAB, node (12A). The first IAB node (12A) receives, from an IAB donor (14), signaling (19) that indicates which one or more possible values (18-1 . . . 18-X) of a field (18) are mapped to which one or more possible values (20-1 . . . 20-M) of a multiplexing adaptation parameter (20). In some embodiments, the multiplexing adaptation parameter (20) facilitates or governs adaptation of in which multiplexing mode, if any, a multiplexing IAB node operates for multiplexing communication on a parent IAB link with communication on a child IAB link. The first IAB node (12A) also transmits to, or receives from, a second IAB node (12B) a message (16) that includes the field (18) set to one of the one or more possible values (18-1 . . . 18-X) of the field (18) indicated by the signaling (19). In some embodiments, the multiplexing IAB node is the first IAB node (12A) or the second IAB node (12B).

### TECHNICAL FIELD

The present application relates generally to an integrated access backhaul, IAB, and relates more particularly to IAB node signaling.

### BACKGROUND

A split radio network architecture splits radio network equipment (e.g., a base station) into a so-called central unit (CU) and one or more so-called distributed units (DUs). The central unit terminates higher layer and/or less time-critical protocols, such as the Packet Data Convergence Protocol (PDCP) and Radio Resource Control (RRC) protocols towards a wireless device. The central unit also controls the operations of the distributed unit(s). A distributed unit by contrast terminates lower layer and/or more time-critical protocols, such as the Radio Link Control (RLC), Medium Access Control (MAC), and physical layer protocols.

The split radio network architecture may be applied to an integrated access backhaul (IAB) where some radio resources are used for the access link to wireless devices and some radio resources are also used for the backhaul link between radio network equipment. Such IAB may be used for instance to connect small cells to the network, instead of requiring fiber connections to the many small cells. With IAB, one or more so-called IAB nodes may be chained underneath an IAB donor. Each IAB node holds a DU and a mobile termination (MT). Via the MT, the IAB node communicates over a parent IAB link to a parent IAB node, which may be an upstream IAB node or the IAB donor. Via the DU, the IAB node communicates over a child IAB link with a child IAB node, e.g., to an MT of a downstream IAB node. The IAB donor also holds a DU to support UEs and MTs of downstream IAB nodes. The IAB donor further holds a CU for the DUs of all IAB nodes and for its own DU.

An IAB node may be capable of operating in a multiplexing mode in which the IAB node multiplexes communication on the parent IAB link with communication on the child IAB link, e.g., using time-division multiplexing (TDM), frequency division multiplexing (FDM), spatial division multiplexing (SDM), or a combination thereof. The IAB node may in fact support multiple different multiplexing modes that multiplex communication on the parent IAB link with communication on the child IAB link in different ways, e.g., one mode that uses TDM, another mode that uses FDM, another mode that uses SDM, etc. In this case, then, the IAB node may be capable of adapting in which multiplexing mode (if any) the IAB node operates.

In this context, the IAB node may communicate with its parent IAB node as needed to facilitate adaptation of in which multiplexing mode the IAB node operates. Such communication may for instance involve transmission or reception of a medium access control (MAC) message that indicates a multiplexing adaptation parameter, e.g., a condition parameter and/or an association parameter. However, given the large number of possible values for such a parameter, communicating such a multiplexing adaptation parameter efficiently in terms of signaling overhead proves challenging.

### SUMMARY

According to some embodiments herein, an IAB donor configures (e.g., via radio resource control, RRC, signaling) which one or more possible values of a field of a message (e.g., a medium access control, MAC, message) are mapped to which one or more possible values of a parameter. The message may then be communicated between IAB nodes on the basis of that configuration, e.g., with the field of the message set to one of the one or more possible values configured.

In some embodiments, the one or more possible values of the parameter to which the one or more possible values of the field are mapped comprise a subset of a set of multiple possible values of the parameter. In these and other embodiments, then, the field of the message may be sized (e.g., in terms of bit length) to signal any one of the possible value(s) in the subset, rather than to signal any one of the possible values in the full set. The field of the message may thereby be smaller than would otherwise be required. Some embodiments thereby facilitate signaling the parameter between IAB nodes with lower signaling overhead.

More particularly, embodiments herein include a method performed by a first integrated access backhaul, IAB, node. The method includes receiving, from an IAB donor, signaling that indicates which one or more possible values of a field are mapped to which one or more possible values of a multiplexing adaptation parameter. In some embodiments, the multiplexing adaptation parameter facilitates or governs adaptation of in which multiplexing mode, if any, a multiplexing IAB node operates for multiplexing communication on a parent IAB link with communication on a child IAB link. The method also includes transmitting to, or receiving from, a second IAB node a message that includes the field set to one of the one or more possible values of the field indicated by the signaling. In some embodiments, the multiplexing IAB node is the first IAB node or the second IAB node.

In some embodiments, the one or more possible values of the multiplexing adaptation parameter to which the one or more possible values of the field are mapped comprise a subset of a set of multiple possible values of the multiplexing adaptation parameter.

In some embodiments, the signaling is upper layer signaling transmitted at an upper layer of a protocol stack, wherein the upper layer is above a layer at which the message is transmitted or received on the interface between the first and second IAB nodes.

In some embodiments, the signaling is radio resource control signaling, and wherein the message is a medium access control, MAC, message.

In some embodiments, the multiplexing IAB node is the first IAB node. In some embodiments, the method further comprises, based on or according to the value of the multiplexing adaptation parameter to which the value of the field included in the message is mapped, adapting in which multiplexing mode the first IAB node operates.

In some embodiments, the multiplexing adaptation parameter is an association parameter indicating one or more indices of one or more time slots associated with a condition that has been applied, or that is requested to be applied, in order for the multiplexing IAB node to operate in a multiplexing mode. In some embodiments, the multiplexing IAB node comprises a mobile termination, MT, and a distributed unit, DU. In some embodiments, the condition is restriction of simultaneous transmission at the multiplexing IAB node in the direction of one or more beams of the DU. In other embodiments, the condition is use of one or more specified beams by the MT for communication on the parent IAB link. In yet other embodiments, the condition is adjustment of a downlink transmission power by the parent IAB node. In still yet other embodiments, the condition is power spectral density, PSD, of the MT being within a specified range. In still yet other embodiments, the condition is use of certain timing modes in certain respective time slots. In still yet other embodiments, the condition is a combination of any two or more of the above.

In some embodiments, the multiplexing adaptation parameter is a condition parameter indicating a condition that has been applied, or that is requested to be applied, in order for the multiplexing IAB node to operate in a multiplexing mode. In some embodiments, the multiplexing IAB node comprises a mobile termination, MT, and a distributed unit, DU. In some embodiments, the condition is restriction of simultaneous transmission at the multiplexing IAB node in the direction of one or more beams of the DU. In other embodiments, the condition is use of one or more specified beams by the MT for communication on the parent IAB link. In yet other embodiments, the condition is adjustment of a downlink transmission power by the parent IAB node. In still yet other embodiments, the condition is power spectral density, PSD, of the MT being within a specified range. In still yet other embodiments, the condition is use of certain timing modes in certain respective time slots. In still yet other embodiments, the condition is a combination of any two or more of the above.

In some embodiments, the message is a first message. In some embodiments, the method further comprises receiving, from the IAB donor, signaling that changes which one or more possible values of the field are mapped to which one or more possible values of the multiplexing adaptation parameter. In some embodiments, the method further comprises transmitting to, or receiving from, the second IAB node a second message that includes the field set to one of the one or more possible values of the field as changed by the signaling.

In some embodiments, the parent IAB link is a link between the multiplexing IAB node and a parent IAB node. In some embodiments, the child IAB link is a link between the multiplexing IAB node and a child IAB node. In some embodiments, the multiplexing IAB node is capable of operating in any one of multiple possible multiplexing modes. In some embodiments, the multiple possible multiplexing modes include at least a TDM mode in which the multiplexing IAB node uses time-domain multiplexing, TDM, to multiplex communication by the MT on the parent IAB link towards the parent IAB node with communication by the DU on the child IAB link towards the child IAB node. In some embodiments, the multiple possible multiplexing modes include at least an FDM mode in which the multiplexing IAB node uses frequency-domain multiplexing, FDM, to multiplex communication by the MT on the parent IAB link towards the parent IAB node with communication by the DU on the child IAB link towards the child IAB node. In some embodiments, the multiple possible multiplexing modes include at least an SDM mode in which the multiplexing IAB node uses spatial-domain multiplexing, SDM, to multiplex communication by the MT on the parent IAB link towards the parent IAB node with communication by the DU on the child IAB link towards the child IAB node. In some embodiments, the multiple possible multiplexing modes include at least a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

Other embodiments herein include a method performed by an integrated access backhaul, IAB, donor. The method comprises transmitting, to a first IAB node and/or a second IAB node, signaling that indicates which one or more possible values of a field are mapped to which one or more possible values of a multiplexing adaptation parameter. In some embodiments, the multiplexing adaptation parameter governs adaptation of in which multiplexing mode, if any, a multiplexing IAB node operates for multiplexing communication on a parent IAB link with communication on a child IAB link. In some embodiments, the field is a field of a message on an interface between the first IAB node and the second IAB node.

In some embodiments, the one or more possible values of the multiplexing adaptation parameter to which the one or more possible values of the field are mapped comprise a subset of a set of multiple possible values of the multiplexing adaptation parameter.

In some embodiments, the signaling is upper layer signaling transmitted at an upper layer of a protocol stack. In some embodiments, the upper layer is above a layer at which the message is transmitted or received on the interface between the first and second IAB nodes.

In some embodiments, the signaling is radio resource control signaling, and the message is a medium access control, MAC, message.

In some embodiments, the multiplexing adaptation parameter is an association parameter indicating one or more indices of one or more time slots associated with a condition that has been applied, or that is requested to be applied, in order for the multiplexing IAB node to operate in a multiplexing mode. In some embodiments, the multiplexing IAB node comprises a mobile termination, MT, and a distributed unit, DU. In some embodiments, the condition is restriction of simultaneous transmission at the multiplexing IAB node in the direction of one or more beams of the DU. In other embodiments, the condition is use of one or more specified beams by the MT for communication on the parent IAB link. In yet other embodiments, the condition is adjustment of a downlink transmission power by the parent IAB node. In still yet other embodiments, the condition is power spectral density, PSD, of the MT being within a specified range. In still yet other embodiments, the condition is use of certain timing modes in certain respective time slots. In still yet other embodiments, the condition is a combination of any two or more of the above.

In some embodiments, the multiplexing adaptation parameter is a condition parameter indicating a condition that has been applied, or that is requested to be applied, in order for the multiplexing IAB node to operate in a multiplexing mode. In some embodiments, the multiplexing IAB node comprises a mobile termination, MT, and a distributed unit, DU. In some embodiments, the condition is restriction of simultaneous transmission at the multiplexing IAB node in the direction of one or more beams of the DU. In other embodiments, the condition is use of one or more specified beams by the MT for communication on the parent IAB link. In yet other embodiments, the condition is adjustment of a downlink transmission power by the parent IAB node. In still yet other embodiments, the condition is power spectral density, PSD, of the MT being within a specified range. In still yet other embodiments, the condition is use of certain timing modes in certain respective time slots. In still yet other embodiments, the condition is a combination of any two or more of the above.

In some embodiments, the method further comprises, based on or according to the value of the multiplexing adaptation parameter to which the value of the field included in the message is mapped, adapting a configuration of the IAB donor.

In some embodiments, the message is a first message. In some embodiments, the method further comprises transmitting, to the first IAB node and/or the second IAB node, signaling that changes which one or more possible values of the field are mapped to which one or more possible values of the multiplexing adaptation parameter.

In some embodiments, the parent IAB link is a link between the multiplexing IAB node and a parent IAB node. In some embodiments, the child IAB link is a link between the multiplexing IAB node and a child IAB node. In some embodiments, the multiplexing IAB node is capable of operating in any one of multiple possible multiplexing modes. In some embodiments, the multiple possible multiplexing modes include at least a TDM mode in which the multiplexing IAB node uses time-domain multiplexing, TDM, to multiplex communication by the MT on the parent IAB link towards the parent IAB node with communication by the DU on the child IAB link towards the child IAB node. In some embodiments, the multiple possible multiplexing modes include at least an FDM mode in which the multiplexing IAB node uses frequency-domain multiplexing, FDM, to multiplex communication by the MT on the parent IAB link towards the parent IAB node with communication by the DU on the child IAB link towards the child IAB node. In some embodiments, the multiple possible multiplexing modes include at least an SDM mode in which the multiplexing IAB node uses spatial-domain multiplexing, SDM, to multiplex communication by the MT on the parent IAB link towards the parent IAB node with communication by the DU on the child IAB link towards the child IAB node. In some embodiments, the multiple possible multiplexing modes include at least a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

In some embodiments, the method further comprises selecting which one or more possible values of the field are mapped to which one or more possible values of the multiplexing adaptation parameter. In some embodiments, the method further comprises generating a mapping that maps one or more possible values of the field to one or more possible values of the multiplexing adaptation parameter according to said selecting. In some embodiments, the signaling indicates the mapping.

Other embodiments herein include a first integrated access backhaul, IAB, node. The first IAB node is configured to receive, from an IAB donor, signaling that indicates which one or more possible values of a field are mapped to which one or more possible values of a multiplexing adaptation parameter. In some embodiments, the multiplexing adaptation parameter governs adaptation of in which multiplexing mode, if any, a multiplexing IAB node operates for multiplexing communication on a parent IAB link with communication on a child IAB link. The first IAB node is also configured to transmit to, or receiving from, a second IAB node a message that includes the field set to one of the one or more possible values of the field indicated by the signaling, wherein the multiplexing IAB node is the first IAB node or the second IAB node.

In some embodiments, the first IAB node is configured to perform the steps described above for a first IAB node.

Other embodiments herein include an integrated access backhaul, IAB, donor. The IAB donor is configured to transmit, to a first IAB node and/or a second IAB node, signaling that indicates which one or more possible values of a field are mapped to which one or more possible values of a multiplexing adaptation parameter. In some embodiments, the multiplexing adaptation parameter governs adaptation of in which multiplexing mode, if any, a multiplexing IAB node operates for multiplexing communication on a parent IAB link with communication on a child IAB link. In some embodiments, the field is a field of a message on an interface between the first IAB node and the second IAB node.

In some embodiments, the IAB donor is configured to perform the steps described above for an IAB donor.

In some embodiments, a computer program comprising instructions which, when executed by at least one processor of a first IAB node, causes the first IAB node to perform the steps described above for a first IAB node. In some embodiments, a computer program comprising instructions which, when executed by at least one processor of a IAB donor, causes the IAB donor to perform the steps described above for an IAB donor. In some embodiments, a carrier containing the computer program is one of an electronic signal, optical signal, radio signal, or computer readable storage medium.

Other embodiments herein include a first integrated access backhaul, IAB, node. The first IAB node comprises communication circuitry and processing circuitry. The processing circuitry is configured to receive, from an IAB donor, signaling that indicates which one or more possible values of a field are mapped to which one or more possible values of a multiplexing adaptation parameter. In some embodiments, the multiplexing adaptation parameter governs adaptation of in which multiplexing mode, if any, a multiplexing IAB node operates for multiplexing communication on a parent IAB link with communication on a child IAB link. The processing circuitry is also configured to transmit to, or receiving from, a second IAB node a message that includes the field set to one of the one or more possible values of the field indicated by the signaling. In some embodiments, the multiplexing IAB node is the first IAB node or the second IAB node.

In some embodiments, the processing circuitry is configured to perform the steps described above for a first IAB node.

Other embodiments herein include an integrated access backhaul, IAB, donor. The first IAB donor comprises communication circuitry and processing circuitry. The processing circuitry is configured to transmit, to a first IAB node and/or a second IAB node, signaling that indicates which one or more possible values of a field are mapped to which one or more possible values of a multiplexing adaptation parameter. In some embodiments, the multiplexing adaptation parameter governs adaptation of in which multiplexing mode, if any, a multiplexing IAB node operates for multiplexing communication on a parent IAB link with communication on a child IAB link. In some embodiments, the field is a field of a message on an interface between the first IAB node and the second IAB node.

In some embodiments, the processing circuitry is configured to perform the steps described above for an IAB donor.

Other embodiments herein include a method performed by a first integrated access backhaul, IAB, node. The method comprises receiving, from an IAB donor, signaling that indicates which one or more possible values of a field are mapped to which one or more possible values of a parameter. The method also comprises transmitting to, or receiving from, a second IAB node a message that includes the field set to one of the one or more possible values of the field indicated by the signaling.

In some embodiments, the one or more possible values of the parameter to which the one or more possible values of the field are mapped comprise a subset of multiple possible values of the parameter.

In some embodiments, the signaling is upper layer signaling received at an upper layer of a protocol stack. In this case, the upper layer is above a layer at which the message is transmitted or received.

In some embodiments, the signaling is radio resource control signaling, F1 signaling, or operation and maintenance signaling.

In some embodiments, the signaling is received from a central unit, CU, of the IAB donor.

In some embodiments, the message is a medium access control, MAC, message or a downlink control information, DCI, message.

In some embodiments, the field is included in a MAC control element, CE, of a MAC message.

In some embodiments, the parameter indicates a configuration according to which the first IAB node or the second IAB node operates or is requested to operate.

In some embodiments, the parameter indicates a configuration according to which the first IAB node or the second IAB node operates, or is requested to operate, in order for a multiplexing IAB node to operate in a multiplexing mode. In some embodiments, a multiplexing mode is a mode in which the multiplexing IAB node multiplexes communication on a parent IAB link with communication on a child IAB link. In some embodiments, the multiplexing IAB node is the first IAB node or the second IAB node.

In some embodiments, the parameter is a multiplexing adaptation parameter that facilitates or governs adaptation of in which multiplexing mode, if any, a multiplexing IAB node operates. In some embodiments, the multiplexing IAB node is an IAB node capable of operating in a multiplexing mode. In some embodiments, a multiplexing mode is a mode in which the multiplexing IAB node multiplexes communication on a parent IAB link with communication on a child IAB link. In some embodiments, the parent IAB link is a link between the multiplexing IAB node and a parent IAB node. In some embodiments, the child IAB link is a link between the multiplexing IAB node and a child IAB node. In some embodiments, the multiplexing IAB node is the first IAB node or the second IAB node. In one or more of these embodiments, the multiplexing adaptation parameter is a condition parameter indicating a condition that has been applied, or that is requested to be applied, in order for the multiplexing IAB node to operate in a multiplexing mode. In one or more of these embodiments, the multiplexing IAB node comprises a mobile termination, MT, and a distributed unit, DU. In some embodiments, the condition is restriction of simultaneous transmission at the multiplexing node in the direction of one or more beams of the DU. Alternatively, the condition is use of one or more specified beams by the MT for communication on the parent IAB link. Alternatively, the condition is adjustment of a downlink transmission power by the parent IAB node. Alternatively, the condition is power spectral density, PSD, of the MT being within a specified range. Alternatively, the condition is use of certain timing modes in certain respective time slots. Alternatively, the condition is a combination of any two or more of the above. In one or more of these embodiments, the multiplexing adaptation parameter is an association parameter indicating one or more times, frequencies, and/or cells associated with a condition that has been applied, or that is requested to be applied, in order for the multiplexing IAB node to operate in a multiplexing mode. In one or more of these embodiments, the association parameter indicates one or more indices of one or more time slots associated with the condition. In one or more of these embodiments, the association parameter indicates one or more distributed unit, DU, resource configurations associated with the condition. In one or more of these embodiments, the association parameter indicates one or more carrier-cell pairs associated with the condition. In some embodiments, each of the one or more carrier-cell pairs is a pair of an IAB mobile termination component carrier and an IAB distributed unit cell. In one or more of these embodiments, the multiplexing adaptation parameter is an association parameter indicating a multiplexing mode associated with a condition that has been applied, or that is requested to be applied, in order for the multiplexing IAB node to operate in the indicated multiplexing mode.

In some embodiments, the multiplexing IAB node comprises a mobile termination, MT, and a distributed unit, DU. In some embodiments, the multiplexing IAB node is configured to multiplex communication by the MT on the parent IAB link towards the parent IAB node with communication by the DU on the child IAB link towards the child IAB node. In one or more of these embodiments, the multiplexing IAB node is capable of operating in any one of multiple possible multiplexing modes. In some embodiments, the multiple possible multiplexing modes include at least a TDM mode in which the multiplexing IAB node uses time-domain multiplexing, TDM, to multiplex communication by the MT on the parent IAB link towards the parent IAB node with communication by the DU on the child IAB link towards the child IAB node. Additionally or alternatively, the multiple possible multiplexing modes include at least an FDM mode in which the multiplexing IAB node uses frequency-domain multiplexing, FDM, to multiplex communication by the MT on the parent IAB link towards the parent IAB node with communication by the DU on the child IAB link towards the child IAB node. Additionally or alternatively, the multiple possible multiplexing modes include at least an SDM mode in which the multiplexing IAB node uses spatial-domain multiplexing, SDM, to multiplex communication by the MT on the parent IAB link towards the parent IAB node with communication by the DU on the child IAB link towards the child IAB node. Additionally or alternatively, the multiple possible multiplexing modes include at least a combination mode in which the multiplexing IAB node uses a combination of two or more of TDM, FDM, and SDM to multiplex communication by the MT on the parent IAB link towards the parent IAB node with communication by the DU on the child IAB link towards the child IAB node. In one or more of these embodiments, the multiplexing IAB node is configured to multiplex transmission by the MT on the parent IAB link towards the parent IAB node with transmission by the DU on the child IAB link towards the child IAB node. In some embodiments, the multiplexing IAB node is configured to multiplex transmission by the MT on the parent IAB link towards the parent IAB node with reception by the DU on the child IAB link towards the child IAB node. In some embodiments, the multiplexing IAB node is configured to multiplex reception by the MT on the parent IAB link towards the parent IAB node with transmission by the DU on the child IAB link towards the child IAB node. In some embodiments, the multiplexing IAB node is configured to multiplex reception by the MT on the parent IAB link towards the parent IAB node with reception by the DU on the child IAB link towards the child IAB node.

In some embodiments, the multiplexing IAB node is the first IAB node. In one or more of these embodiments, the method further comprises, based on or according to the value of the parameter indicated by the message, adapting in which multiplexing mode the first IAB node operates.

In some embodiments, the first IAB node is the parent IAB node. In one or more of these embodiments, the method further comprises, based on or according to the value of the parameter indicated by the message, adapting a configuration of the first IAB node.

In some embodiments, the field is an identity, ID, field or an index field.

In some embodiments, the message is a first message. In some embodiments, the method further comprises receiving, from the IAB donor, signaling that changes which one or more possible values of the field are mapped to which one or more possible values of the parameter. In some embodiments, the method further comprises transmitting to, or receiving from, the second IAB node a second message that includes the field set to one of the one or more possible values of the field indicated by the signaling.

In some embodiments, the field is a first field and the parameter is a first parameter. In some embodiments, the method further comprises receiving, from the IAB donor, signaling that indicates which one or more possible values of a second field are mapped to which one or more possible values of a second parameter. In some embodiments, the message further includes the second field set to one of the one or more possible values of the second field indicated by the signaling.

In some embodiments, the signaling comprises a mapping between the one or more possible values of the field to the one or more possible values of the parameter.

In some embodiments, the parameter is a beam configuration parameter.

In some embodiments, the parameter is a beam configuration for a certain distributed unit, DU, cell.

In some embodiments, the first IAB node is a parent IAB node with respect to the second IAB node.

In some embodiments, the first IAB node is a child IAB node with respect to the second IAB node.

In some embodiments, the IAB donor is the second IAB node.

Other embodiments herein include a method performed by a donor integrated access backhaul, IAB, node configured for use in a communication network. The method comprises transmitting, to a first IAB node and/or a second IAB node, signaling that indicates which one or more possible values of a field are mapped to which one or more possible values of a parameter. In some embodiments, the field is a field of a message on an interface between the first IAB node and the second IAB node

In some embodiments, the one or more possible values of the parameter to which the one or more possible values of the field are mapped comprise a subset of multiple possible values of the parameter.

In some embodiments, the signaling is upper layer signaling transmitted at an upper layer of a protocol stack. In some embodiments, the upper layer is above a layer at which the message is transmitted or received on the interface between the first and second IAB nodes.

In some embodiments, the signaling is radio resource control signaling, F1 signaling, or operation and maintenance signaling.

In some embodiments, the signaling is transmitted by a central unit, CU, of the IAB donor.

In some embodiments, the message is a medium access control, MAC, message or a downlink control information, DCI, message.

In some embodiments, the field is included in a MAC control element, CE, of a MAC message.

In some embodiments, the parameter indicates a configuration according to which the first IAB node or the second IAB node operates or is requested to operate.

In some embodiments, the parameter indicates a configuration according to which the first IAB node or the second IAB node operates, or is requested to operate, in order for a multiplexing IAB node to operate in a multiplexing mode. In some embodiments, a multiplexing mode is a mode in which the multiplexing IAB node multiplexes communication on a parent IAB link with communication on a child IAB link. In some embodiments, the multiplexing IAB node is the first IAB node or the second IAB node.

In some embodiments, the parameter is a multiplexing adaptation parameter that facilitates or governs adaptation of in which multiplexing mode, if any, a multiplexing IAB node operates. In some embodiments, the multiplexing IAB node is an IAB node capable of operating in a multiplexing mode. In some embodiments, a multiplexing mode is a mode in which the multiplexing IAB node multiplexes communication on a parent IAB link with communication on a child IAB link. In some embodiments, the parent IAB link is a link between the multiplexing IAB node and a parent IAB node. In some embodiments, the child IAB link is a link between the multiplexing IAB node and a child IAB node. In some embodiments, the multiplexing IAB node is the first IAB node or the second IAB node. In one or more of these embodiments, the multiplexing adaptation parameter is a condition parameter indicating a condition that has been applied, or that is requested to be applied, in order for the multiplexing IAB node to operate in a multiplexing mode. In one or more of these embodiments, the multiplexing IAB node comprises a mobile termination, MT, and a distributed unit, DU. In some embodiments, the condition is restriction of simultaneous transmission at the multiplexing node in the direction of one or more beams of the DU. Alternatively, the condition is use of one or more specified beams by the MT for communication on the parent IAB link. Alternatively, the condition is adjustment of a downlink transmission power by the parent IAB node. Alternatively, the condition is power spectral density, PSD, of the MT being within a specified range. Alternatively, the condition is use of certain timing modes in certain respective time slots. Alternatively, the condition is a combination of any two or more of the above.

In one or more of these embodiments, the multiplexing adaptation parameter is an association parameter indicating one or more times, frequencies, and/or cells associated with a condition that has been applied, or that is requested to be applied, in order for the multiplexing IAB node to operate in a multiplexing mode. In one or more of these embodiments, the association parameter indicates one or more indices of one or more time slots associated with the condition. In one or more of these embodiments, the association parameter indicates one or more distributed unit, DU, resource configurations associated with the condition. In one or more of these embodiments, the association parameter indicates one or more carrier-cell pairs associated with the condition. In some embodiments, each of the one or more carrier-cell pairs is a pair of an IAB mobile termination component carrier and an IAB distributed unit cell. In one or more of these embodiments, the multiplexing adaptation parameter is an association parameter indicating a multiplexing mode associated with a condition that has been applied, or that is requested to be applied, in order for the multiplexing IAB node to operate in the indicated multiplexing mode. In one or more of these embodiments, the multiplexing IAB node comprises a mobile termination, MT, and a distributed unit, DU. In some embodiments, the multiplexing IAB node is configured to multiplex communication by the MT on the parent IAB link towards the parent IAB node with communication by the DU on the child IAB link towards the child IAB node. In one or more of these embodiments, the multiplexing IAB node is capable of operating in any one of multiple possible multiplexing modes. In some embodiments, the multiple possible multiplexing modes include at least a TDM mode in which the multiplexing IAB node uses time-domain multiplexing, TDM, to multiplex communication by the MT on the parent IAB link towards the parent IAB node with communication by the DU on the child IAB link towards the child IAB node.

In some embodiments, the multiple possible multiplexing modes include at least an FDM mode in which the multiplexing IAB node uses frequency-domain multiplexing, FDM, to multiplex communication by the MT on the parent IAB link towards the parent IAB node with communication by the DU on the child IAB link towards the child IAB node. In some embodiments, the multiple possible multiplexing modes include at least an SDM mode in which the multiplexing IAB node uses spatial-domain multiplexing, SDM, to multiplex communication by the MT on the parent IAB link towards the parent IAB node with communication by the DU on the child IAB link towards the child IAB node. In some embodiments, the multiple possible multiplexing modes include at least a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

In one or more of these embodiments, the multiplexing IAB node is configured to multiplex transmission by the MT on the parent IAB link towards the parent IAB node with transmission by the DU on the child IAB link towards the child IAB node. In some embodiments, the multiplexing IAB node is configured to multiplex transmission by the MT on the parent IAB link towards the parent IAB node with reception by the DU on the child IAB link towards the child IAB node. In some embodiments, the multiplexing IAB node is configured to multiplex reception by the MT on the parent IAB link towards the parent IAB node with transmission by the DU on the child IAB link towards the child IAB node. In some embodiments, the multiplexing IAB node is configured to multiplex reception by the MT on the parent IAB link towards the parent IAB node with reception by the DU on the child IAB link towards the child IAB node. In one or more of these embodiments, the multiplexing IAB node is the first IAB node. In one or more of these embodiments, the IAB donor is the parent IAB node.

In one or more of these embodiments, the method further comprises, based on or according to the value of the parameter indicated by the message, adapting a configuration of the IAB donor.

In some embodiments, the field is an identity, ID, field or an index field.

In some embodiments, the message is a first message. In some embodiments, the method further comprises transmitting, to the first IAB node and/or the second IAB node, signaling that changes which one or more possible values of the field are mapped to which one or more possible values of the parameter.

In some embodiments, the field is a first field and the parameter is a first parameter. In some embodiments, the method further comprises transmitting, to the first IAB node and/or the second IAB node, signaling that indicates which one or more possible values of a second field of the message are mapped to which one or more possible values of a second parameter.

In some embodiments, the signaling comprises a mapping between the one or more possible values of the field to the one or more possible values of the parameter.

In some embodiments, the parameter is a beam configuration parameter.

In some embodiments, the parameter is a beam configuration for a certain distributed unit, DU, cell.

In some embodiments, the first IAB node is a parent IAB node with respect to the second IAB node.

In some embodiments, the first IAB node is a child IAB node with respect to the second IAB node.

In some embodiments, the IAB donor is the second IAB node.

Embodiments herein also include corresponding apparatus, computer programs, and carriers of those computer programs.

For example, embodiments herein include a first integrated access backhaul, IAB, node. The first IAB node is configured to receive, from an IAB donor, signaling that indicates which one or more possible values of a field are mapped to which one or more possible values of a parameter. The first IAB node is configured to transmit to, or receiving from, a second IAB node a message that includes the field set to one of the one or more possible values of the field indicated by the signaling.

Embodiments herein also include a donor integrated access backhaul, IAB, node configured for use in a communication network. The donor IAB node is configured to transmit, to a first IAB node and/or a second IAB node, signaling that indicates which one or more possible values of a field are mapped to which one or more possible values of a parameter. In some embodiments, the field is a field of a message on an interface between the first IAB node and the second IAB node.

### BRIEF DESCRIPTION OF THE DRAWINGS

FIG. 1 is a block diagram of a communication network in accordance with some embodiments.

FIG. 2 is a block diagram of an IAB deployment that supports multiple hops according to some embodiments.

FIG. 3 is a block diagram of a child and parent relationship between IAB nodes according to some embodiments.

FIG. 4 is a block diagram of a two-hop chain of IAB-nodes under an IAB-donor according to some embodiments.

FIG. 5 is a block diagram of spanning tree (ST) and directed acyclic graph (DAG) topologies according to some embodiments.

FIG. 6 is a block diagram of a time-domain DU resource configuration according to some embodiments.

FIG. 7 is a block diagram of a frequency-domain DU resource configuration according to some embodiments.

FIG. 8 is a block diagram of an IAB network according to some embodiments.

FIG. 9 is a flowchart for the parent IAB-node according to some embodiments.

FIG. 10 is a block diagram of a donor-CU configured multiplexing adaptation condition parameter according to some embodiments.

FIG. 11 is a block diagram of a donor-CU configured upper-layer association parameter according to some embodiments.

FIG. 12 is a block diagram of a donor-CU configured upper-layer association parameter according to some embodiments.

FIG. 13 is a block diagram of a donor-CU configured slot indication table according to some embodiments.

FIG. 14 is a block diagram of MAC-CE signaling of the recommended IAB-MT beam MAC-CE according to some embodiments.

FIG. 15 is a block diagram of a multi-dimensional table being configured to include all the association parameters according to some embodiments.

FIG. 16 is a block diagram of MAC-CE signaling of the restricted IAB-MT beam MAC-CE according to some embodiments.

FIG. 17 is a block diagram of a MAC CE format of Child IAB-DU Restricted Beam Indication MAC CE according to some embodiments.

FIG. 18 is a block diagram of a Child IAB-DU restricted beam indication MAC CE signalled by the parent IAB node to the child IAB node according to some embodiments.

FIG. 19 is a block diagram of a MAC CE format of Child IAB-DU Restricted Beam Indication MAC CE according to some embodiments.

FIG. 20 is a block diagram of a Desired DL TX Power Adjustment MAC CE according to some embodiments.

FIG. 21 is a block diagram of an IAB-MT Recommended Beam Indication MAC CE according to some embodiments.

FIG. 22 is a block diagram of a desired IAB-MT PSD range MAC CE according to some embodiments.

FIG. 23 is a logic flow diagram of a method performed by a first IAB node according to some embodiments.

FIG. 24 is a logic flow diagram of a method performed by an IAB donor according to some embodiments.

FIG. 25 is a block diagram of a first IAB node according to some embodiments.

FIG. 26 is a block diagram of an IAB donor according to some embodiments.

FIG. 27 is a block diagram of a communication system in accordance with some embodiments.

FIG. 28 is a block diagram of a user equipment according to some embodiments.

FIG. 29 is a block diagram of a network node according to some embodiments.

FIG. 30 is a block diagram of a host according to some embodiments.

FIG. 31 is a block diagram of a virtualization environment according to some embodiments.

FIG. 32 is a block diagram of a host communicating via a network node with a UE over a partially wireless connection in accordance with some embodiments.

### DETAILED DESCRIPTION

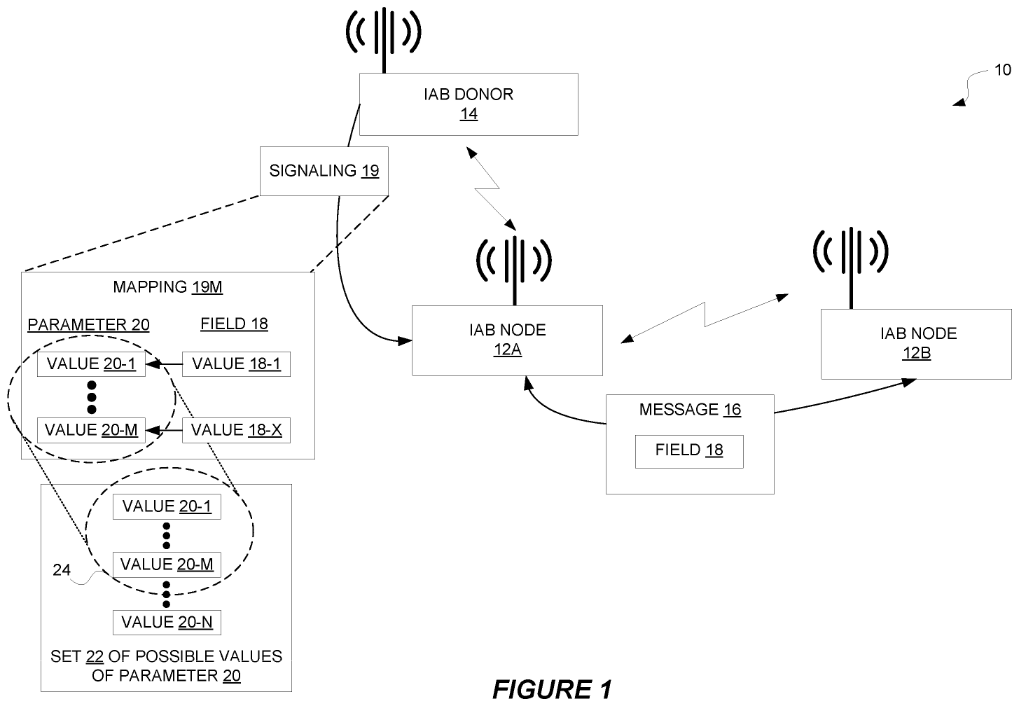

FIG. 1 shows a communication network 10 according to some embodiments, e.g., a 5G communication network. The communication network 10 includes IAB nodes 12A, 12B, which may also be referred to as a first IAB node 12A and a second IAB node 12B. The communication network 10 also includes an IAB donor 14.

In some embodiments, the first IAB node 12A is a parent IAB node with respect to the second IAB node 12B. In other embodiments, by contrast, the first IAB node 12A is a child IAB node with respect to the second IAB node 12B. Although the second IAB node 12B and the IAB donor 14 are depicted as being separate IAB nodes, in some embodiments, the second IAB node 12B is or serves as the IAB donor 14.

The first IAB node 12A is configured to transmit to the second IAB node 12B, or receive from the second IAB node 12B, a message 16. In some embodiments, the message 16 is a medium access control (MAC) message, e.g., including a MAC control element (CE). In other embodiments, the message 16 is a downlink control information (DCI) message. In these and other embodiments, then, the message 16 may be referred to as a lower layer message, e.g., at a layer of a protocol stack that is at or lower than a MAC layer.

In any event, the message 16 as shown includes a field 18, e.g., an identity (ID) field or an index field. Where the message 16 is a MAC message, for instance, the field 18 may be included in a MAC CE of the message 16. Regardless, the field 18 is settable to any one of one or more possible values 18-1 . . . 18-X. As communicated between the first and second IAB nodes 12A, 12B, then, the message 16 is set to one of the one or more possible values 18-1 . . . 18-X.

In this context, the IAB donor 14 according to some embodiments configures or otherwise controls the meaning of the one or more possible values 18-1 . . . 18-X, i.e., configures or controls what each of the one or more possible values 18-1 . . . 18-X indicates.

FIG. 1 in this regard shows that the first IAB node 12A is configured to receive signaling 19 from the IAB donor 14, e.g., from a central unit (CU) of the IAB donor 14. Although not shown, the second IAB node 12A may also be configured to receive this signaling 19 from the IAB donor 14. The signaling 19 may be radio resource control (RRC) signaling, F1 signaling, or operations and maintenance (OAM) signaling. In these and other embodiments, the signaling 19 may be so-called upper layer signaling, e.g., at a layer of a protocol stack that is above one or more lower layers such as a medium access control (MAC) layer. In one such case, the signaling 19 is communicated at an upper layer that is above a lower layer at which the message 16 is communicated. Regardless, the signaling 19 as shown indicates which one or more possible values 18-1 . . . 18-X of the field 18 are mapped to which one or more possible values of a parameter 20, e.g., a beam configuration parameter. That is, the value to which the field 18 is set indicates some value of the parameter 20, and the signaling 19 indicates which value of the field 18 indicates which value of the parameter 20.

As shown in FIG. 1, for example, the signaling 19 may comprise or indicate a mapping 19M that maps possible values 18-1 . . . 18-X of the field to respective possible values 20-1 . . . 20-M of the parameter 20. Notably, in some embodiments, the one or more possible values 20-1 . . . 20-M of the parameter 20 to which the one or more possible values 18-1 . . . 18-X of the field 18 are mapped may comprise a subset 24 of a set 22 of multiple possible values 20-1 . . . 20-N of the parameter 20.

In one embodiment, for example, the parameter 20 may nominally have any of N multiple possible values 20-1 . . . 20-N in a set 22. The IAB donor 14 may nonetheless select only a size-M subset 24 of the N multiple possible values 20-1 . . . 20-N in the set 22 (with M<N) as being indicatable by the field 18. Rather than the field 18 being able to indicate any of the N multiple possible values 20-1 . . . 20-N in the set 22, then, the field 18 is configured, e.g., on a semi-static basis, to be able to indicate any of the M possible values 20-1 . . . 20-M selected for inclusion in the subset 24. Based on this selection, the IAB donor 14 may then generate the mapping 19M to map possible values 18-1 . . . 18-X of the field 18 to respective possible values 20-1 . . . 20-M of the parameter 20 in the subset 24. The IAB donor 14 then transmits signaling 19 to indicate the mapping 19M.

In these and other embodiments, then, the field 18 of the message 16 may be sized (e.g., in terms of bit length) to signal any one of the possible value(s) 20-1 . . . 20-M in the subset 24, rather than to signal any one of the possible values 20-1 . . . 20-N in the full set 22. The field 18 of the message 16 may thereby be smaller than would otherwise be required. Some embodiments thereby facilitate signaling the parameter 20 between IAB nodes 12A, 12B with lower signaling overhead. Moreover, the configurability of which possible value 20-1 . . . 20-M are indicatable by the field 18, e.g., on a semi-static basis via signaling 19, preserves at least some flexibility to indicate any of the possible values 20-1 . . . 20-N in the full set 22.

In fact, in some embodiments, the IAB donor 14 may transmit signaling 19 from time to time as needed to change which one or more possible values 18-1 . . . 18-X of the field 18 are mapped to which one or more possible values of the parameter 20, i.e., to update the mapping 19M. With respect to any subsequent communication of the message 18, then, the field 18 may be set or interpreted according to such an updated mapping.

In some embodiments, the parameter 20 indicates a configuration according to which the first IAB node 12A or the second IAB node 12B operates or is requested to operate.

In these and other embodiments, some embodiments herein are applicable in a context where the first IAB node 12A or the second IAB node 12B is a so-called multiplexing node capable of operating in a multiplexing mode. Here, a multiplexing mode is a mode in which the multiplexing IAB node multiplexes communication on a parent IAB link with communication on a child IAB link. In this case, the parameter 20 may for instance be a multiplexing adaptation parameter that facilitates or governs adaptation of in which multiplexing mode, if any, a multiplexing node operates.

The parameter 20 in this case may be a condition parameter indicating a condition that has been applied, or that is requested to be applied, in order for the multiplexing IAB node to operate in a multiplexing mode. In other embodiments, the parameter 20 may be an association parameter indicating one or more times, frequencies, and/or cells associated with a condition that has been applied, or that is requested to be applied, in order for the multiplexing IAB node to operate in a multiplexing mode. In yet other embodiments, the parameter 20 may be an association parameter indicating a multiplexing mode associated with a condition that has been applied, or that is requested to be applied, in order for the multiplexing IAB node to operate in the multiplexing mode.

Although FIG. 1 illustrates embodiments herein with respect to a single field 18 in the message 16 and a single parameter 20, embodiments herein may be extrapolated to multiple fields in the message 16 for multiple respective parameters. For example, in some embodiments, the signaling 19 also indicates which one or more possible values of a second field are mapped to which one or more possible values of a second parameter. In this case, the message 16 may further include the second field set to one of the one or more possible values of the second field indicated by the signaling 19.

Consider now an example of some embodiments herein in the following context.

### Integrated Access and Backhaul Overview

Densification via the deployment of increasing base stations (be them macro or micro base stations) is one of the mechanisms that can be employed to satisfy the ever-increasing demand for more and more bandwidth/capacity in mobile networks. Due to the availability of more spectrum in the millimeter wave (mmw) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

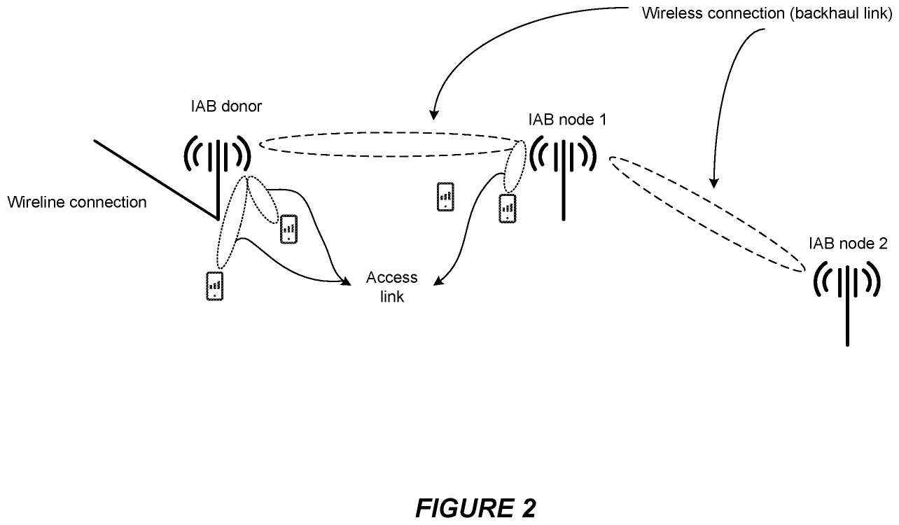

In FIG. 2, an IAB deployment that supports multiple hops is presented. The IAB donor node (in short IAB donor) has a wired connection to the core network and the IAB-nodes are wirelessly connected using New Radio (NR) to the IAB donor, either directly or indirectly via another IAB-node. The connection between IAB donor/node and user equipments (UEs) is called access link, whereas the connection between two IAB-nodes or between an IAB donor and an IAB-node is called backhaul link.

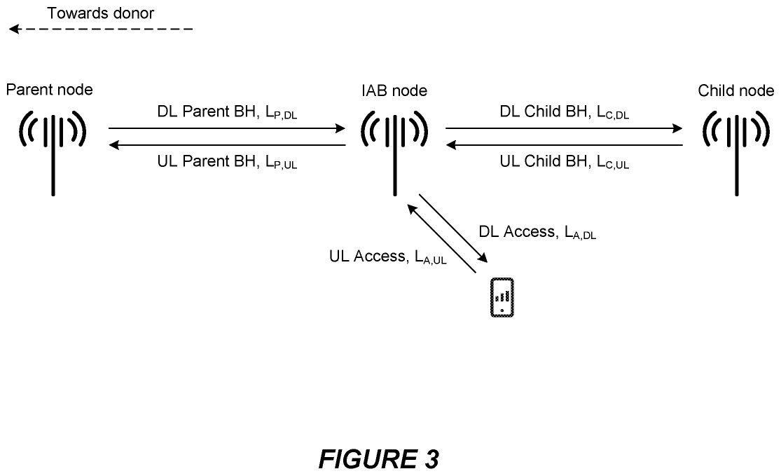

Furthermore, as shown in FIG. 3, the adjacent upstream node which is closer to the IAB donor node of an IAB-node is referred to as a parent node of the IAB-node. The adjacent downstream node which is further away from the IAB donor node of an IAB-node is referred to as a child node of the IAB-node. The backhaul link between the parent node and the IAB-node is referred to as parent (backhaul) link, whereas the backhaul link between the IAB-node and the child node is referred to as child (backhaul) link.

### IAB Architecture

One major difference of the IAB architecture compared to Rel-10 Long Term Evolution (LTE) relay (besides lower layer differences) is that the IAB architecture adopts the Central-Unit/Distributed-Unit (DU/DU) split of gNBs. In this CU/DU split, time-critical functionalities are realized in DU closer to the radio, whereas the less time-critical functionalities are pooled in the CU with the opportunity for centralization. Based on this architecture, an IAB-donor contains both CU and DU functions. In particular, it contains all CU functions of the IAB-nodes under the same IAB-donor. Each IAB-node then hosts the DU function(s) of a gNB. In order to be able to transmit/receive wireless signals to/from the upstream IAB-node or IAB-donor, each IAB-node has a mobile termination (MT), which is a logical unit providing a necessary set of UE-like functions. Via the DU, the IAB-node establishes Radio Link Control (RLC)-channel to UEs and/or to MTs of the connected IAB-node(s). Via the MT, the IAB-node establishes the backhaul radio interface towards the serving IAB-node or IAB-donor.

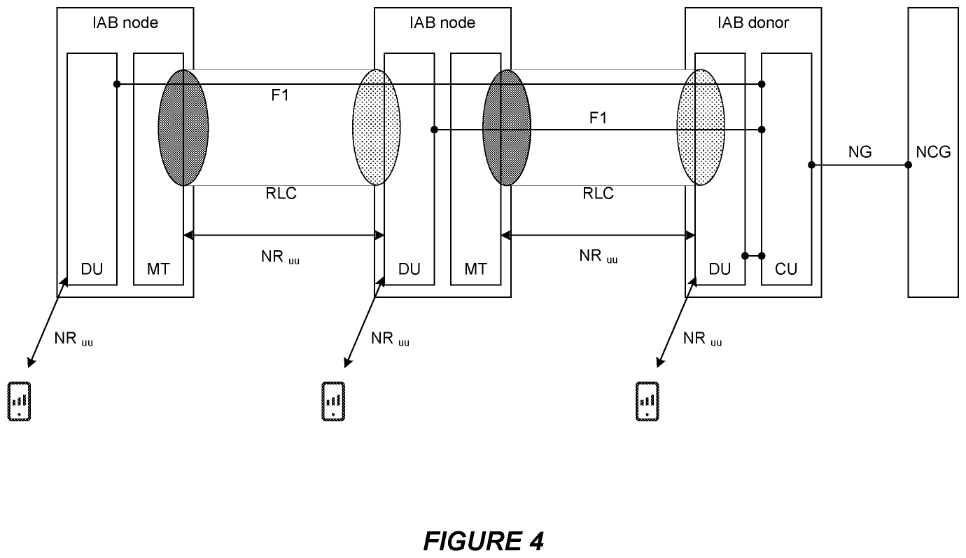

FIG. 4 shows a reference diagram for a two-hop chain of IAB-nodes under an IAB-donor. As shown, the IAB-donor is connected to a Next Generation Core (NGC) vi an NG interface. The CU of the IAB donor is connected to the DU of each IAB node via an F1 interface. And the DU of the IAB donor is connected to the MT of one of the IAB nodes (its immediate child) over the NR Uu interface, with the DU of that IAB node in turn connected to the MT of the other of the IAB nodes. The DU of the IAB donor and the DU of each IAB node may be connected to any UEs via the NR Uu interface.

### IAB Topologies

Wireless backhaul links are vulnerable to blockage, e.g., due to moving objects such as vehicles, due to seasonal changes (foliage), severe weather conditions (rain, snow or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the Rel-10 LTE relay.

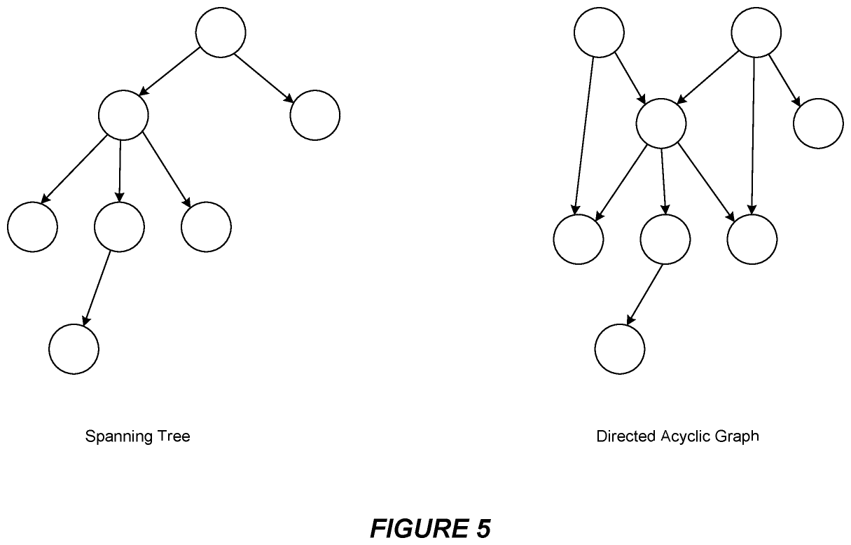

The following topologies are considered in IAB as shown in FIG. 5: Spanning tree (ST) and Directed acyclic graph (DAG). Here, the arrow indicates the directionality of the graph edge.

As shown, one IAB-node can have multiple child nodes and/or have multiple parent nodes. The multi-connectivity or route redundancy may be used for back-up purposes. It is also possible that redundant routes are used concurrently, e.g., to achieve load balancing, reliability, etc.

### Resource Configuration

### Time-Domain Resource Coordination

In case of in-band operation, the IAB-node is typically subject to the half-duplex constraint, i.e., an IAB-node can only be in either transmission or reception mode at a time. Rel-16 IAB mainly considers the time-division multiplexing (TDM) case where the MT and DU resources of the same IAB-node are separated in time. Based on this consideration, the following resource types have been defined for IAB MT and DU, respectively.

From an IAB-node MT point-of-view, as in Rel-15, the following time-domain resources can be indicated for the parent link: Downlink (DL) time resource, Uplink (UL) time resource, Flexible (F) time resource.

From an IAB-node DU point-of-view, the child link has the following types of time resources: DL time resource, UL time resource, F time resource, Not-available (NA) time resources (resources not to be used for communication on the DU child links).

Each of the downlink, uplink and flexible time-resource types of the DU child link can belong to one of two categories: Hard (H) and Soft(S). In the Hard category, the corresponding time resource is always available for the DU child link. In the Soft category, the availability of the corresponding time resource for the DU child link is explicitly and/or implicitly controlled by the parent node.

The IAB DU resources are configured per cell, and the H/S/NA attributes for the DU resource configuration are explicitly indicated per-resource type (D/U/F) in each slot. As a result, the semi-static time-domain resources of the DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relation between MT and DU resources are listed in Table 1.

TABLE 1
Coordination between MT and DU resources of an IAB-node.

| | DL | UL | Flexible |
|---|---|---|---|
| DL-H | DU: can transmit on | DU: can transmit on | DU: can transmit on |
| | DL unconditionally; | DL unconditionally; | DL unconditionally; |
| | MT: not available. | MT: not available. | MT: not available. |
| DL-S | DU: can transmit | DU: can transmit | DU: can transmit |
| | conditionally; | conditionally; | conditionally; |
| | MT: available on DL. | MT: available on UL. | MT: available on DL & UL. |
| UL-H | DU: can schedule UL | DU: can schedule UL | DU: can schedule UL |
| | unconditionally; | unconditionally; | unconditionally; |
| | MT: not available. | MT: not available. | MT: not available. |
| UL-S | DU: can schedule UL | DU: can schedule UL | DU: can schedule UL |
| | conditionally; | conditionally; | conditionally; |
| | MT: available on DL. | MT: available on UL. | MT: available on DL & UL. |
| F-H | DU: can transmit on | DU: can transmit on | DU: can transmit on |
| | DL or schedule UL | DL or schedule UL | DL or schedule UL |
| | unconditionally; | unconditionally; | unconditionally; |
| | MT: not available. | MT: not available. | MT: not available. |
| F-S | DU: can transmit on | DU: can transmit on | DU: can transmit on |
| | DL or schedule UL | DL or schedule UL | DL or schedule UL |
| | conditionally; | conditionally; | conditionally; |
| | MT: available on DL. | MT: available on UL. | MT: available on DL & UL. |
| NA | DU: not available; | DU: not available; | DU: not available; |
| | MT: available on DL. | MT: available on UL. | MT: available on DL & UL. |

Furthermore, an IAB-DU function may correspond to multiple cells, including cells operating on different carrier frequencies. Similarly, an IAB-MT function may correspond to multiple carrier frequencies. This can either be implemented by one IAB-MT unit operating on multiple carrier frequencies or be implemented by multiple IAB-MT units, each operating on different carrier frequencies. The H/S/NA attributes for the per-cell DU resource configuration should take into account the associated IAB-MT carrier frequency (ies).

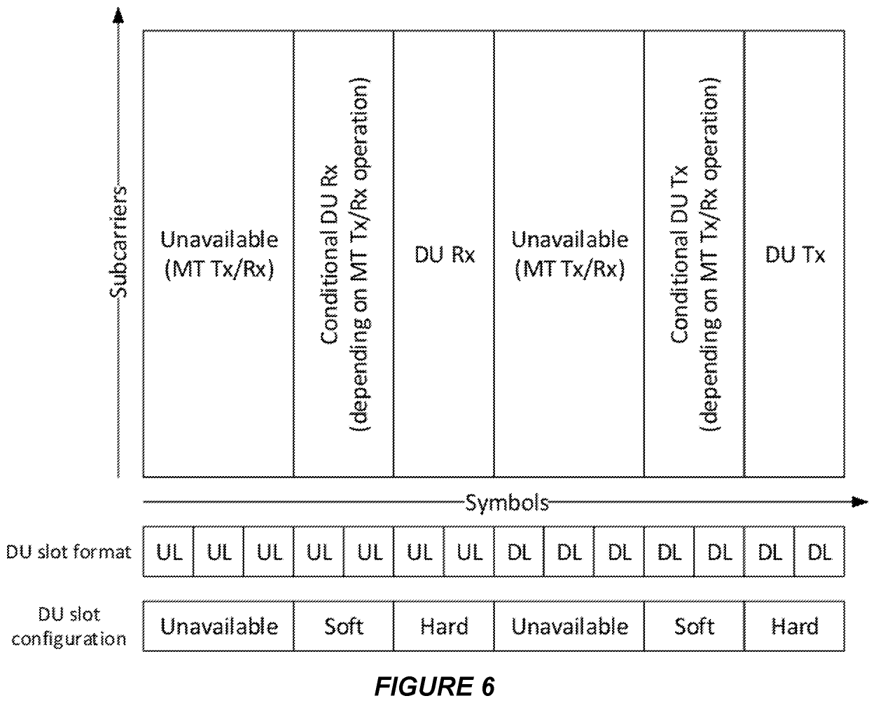

One example of such DU configuration is in FIG. 6, which shows an example of a time-domain DU resource configuration.

### Frequency-Domain Resource Configuration

Some embodiments herein facilitate specification of enhancements to the resource multiplexing between child and parent links of an IAB node, including: support of simultaneous operation (transmission and/or reception) of IAB-node's child and parent links (i.e., MT Tx/DU Tx, MT Tx/DU Rx, MT Rx/DU Tx, MT Rx/DU Rx).

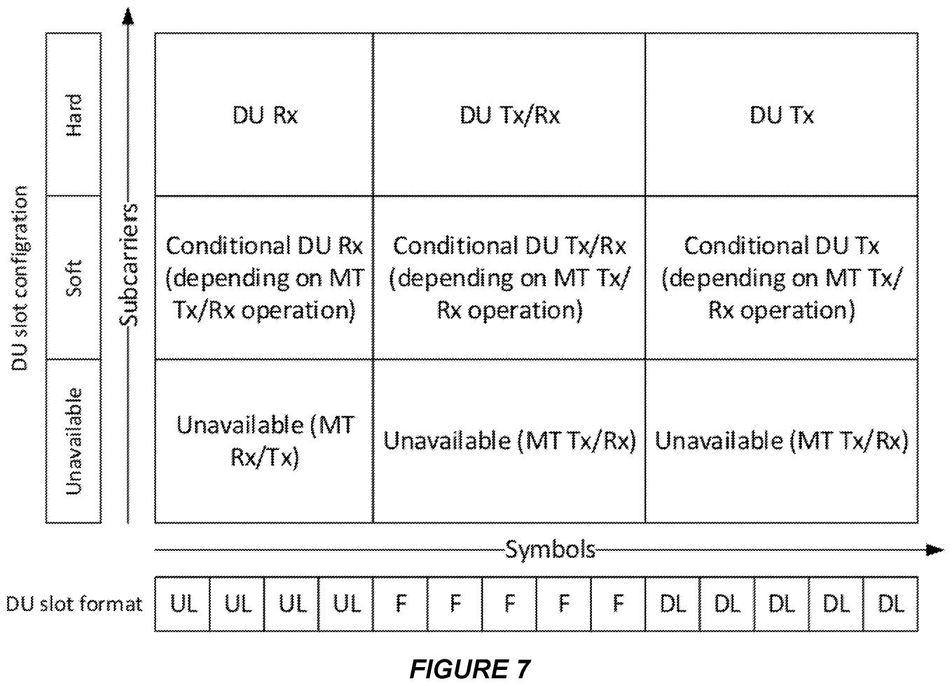

One approach for such enhancement is to provide frequency-domain resource configuration. Comparing to the time-domain counterpart, one example of the frequency-domain DU resource configuration is shown in FIG. 7.

### Capability Indication

To facilitate the resource configuration, the donor CU and the parent node can be made aware of the multiplexing capability between MT and DU (TDM required, TDM not required) of an IAB node for any {MT component carrier (CC), DU cell} pair.

In some embodiments, the indication of the multiplexing capability for the case of no-TDM between IAB MT and IAB DU is additionally provided with respect to each transmission-direction combination (per MT CC/DU cell pair): MT-TX/DU-TX, MT-TX/DU-RX, MT-RX/DU-TX, MT-RX/DU-RX.

For the 3GPP Rel-16 IAB specification, the corresponding signaling has been defined in TS 38.473 v16.9.0, clause 9.3.1.108 as part of the F1 application protocol (F1AP) information element (IE), which is Layer 3 (L3) signaling.

### Rel-17 Simultaneous Operation

With regard to 3GPP Rel-17, some embodiments provide enhancements to the resource multiplexing between child and parent links of an IAB node, including support of simultaneous operation (transmission and/or reception) of IAB-node's child and parent links (i.e., MT Tx/DU Tx, MT Tx/DU Rx, MT Rx/DU Tx, MT Rx/DU Rx).

The simultaneous operation includes both frequency-division multiplexing (FDM) and spatial-division multiplexing (SDM). To facilitate FDM operation, for frequency domain multiplexing, H/S/NA configurations for an IAB-node are provided separately in addition to the Rel-16 H/S/NA.

Based on a given hardware capability, the IAB-MT and IAB-DU can conduct simultaneous transmission and/or reception, if the operational conditions at the parent node and/or the child node are fulfilled, as well as the conditions on the propagation channel and the network interference level. After receiving the semi-static configuration from the donor-CU, the IAB-node should initialize the exchange of the operational parameters for simultaneous operation with its parent node and child node. The parent IAB-node is dynamically provided with condition/parameters to facilitate adaptation between multiplexing operation modes.

The parent IAB-node is dynamically provided with conditions/parameters to facilitate adaptation between multiplexing operation modes.

Some embodiments herein address certain challenge(s) in this context.

Rel-16 IAB considers the time-division multiplexing (TDM) case where the IAB-DU and IAB-MT resources of the same IAB-node are separated in time. Rel-17 elAB is focused on simultaneous operation of IAB-DU and IAB-MT, e.g., the frequency-domain multiplexing (FDM) and the spatial-domain multiplexing (SDM). For a FDM-capable IAB node, the donor-CU will provide to the IAB-DU separate TDM and FDM resource configurations. The use of TDM or FDM at an IAB-DU cell is orthogonal which means that for a certain time resource (e.g., a slot) either one or the other multiplexing mode is used. After receiving the semi-static configuration from the donor-CU, the IAB-node should initialize the exchange of the multiplexing adaptation parameters for simultaneous operation, with its parent node and child node. In the Rel-17 IAB, information regarding the following multiplexing adaptation conditions can be exchanged, between the IAB-node and the parent node, via MAC-CE signaling.

Child IAB-DU restricted beam indication: Signaling from a parent IAB-node/parent IAB-donor to an IAB node indicating beams of the IAB-DU in the direction of which simultaneous transmission at the IAB-node is restricted.

Desired DL TX power adjustment: The IAB-MT indicates, to its parent-node, its desired DL TX power adjustment to assist with the parent-node's DL TX power allocation, in order to facilitate the simultaneous reception at the IAB-node, i.e., to ensure a balanced received power from both the parent IAB-node and the child IAB-node.

DL TX power adjustment: The parent-node indicates to the IAB-node an adjustment to the parent-node's DL TX power (e.g., in response to receiving Desired DL TX Power Adjustment from the IAB-node), to facilitate the simultaneous reception at the IAB-node, i.e., to ensure a balanced received power from both the parent IAB-node and child IAB-node.

Desired IAB-MT PSD range: The IAB-node indicates to its parent-node, its desired power spectral density (PSD) range to help with its MT's UL TX power control to ensure a balanced transmission power relation to both parent and child IAB-nodes, and facilitate simultaneous transmission at the IAB-node.

IAB-MT recommended beam indication: Signaling from an IAB-node to its parent-node indicating the recommended beams of the IAB-MT for DL RX beams and/or UL TX beams, to facilitate the simultaneous reception (from both parent and child IAB-nodes) or simultaneous transmission (to both parent and child IAB-nodes) at the IAB node.

Timing case indication: The parent-node indicates to an IAB-node a list of slots and their associated UL TX timing cases (i.e., one of {Case 1, Case 6, Case 7} for each slot), where Case 1 timing is TDM, Case 6 timing is simultaneous transmission at IAB-node, and Case 7 timing is simultaneous reception at the IAB-node.

For each of the above adaptation conditions, the indication can have an association to one or multiple of the IAB-node operational modes/configurations, such as {IAB-MT Component-Carrier (CC), IAB-DU cell}, multiplexing mode information, slot index, DU resource configuration, etc.

It should be noted that some of the above-mentioned operational modes/configurations have extremely flexible configuration options, which makes the design of the MAC-CE signaling highly complex. For example, the association to {MT CC, DU cell} pairs can involve up to 32 IAB-MT CCs and 512 IAB-DU cells. Taking another example, the slot indication may include indication for all slots in a time division duplex (TDD) period, where the ranges for TDD periodicity can take a value of {16, 20, 32, 40, 64 80, 160, 320, 640, 1280, 2560, 5120} slots. Hence, there is a need for methods for efficient signaling for the adaptation condition to support simultaneous operation at the IAB-node.

Certain aspects of the disclosure and their embodiments may provide solutions to these or other challenges. Some embodiments provide signaling with low overhead to indicate multiplexing adaptation conditions, and the related associations, between parent IAB-node and IAB-node, which is desired to enable the IAB-node to flexibly and smoothly operate in simultaneous operation mode. Such signaling may exemplify the signaling 19 and/or message 16 in FIG. 1. In some embodiments, the signaling comprises donor-CU configured (e.g., RRC-based) sets of multiplexing adaptation parameters. Also, a parent IAB-node and/or an IAB-node indicate (e.g., by MAC-CE) a selection(s) from the RRC-configured parameter sets. The RRC-configured parameter sets contain the alternative configurations of multiplexing adaptation conditions and associations.

Certain embodiments may provide one or more of the following technical advantage(s). Some embodiments herein allow for flexible and efficient signaling of multiplexing adaptation conditions for simultaneous operation of IAB-MT and the collocated IAB-DU. Particularly, some embodiments significantly reduce the complexity of the MAC-CE design, and also support future extension of the multiplexing adaptation configurations.

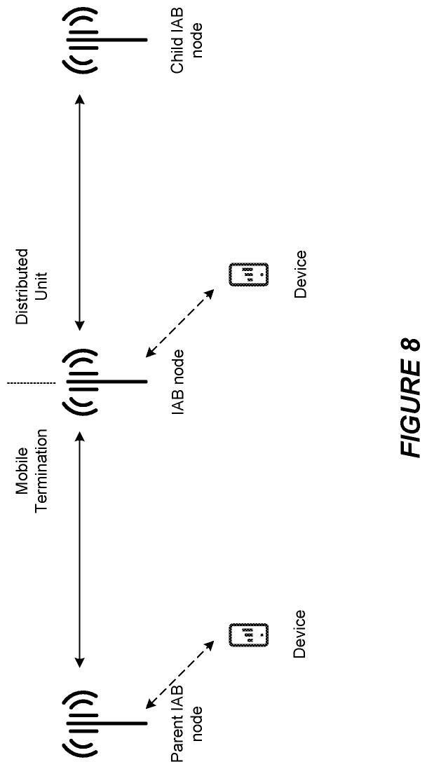

FIG. 8 shows the context of some embodiments as being an IAB network where an IAB-node may be connected upstream to a parent IAB-node and downstream to a device and/or a child IAB-node. The parent node may, in turn, also connect a device, or other IAB-nodes.

Some embodiments herein design signaling to indicate multiplexing adaptation conditions, and the related associations, between parent IAB-node and IAB-node. In some embodiments, the signaling comprises RRC and/or F1 configured (upper-layer) multiplexing adaptation parameters, i.e., a set of alternative configurations; and a MAC-CE indication of the parent node determined (or IAB-node desired) multiplexing adaptation conditions, wherein the multiplexing adaptation condition signaled in the said MAC CE indication is associated to a certain alternative configuration configured by the upper layers (i.e., RRC). Some embodiments split the multiplexing adaptation signaling into RRC part and MAC-CE part based on the donor-CU's responsibility and parent node's responsibility, respectively. As explained above, the association parameter can have very flexible and extremely large configuration options. It is unrealistic to reserve MAC-CE to take all possible configuration options into consideration. On the other hand, the RRC-configured signaling does not have the same size limitation as the MAC-CE configured signaling. A split signaling design can further reduce the signaling overhead since the donor-CU has better knowledge than the parent IAB-node in order to specify a subset of possible multiplexing adaptation configuration options/states, based on e.g., multiplexing capability of the IAB-node and/or semi-static configuration of resource multiplexing of the IAB-node. Indeed, this information is always available at the donor-CU, but only optionally provided to the parent IAB-node.

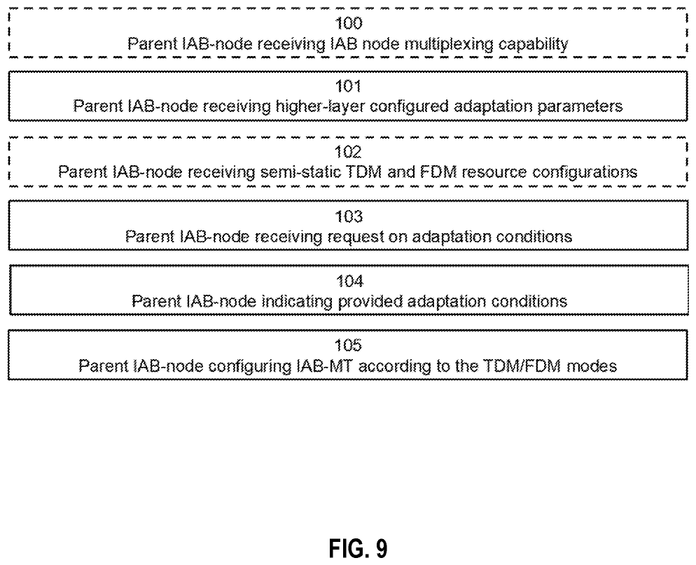

FIG. 9 depicts the flowchart for the parent IAB-node aspect of some embodiments. In some embodiments, the first IAB node 12A in FIG. 1 is exemplified by the IAB node and the second IAB node 12B in FIG. 1 is exemplified by the parent IAB-node. In other embodiments, though, the first IAB node 12A in FIG. 1 is exemplified by the parent IAB-node and the second IAB node 12B in FIG. 1 is exemplified by the IAB-node. The IAB donor 14 is exemplified by the donor-CU.

### Upper Layers Configuration

In an optional first step (100) shown in FIG. 9, the parent IAB-node receives the IAB-node multiplexing capability from the donor-CU via F1 signaling.

The multiplexing capability can be two or more of the following: time-division multiplexing (TDM), frequency-division multiplexing (FDM), or space-division multiplexing (SDM).

Alternatively, or additionally, the multiplexing capability can be one or more of the following: (i) capable of simultaneous transmission (TX) of IAB-MT and IAB-DU; (ii) capable of simultaneous reception (RX) of IAB-MT and IAB-DU; (iii) capable of simultaneous TX and RX of IAB-MT and IAB-DU, respectively; (iv) capable of simultaneous RX and TX of IAB-MT and IAB-DU, respectively; or (v) incapable of any simultaneous operation.

Alternatively, or additionally, the multiplexing capability can be one of the following: TDM required, or TDM not required, or FDM required, or FDM not required, etc.

In the second step (101), the parent IAB-node receives the upper-layer configured multiplexing adaptation parameters from donor-CU, via e.g., RRC signaling or F1 signaling or OAM signaling. For the purpose of some embodiments, it is assumed that RRC signaling is used. But that may not always be the case, in which case, the upper-layer configured can also be signaled using F1, etc. In this example, a multiplexing adaptation parameter exemplifies the parameter 20 in FIG. 1, where the multiplexing adaptation parameter may be a condition parameter or an association parameter. And the upper-layer signaling used to configure the multiplexing adaptation parameters exemplifies the signaling 19 in FIG. 1.

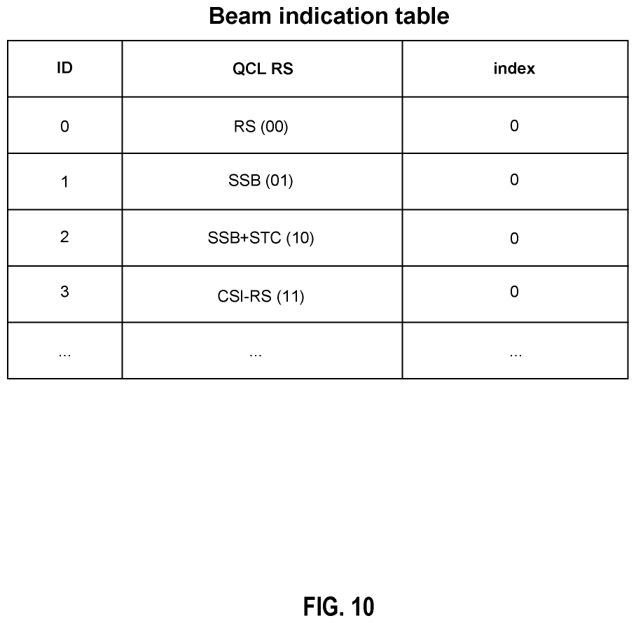

In one embodiment, the donor-CU configured upper-layer multiplexing adaptation parameters comprise a set of one or more of condition parameters, such as beam control, DL/UL power control, timing, etc. In one related embodiment, each multiplexing adaptation condition parameter comprises a set of configurable states of the condition parameter where each state is assigned with an index/ID. FIG. 10 provides an example of the donor-CU configured multiplexing adaptation condition parameter, namely beam indication in this example. Each configurable state of the beam indication parameter/table (each row of the beam indication table) is assigned to an ID and mapped to a quasi co-location (QCL) reference signal type (e.g., synchronization signal beam (SSB), channel state information reference signal (CSI-RS), etc.) and an index of the said QCL reference signal type.

In one embodiment, the donor-CU configured upper-layer multiplexing adaptation parameters, e.g., for a beam configuration, comprise a set of one or more association parameters. The set of one or more association parameters may include one or more of: (i) MT CC to which the multiplexing adaptation parameters are applicable; (ii) the DU cell to which the multiplexing adaptation parameters are applicable or the MT CC-DU Cell relation to which the multiplexing adaptation parameters are applicable; (iii) multiplexing mode information to which the multiplexing adaptation parameters are applicable; (iv) a sequence of slot indication including periodicity and optionally slot indices to which the multiplexing adaptation parameters are applicable; (v) IAB-DU resource configuration to which the multiplexing adaptation parameters are applicable; (vi) IAB-MT and IAB-DU carrier relationship to which the multiplexing adaptation parameters are applicable; or (vii) an indication indicating the associate beam indication, i.e. whether the configuration is associated to the Transmission Configuration Indication (TCI) TCI state ID, or Synchronization Signal Block (SSB) ID, or CSI-RS ID, or Scheduling Request Indicator (SRI).

In one related embodiment, the above multiplexing adaptation parameters are grouped in a specific configurable state. A set of multiple configurable states with their respective multiplexing adaptation parameters may be configured in a list, where each entry of the list comprises a configurable state identified by an index/ID.

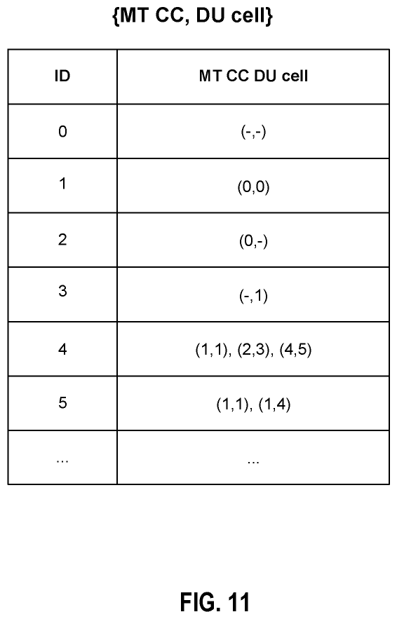

FIG. 11 gives an example of a donor-CU configured upper-layer association parameter regarding the {MT CC, DU cell} pair, where each state can contain zero, one or multiple {MT CC, DU cell} pairs. In one detailed embodiment, one state can be reserved to indicate “No association to any {MT CC, DU cell}” pair; see the state with ID=0. In another detailed embodiment, one state may only indicate association to one or multiple MT CCs; see the state with ID=2. In yet another detailed embodiment, one state may only indicate association to one or multiple DU cells; see the state with ID=3. In yet another embodiment, one state can be used to indicate association to multiple {MT CC, DU cell} pairs; see the state with ID=4 and 5.

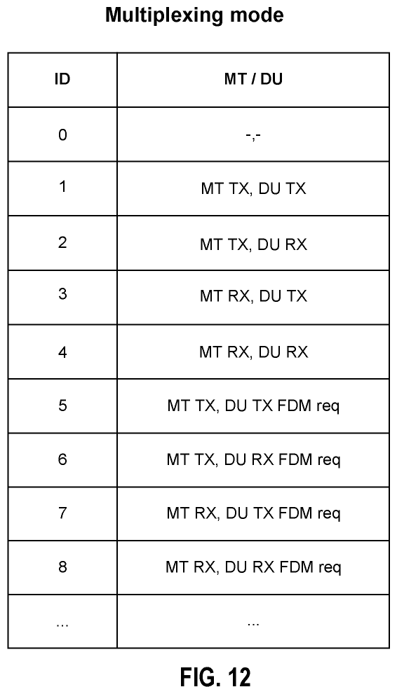

FIG. 12 gives another example of a donor-CU configured upper-layer association parameter regarding the IAB-node multiplexing mode, where the configurable states include for example MT TX/DU TX, MT TX/DU RX, MT RX/DU TX, MT RX/DU RX, and/or FDM required/FDM not required, etc. In one related embodiment, one state is reserved to indicate “No association to multiplexing mode”.

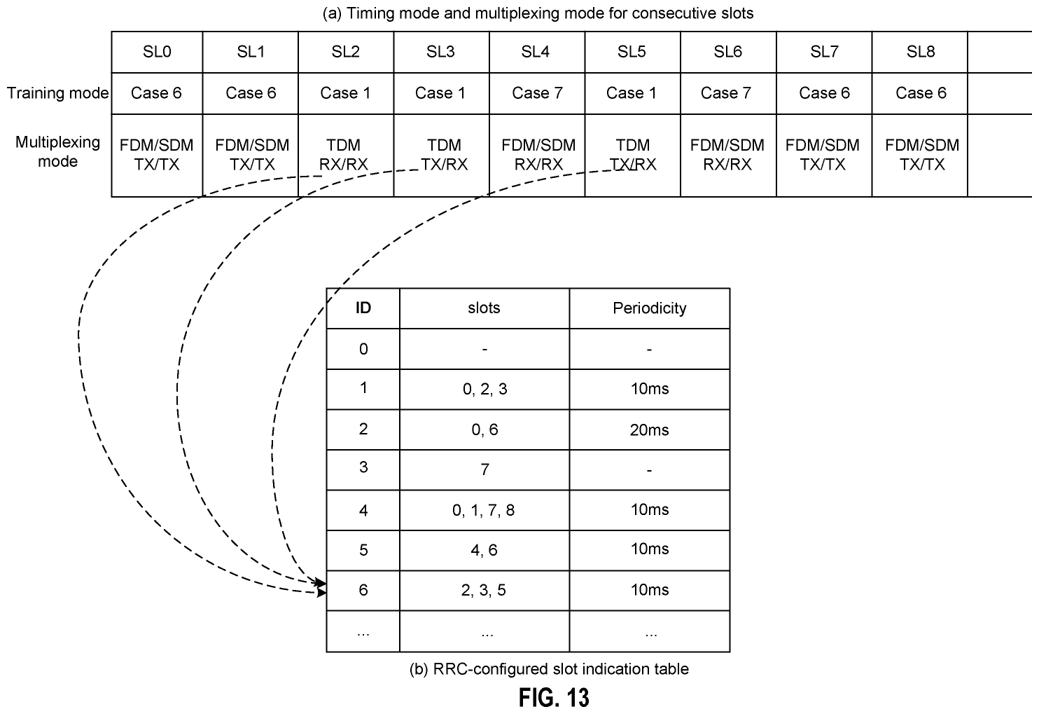

FIG. 13 depicts further an example of a donor-CU configured slot indication table. FIG. 13(a) shows the configured timing mode (case 1, or case 6, or case 7) and multiplexing mode over consecutive 10 slots. FIG. 13(b) shows the RRC-configured slot indication table in which each ID is mapped to none, or one, or multiple slots in a period and the corresponding periodicity. For example, the 5th state of the slot indication table (ID=4) can be used to indicate association to Slots 2-5 which are configured with Case 1 timing and TDM mode.

Referring again to FIG. 9, in an optional third step (102), the parent IAB-node can be made aware of the semi-static TDM and/or FDM resource configurations of the IAB-node, via e.g., the F1 signaling. This information is useful to the parent IAB-node for a determination of which time resource (e.g., slots) the IAB-node may perform simultaneous operations.

### MAC Signaling

The following describes the MAC CE signalling that may be transmitted by the parent IAB node to a child IAB node or vice versa, depending on the specific MAC CE. This MAC CE signaling exemplifies the message 16 in FIG. 1, for the case where the message 16 is a MAC message that includes the field 18 in a MAC CE of the message. For the sake of simplicity, in the following, consider the case of a MAC CE transmitted by the parent IAB node to the child IAB node. However, embodiments herein may be applied also to the case of MAC CEs transmitted by the child IAB node to the parent IAB node.

In a fourth step (103), the parent IAB-node receives from the IAB-node, via a MAC CE indication, multiplexing adaptation conditions for simultaneous operations, wherein the indication refers to one or multiple specific configurations configured by upper layers as described in other embodiments. This MAC CE indication may be an additional or alternative example of the message 16 in FIG. 1. The indication may indicate for the associated beam configuration configured by upper layers certain information intended for the receiving IAB node. As an example, such information may include: (i) the beams for which restricted operations for the associated beam configuration has to be applied; (ii) the beams recommended for the associated beam configuration; (iii) the power adjustment or the recommended power adjustment for the associated beam configuration.

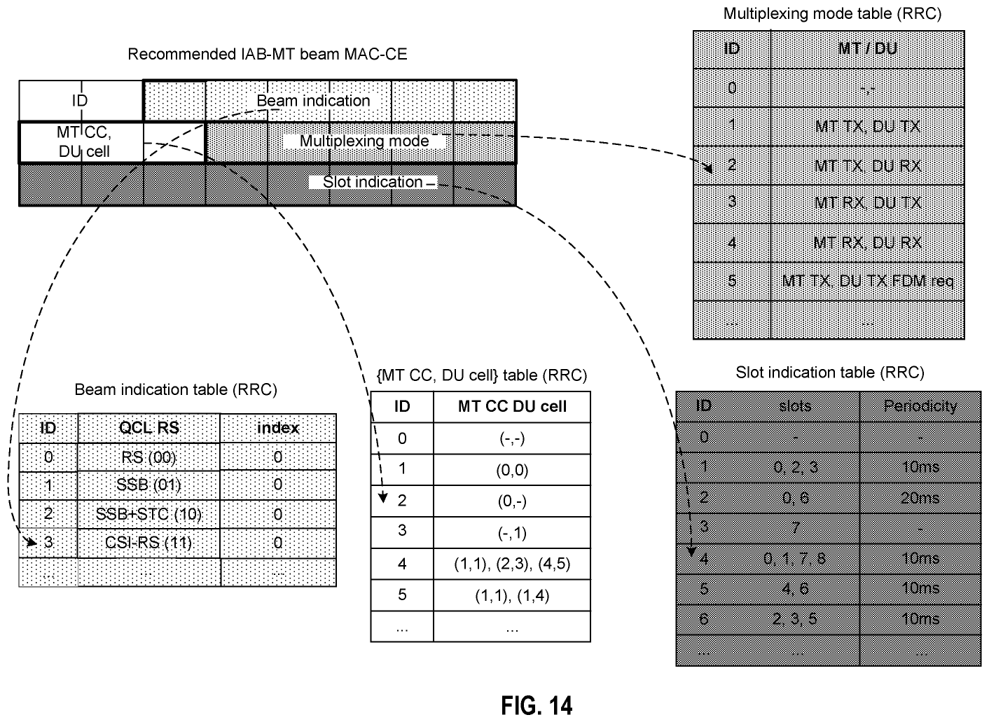

In other words, the parent IAB-node is informed, dynamically via MAC CE, about the IAB-node's ability to exploit the multiplexing capability, referring to one or more specific configurations among the configured configurations provided semi-statically via the upper layers (RRC). FIG. 14 gives an example of a MAC-CE signaling of the recommended IAB-MT beam MAC-CE which is used by the IAB-node to inform the parent IAB-node about a recommended IAB-MT beam. Besides the ID which indicates the Nth recommended IAB-MT beam, there are bit-fields which contain pointers to the RRC-configured multiplexing adaptation parameters: beam indication table, multiplexing mode table, {MTCC, DU cell} table and Slot indication table, respectively.

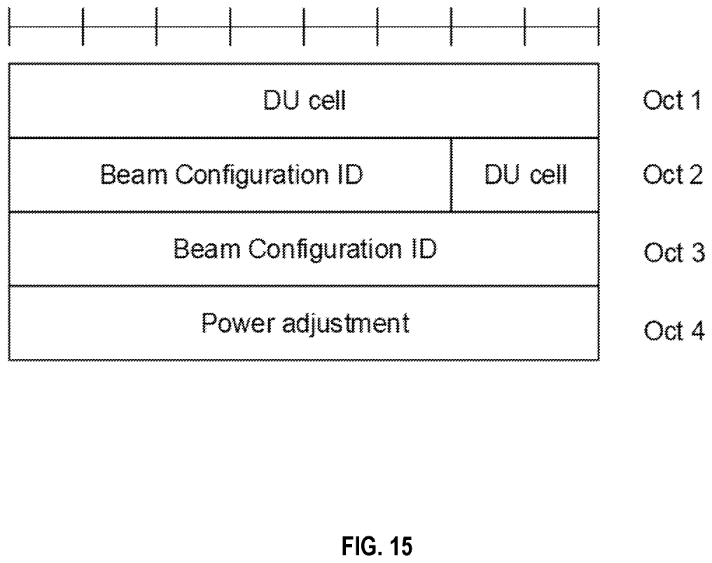

In another example, a multi-dimensional table can be configured to include all the association parameters, i.e., a set of combinations of selected association parameters. Each combination will be configured with a Combination ID. In FIG. 15, the Power adjustment bitfield is allocated to the multiplexing adaptation condition parameter power adjustment, whilst the Beam Configuration ID bitfield is allocated to the multiplexing adaptation association parameters. The Beam Configuration ID bitfield contains 14 bits, which can allow a maximum 16384 combinations of association parameters.

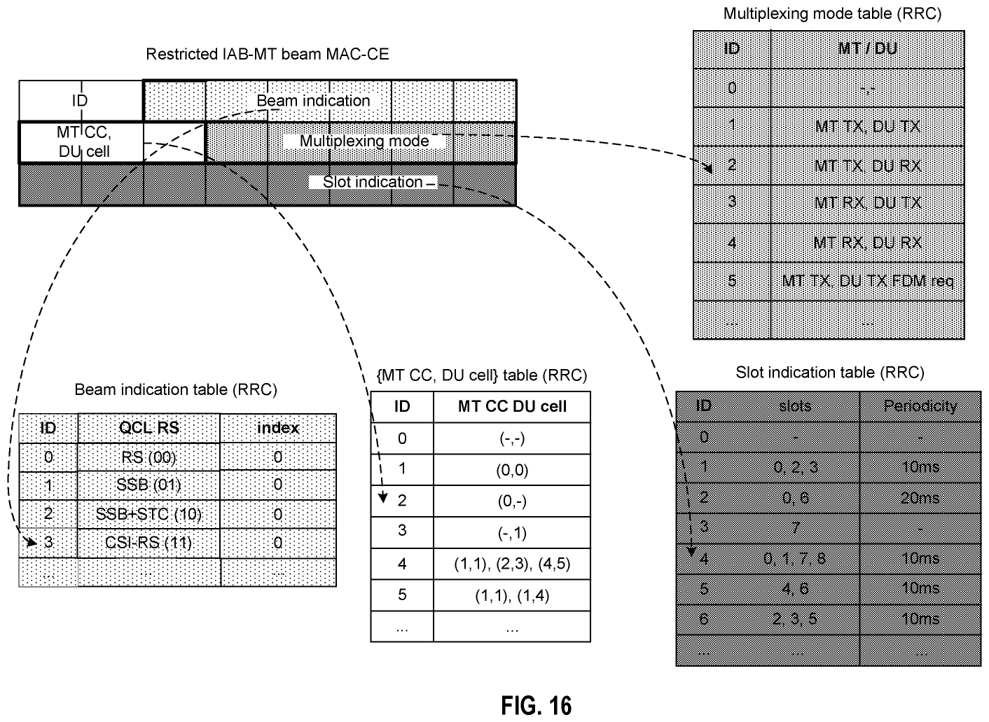

In a fifth step (104), the parent IAB-node indicates to the IAB-node the Provided multiplexing adaptation conditions. In other words, the parent node can determine the multiplexing mode of the IAB-DU based on its own operational conditions, such as timing, power control, serving beams etc. This indication from the parent IAB-node to the IAB-node is yet another additional or alternative example of the message 16 in FIG. 1. FIG. 16 gives an example of a MAC-CE signaling of the restricted IAB-MT beam MAC-CE which is used by the parent IAB-node to inform the IAB-node about restricted IAB-DU beam. Besides the ID which indicates the Nth restricted IAB-MT beam, there are bit-fields which contains pointers to the RRC-configured multiplexing adaptation parameters: beam indication table, multiplexing mode table, {MTCC, DU cell} table and Slot indication table, respectively.

In a final step (105), the parent IAB-node configures the IAB-MT according to the determined multiplexing mode (TDM, or FDM, or SDM etc.).

### Examples of the Implementation of the Upper Layers Configuration

In the following example, the RRC layer provides a set of multiplexing parameters for a beam configuration. The parameters are grouped in a list wherein each entry in the list comprises a beam configuration for a certain DU cell. The beam configuration is identified with a beamConfigurationID.

This RRC signaling exemplifies signaling 19 in FIG. 1, e.g., where the parameter 20 is the beam configuration parameter.

### IAB-DU-BeamConfigurationList

The IE IAB-DU-BeamConfigurationList is used to configure the beam configurations indicated in the Child IAB-DU Restricted Beam Indication MAC CE, in the IAB-MT Recommended Beam Indication MAC CE, in the Desired DL TX Power Adjustment MAC CE, in the DL TX Power Adjustment MAC CE, in the Desired IAB-MT PSD range MAC CE, as specified in TS 38.321 v16.8.0.

IAB-DU-BeamConfigurationList information element

-- ASN1START
-- TAG-IABDUBEAMCONFIGURATIONLIST-START

| | |
|---|---|
| IAB-DU-BeamConfigurationList-r17 | SEQUENCE { |
| iab-BeamConfigurationToAddModList-r17 | SEQUENCE (SIZE(1..maxNrofDUCells-r16)) |
| | OF IAB-DUCell-BeamConfiguration-r17 OPTIONAL, -- Need N |
| iab-BeamConfigurationToReleaseList-r17 | SEQUENCE (SIZE(1..maxNrofDUCells-r16)) |
| | OF IAB-DUCell-BeamConfiguration-r17 OPTIONAL, -- Need N |

...
}

| | |
|---|---|
| IAB-DUCell-BeamConfiguration-r17 | SEQUENCE { |
| duCellIndex | INTEGER (0..maxNrofDUCells-r16-1), |
| iab-BeamConfiguration-r17 | SEQUENCE (SIZE(1..FFS)) OF IAB-BeamConfiguration-r17 |
| | OPTIONAL, -- Need M |

...
}

| | |
|---|---|
| IAB-BeamConfiguration-r17 | SEQUENCE { |
| beamConfigurationID | INTEGER (1..FFS), |
| MT-cellID | SEQUENCE (SIZE(1..maxNrofServingCells)) OF |
| | ServCellIndex OPTIONAL, -- Need R |
| multiplexingModeInfo-r17 | MultiplexingModeInfo-r17 OPTIONAL, -- Need M |
| nonOverlappingFreqResModeInfo-r17 | ENUMERATED {supported} OPTIONAL, -- Need R |
| slotConfig-r17 | SlotConfig-r17 OPTIONAL, -- Need M |
| associatedBeamIndication-r17 | ENUMERATED {tciState, SSBId, CSI-RSId, SRI} |
| | OPTIONAL, -- Need M |
| nonOverlappingFreqResPowerAdj-r17 | ENUMERATED {supported} OPTIONAL, -- Need R |

...
}

| | |
|---|---|
| MultiplexingModeInfo-r17 | SEQUENCE { |
| duRX-mtRX | ENUMERATED {supported, fdmRequired} OPTIONAL, -- Need R |
| duTX-mtTX | ENUMERATED {supported, fdmRequired} OPTIONAL, -- Need R |
| duTX-mtRX | ENUMERATED {supported, fdmRequired} OPTIONAL, -- Need R |
| duRX-mtTX | ENUMERATED {supported, fdmRequired} OPTIONAL -- Need R |

}

| | |
|---|---|
| SlotConfig-r17 | SEQUENCE { |
| slotList-r17 | SEQUENCE (SIZE (1..5120))OF INTEGER (0..5119) |
| | OPTIONAL, -- Need M |
| periodicitySlotList-r17 | ENUMERATED {16, 20, 32, 40, 64, 80, 160, 320, 640, 1280, |
| | 2560, 5120} OPTIONAL -- Need M |

}
-- TAG-IABDUBEAMCONFIGURATIONLIST-STOP
-- ASN1STOP

IAB-DU-BeamConfigurationList field descriptions

associatedBeamIndication
Indicates whether the beam configuration signalled in the MAC CE (as specified in the TS
38.321) is associated to the TCI state ID, or SSB ID, or CSI-RS ID, or SRI.
beamConfigurationID
This ID is used to indicated the specific beam configuration addressed in the MAC CE, as
specified in TS 38.321.
duCellIndex
Indicates the index of the cell of the collocated IAB DU cell.
MT-cellID
Indicates the index of the serving cell of the IAB-MT. If the field is absent, the beam
configuration is applicable to all the serving cells of the IAB-MT for the collocated IAB DU cell.
multiplexingModeInfo
Indicates the multiplexing mode applied to the specific beam configuration. The duRX-mtRX
field indicates whether the IAB-node supports simultaneous reception at its DU and MT side;
the duTX-mtTX indicates whether the IAB-node supports simultaneous transmission at its DU
and MT side; the duTX-mtRX indicates whether the IAB-node supports simultaneous
transmission at its DU and reception at its MT side; the duRX-mtTX indicates whether the
IAB-node supports simultaneous reception at its DU and transmission at its MT side. When
the fdmRequired is set, the corresponding multiplexing mode is supported and FDM is
required.
nonOverlappingFreqResModeInfo
Indicates whether the configured multiplexing mode is applicable to non-overlapping
frequency resources.
nonOverlappingFreqResPowerAdj
Indicates whether the desired power adjustment signalled in the MAC CE (as specified in TS
38.321) is applied on FDM resources where the simultaneous MT's and DU's signals are non-
overlapping in the frequency-domain for the beam configuration.
periodicitySlotList
Indicates the periodicity of the list of slots indicated in slotList.
slotList
Indicates the list of slots associated to the specific beam configuration.

### Examples of the Implementation of the MAC CE Signalling

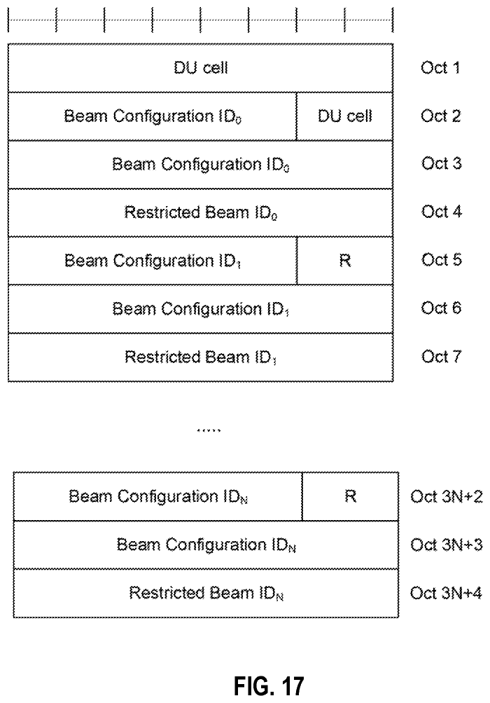

In FIG. 17 it is provided the MAC CE format of Child IAB-DU Restricted Beam Indication MAC CE. This Child IAB-DU Restricted Beam Indication MAC CE is one example of the message 16 in FIG. 1, with the beam configuration ID field exemplifying the field 18 in FIG. 1. The beam configuration ID refers to the beamConfigurationID configured by the RRC layer for a specific DU cell. For each beamConfigurationID it is provided the beam for which restricted operations are needed. The MAC CE may include multiple beam configuration IDs with their respective restricted beam indication. In particular, the following parameters are included in this MAC CE as an example.

DU Cell: This field indicates the identity of the collocated IAB DU cell identified by the duCellIndex within the IAB-DU-BeamConfigurationList in TS 38.331 v16.8.0 associated to the Beam Configuration IDᵢ. The length of the field is 10 bits.

Beam Configuration IDᵢ: This field indicates the Beam Configuration ID identified by iab-BeamConfiguration within the IAB-DU-BeamConfigurationList as specified in TS 38.331 v16.8.0. The length of the field is 14 bits.

Restricted Beam ID: An indication of the child IAB-DU's beam in the direction of which simultaneous operation is restricted. The length of the field is 8 bits.

R: Reserved bit, set to 0.

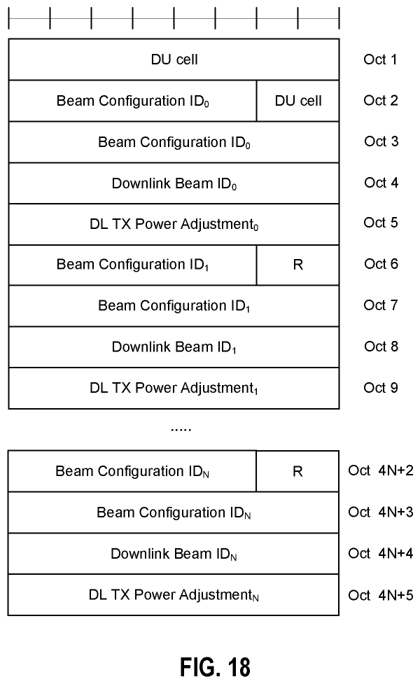

As another example, FIG. 18 shows the Child IAB-DU restricted beam indication MAC CE signalled by the parent IAB node to the child IAB node. The MAC CE refers to a specific beam configuration configured by upper layers and indicates for such a beam configuration the downlink transmitting power adjustment for a specific beam. In particular, the following parameters are included in this MAC CE as an example.

DU Cell: This field indicates the identity of the collocated IAB DU cell identified by the duCellIndex within the IAB-DU-BeamConfigurationList in TS 38.331 v16.8.0 associated to the Beam Configuration IDᵢ. The length of the field is 10 bits.

Beam Configuration IDᵢ: This field indicates the Beam Configuration ID identified by iab-BeamConfiguration within the IAB-DU-BeamConfigurationList as specified in TS 38.331 v16.8.0.

The length of the field is 14 bits.

Downlink Beam IDᵢ: An indication of the IAB-MT's DL beam for which the downlink transmitting power adjustment of the parent IAB node is indicated in the DL TX Power Adjustmentᵢ. It is indicated by the parent IAB node to its child IAB node. The length of the field is 8 bits.

DL TX Power Adjustmentᵢ: The DL TX Power Adjustment indicated by the parent IAB node to its child IAB node. The length of the field is 8 bits.

R: Reserved bit, set to 0.

### Another Example Implementation of the Upper Layers Configuration

In the following additional example, the RRC layer provides a set of multiplexing parameters for a beam configuration. The parameters are grouped in a list wherein each entry in the list comprises a beam configuration for a certain DU cell. The beam configuration is identified with a beamConfigurationID.

This RRC signaling exemplifies signaling 19 in FIG. 1, e.g., where the parameter 20 is the beam configuration parameter.

### IAB-DU-BeamConfigurationList

The IE IAB-DU-BeamConfigurationList is used to configure the beam configurations indicated in the Child IAB-DU Restricted Beam Indication MAC CE, in the IAB-MT Recommended Beam Indication MAC CE, in the Desired DL TX Power Adjustment MAC CE, in the DL TX Power Adjustment MAC CE, in the Desired IAB-MT PSD range MAC CE, as specified in TS 38.321 v16.8.0.

IAB-DU-BeamConfigurationList information element
IAB-BeamConfigurationList information element

-- ASN1START
-- TAG-IABBEAMCONFIGURATIONLIST-START

| | |
|---|---|
| IAB-BeamConfigurationList-r17 | SEQUENCE { |
| iab-BeamConfigurationToAddModList-r17 | SEQUENCE (SIZE(1..FFS)) OF IAB- |
| | BeamConfiguration-r17 OPTIONAL, -- Need N |
| iab-BeamConfigurationToReleaseList-r17 | SEQUENCE (SIZE(1..FFS)) OF IAB- |
| | BeamConfiguration-r17 OPTIONAL, -- Need N |

...
}

| | |
|---|---|
| IAB-BeamConfiguration-r17 | SEQUENCE { |
| beamConfigurationID | INTEGER (1..FFS), |
| duCellIndex | INTEGER (0..maxNrofDUCells-r16-1), |
| MT-cellID | SEQUENCE (SIZE(1..maxNrofServingCells)) OF |
| | ServCellIndex OPTIONAL, -- Need R |
| multiplexingModeInfo-r17 | MultiplexingModeInfo-r17 OPTIONAL, -- Need M |
| nonOverlappingFreqResModeInfo-r17 | ENUMERATED {supported} OPTIONAL, -- Need R |
| slotConfig-r17 | SlotConfig-r17 OPTIONAL, -- Need M |
| du-BeamIndicationAssociation-r17 | ENUMERATED {RSID, SSBId, CSI-RSId, |
| | SSBIdAndSTCId} OPTIONAL, -- Need M |
| mt-BeamIndicationAssociation-r17 | ENUMERATED {tciState, SSBId, CSI-RSId, SRI, RSId} |

OPTIONAL, -- Need M

| | |
|---|---|
| nonOverlappingFreqResPowerAdj-r17 | ENUMERATED {supported} OPTIONAL, -- Need R |

...
}

| | |
|---|---|
| MultiplexingModeInfo-r17 | SEQUENCE { |
| duRX-mtRX | ENUMERATED {supported, fdmRequired} OPTIONAL, -- Need R |
| duTX-mtTX | ENUMERATED {supported, fdmRequired} OPTIONAL, -- Need R |
| duTX-mtRX | ENUMERATED {supported, fdmRequired} OPTIONAL, -- Need R |
| duRX-mtTX | ENUMERATED {supported, fdmRequired} OPTIONAL -- Need R |

}

| SlotConfig-r17 | SEQUENCE { | |
|---|---|---|
| slotList-r17 | SEQUENCE (SIZE (1..5120))OF INTEGER (0..5119) | |
| | | OPTIONAL, -- Need M |
| periodicitySlotList-r17 | ENUMERATED {16, 20, 32, 40, 64, 80, 160, 320, 640, 1280, | |
| | 2560, 5120} | OPTIONAL -- Need M |

}
-- TAG-IABBEAMCONFIGURATIONLIST-STOP
-- ASN1STOP

IAB-BeamConfigurationList field descriptions

du-BeamIndicationAssociation
Indicates whether the Downlink beam IDs included in the Desired DL TX Power
Adjustment MAC CE and in the DL TX Power Adjustment MAC CE, or in the Restricted
beam ID in the Child IAB-DU Restricted Beam Indication MAC CE, or in the
Recommended Beam ID in the IAB-MT Recommended Beam Indication MAC CE (as
specified in the TS 38.32) are associated to the RS ID, or SSB ID, or CSI-RS ID, or SSB
ID plus STC Id.
beamConfigurationID
This ID is used to indicated the specific beam configuration addressed in the MAC CE,
as specified in TS 38.321.
duCellIndex
Indicates the index of the cell of the collocated IAB DU cell.
mt-BeamIndicationAssociation
Indicates whether the Uplink beam IDs included in the Desired IAB-MT PSD range MAC
CE, or in the Child IAB-DU Restricted Beam Indication MAC CE, or in the
Recommended Beam ID in IAB-MT Recommended Beam Indication MAC CE (as
specified in the TS 38.321) are associated to the TCI State ID, or SSB ID, or CSI-RS ID,
or SRI or RS ID.
MT-cellID
Indicates the index of the serving cell of the IAB-MT. If the field is absent, the beam
configuration is applicable to all the serving cells of the IAB-MT for the collocated IAB
DU cell.
multiplexingModeInfo
Indicates the multiplexing mode applied to the specific beam configuration. The duRX-
mtRX field indicates whether the IAB-node supports simultaneous reception at its DU
and MT side; the duTX-mtTX indicates whether the IAB-node supports simultaneous
transmission at its DU and MT side; the duTX-mtRX indicates whether the IAB-node
supports simultaneous transmission at its DU and reception at its MT side; the duRX-
mtTX indicates whether the IAB-node supports simultaneous reception at its DU and
transmission at its MT side. When the fdmRequired is set, the corresponding
multiplexing mode is supported and FDM is required.
nonOverlappingFreqResModeInfo
Indicates whether the configured multiplexing mode is applicable to non-overlapping
frequency resources.
nonOverlappingFreqResPowerAdj
Indicates whether the desired power adjustment signalled in the MAC CE (as specified
in TS 38.321 [3]) is applied on FDM resources where the simultaneous MT's and DU's
signals are non-overlapping in the frequency-domain for the beam configuration.
periodicitySlotList
Indicates the periodicity of the list of slots indicated in slotList.
slotList
Indicates the list of slots associated to the specific beam configuration. The entries of the
slotList are equal or less than the value set for the periodicitySlotList.

### And Another Example Implementation of the MAC CE Signalling

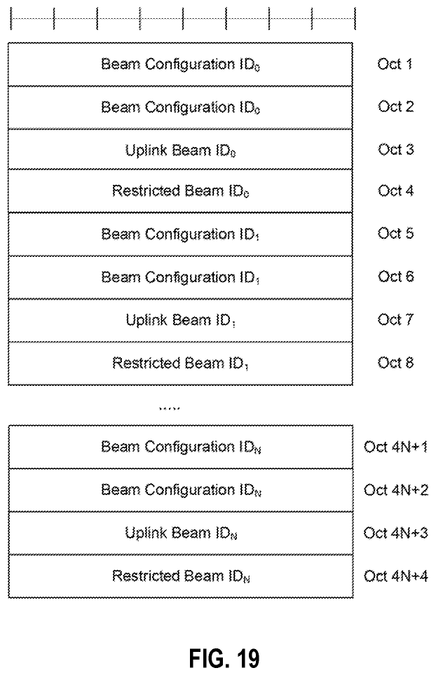

In FIG. 19 it is provided the MAC CE format of Child IAB-DU Restricted Beam Indication MAC CE. This Child IAB-DU Restricted Beam Indication MAC CE is one example of the message 16 in FIG. 1, with the beam configuration ID field exemplifying the field 18 in FIG. 1. The beam configuration ID refers to the beamConfigurationID configured by the RRC layer for a specific DU cell. For each beamConfigurationID it is provided the beam for which restricted operations are needed. The MAC CE may include multiple beam configuration IDs with their respective restricted beam indication. In particular, the following parameters are included in this MAC CE as an example.

Beam Configuration IDᵢ: This field indicates the Beam Configuration ID identified by iab-BeamConfiguration within the IAB-DU-BeamConfigurationList as specified in TS 38.331 v16.8.0. The length of the field is 16 bits.

Restricted Beam IDᵢ: An indication of the child IAB-DU's beam in the direction of which simultaneous operation is restricted when the Uplink Beam IDᵢ is applied. The length of the field is 8 bits.

Uplink Beam IDᵢ: An indication of the IAB-MT's UL beam for which the downlink operations are restricted when it is used.

R: Reserved bit, set to 0.

As another example, FIG. 19 shows the DL TX power Adjustment MAC CE signalled by the parent IAB node to the child IAB node. The MAC CE refers to a specific parent DU DL power configured by upper layers and indicates for such a beam configuration the downlink transmitting power adjustment for a specific beam. In particular, the following parameters are included in this MAC CE as an example.

Beam Configuration IDᵢ: This field indicates the Beam Configuration ID identified by iab-BeamConfiguration within the IAB-DU-BeamConfigurationList as specified in TS 38.331 v16.8.0. The length of the field is 16 bits.

Downlink Beam IDᵢ: An indication of the IAB-MT's DL beam for which the downlink transmitting power adjustment of the parent IAB node is indicated in the DL TX Power Adjustment; It is indicated by the parent IAB node to its child IAB node. The length of the field is 8 bits.

DL TX Power Adjustment: The DL TX Power Adjustment indicated by the parent IAB node to its child IAB node. The length of the field is 8 bits.

R: Reserved bit, set to 0.

As yet another example, some embodiments herein may be implemented or realized as shown below in terms of revisions to TS 38.331.

### 6.2.2 Message Definitions

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: Downlink Control Channel (DCCH)
Direction: Network to UE

RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig OPTIONAL, -- Need M |
| secondaryCellGroup | OCTET STRING (CONTAINING CellGroupConfig) |

OPTIONAL, -- Cond SCG

| | |
|---|---|
| measConfig | MeasConfig OPTIONAL, -- Need M |
| lateNonCriticalExtension | OCTET STRING OPTIONAL, |
| nonCriticalExtension | RRCReconfiguration-v1530-IEs OPTIONAL |

}

| | |
|---|---|
| RRCReconfiguration-v1530-IEs ::= | SEQUENCE { |
| masterCellGroup | OCTET STRING (CONTAINING CellGroupConfig) |

OPTIONAL, -- Need M

| | |
|---|---|
| fullConfig | ENUMERATED {true} OPTIONAL, -- Cond FullConfig |
| dedicatedNAS-MessageList | SEQUENCE (SIZE(1..maxDRB)) OF DedicatedNAS- |
| | Message OPTIONAL, -- Cond nonHO |
| masterKeyUpdate | MasterKeyUpdate OPTIONAL, -- Cond MasterKeyChange |
| dedicatedSIB1-Delivery | OCTET STRING (CONTAINING SIB1) OPTIONAL, -- Need N |
| dedicatedSystemInformationDelivery | OCTET STRING (CONTAINING SystemInformation) |

OPTIONAL, -- Need N

| | |
|---|---|
| otherConfig | OtherConfig OPTIONAL, -- Need M |
| nonCriticalExtension | RRCReconfiguration-v1540-IEs OPTIONAL |

}

| | |
|---|---|
| RRCReconfiguration-v1540-IEs ::= | SEQUENCE { |
| otherConfig-v1540 | OtherConfig-v1540 OPTIONAL, -- Need M |
| nonCriticalExtension | RRCReconfiguration-v1560-IEs OPTIONAL |

}

| | |
|---|---|
| RRCReconfiguration-v1560-IEs ::= | SEQUENCE { |
| mrdc-SecondaryCellGroupConfig | SetupRelease { MRDC-SecondaryCellGroupConfig } |

OPTIONAL, -- Need M

| | |
|---|---|
| radioBearerConfig2 | OCTET STRING (CONTAINING RadioBearerConfig) |

OPTIONAL, -- Need M

| | |
|---|---|
| sk-Counter | SK-Counter OPTIONAL, -- Need N |
| nonCriticalExtension | RRCReconfiguration-v1610-IEs |

OPTIONAL
}

| | |
|---|---|
| RRCReconfiguration-v1610-IEs ::= | SEQUENCE { |
| otherConfig-v1610 | OtherConfig-v1610 OPTIONAL, -- Need M |
| bap-Config-r16 | SetupRelease { BAP-Config-r16 } OPTIONAL, -- Need M |
| iab-IP-AddressConfigurationList-r16 | IAB-IP-AddressConfigurationList-r16 OPTIONAL, |

-- Need M

| | |
|---|---|
| conditionalReconfiguration-r16 | ConditionalReconfiguration-r16 OPTIONAL, -- Need M |
| daps-SourceRelease-r16 | ENUMERATED{true} OPTIONAL, -- Need N |
| t316-r16 | SetupRelease {T316-r16} OPTIONAL, -- Need M |
| needForGapsConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 } |

OPTIONAL, -- Need M

| | |
|---|---|
| dedicatedPosSysInfoDelivery-r16 | OCTET STRING (CONTAINING |
| PosSystemInformation-r16-IEs) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA-Info-r16} |

OPTIONAL, -- Need M

| | |
|---|---|
| targetCellSMTC-SCG-r16 | SSB-MTC OPTIONAL, -- Need S |
| nonCriticalExtension | RRCReconfiguration-v1700-IEs OPTIONAL |

}

| | |
|---|---|
| RRCReconfiguration-v1700-IEs ::= | SEQUENCE { |
| otherConfig-v1700 | OtherConfig-v1700 OPTIONAL, -- Need M |
| ul-GapFR2-Config-r17 | SetupRelease { UL-GapFR2-Config-r17 } OPTIONAL, |

-- Need M

| | |
|---|---|
| sl-L2RelayUEConfig-r17 | SetupRelease { SL-L2RelayUEConfig-r17 } |

OPTIONAL, -- Cond L2RelayUE

| | |
|---|---|
| sl-L2RemoteUEConfig-r17 | SetupRelease { SL-L2RemoteUEConfig-r17 } |
| | OPTIONAL, -- Cond L2RemoteUE |
| dedicatedPagingDelivery-r17 | OCTET STRING (CONTAINING Paging) |
| | OPTIONAL, -- L2U2NRelay |
| needForNCSG-ConfigNR-r17 | SetupRelease {NeedForNCSG-ConfigNR-r17} |
| | OPTIONAL, -- Need M |
| needForNCSG-ConfigEUTRA-r17 | SetupRelease {NeedForNCSG-ConfigEUTRA-r17} |
| | OPTIONAL, -- Need M |
| musim-GapConfig-r17 | SetupRelease {MUSIM-GapConfig-r17} |
| | OPTIONAL, -- Need M |
| scg-State-r17 | ENUMERATED { deactivated } OPTIONAL, -- Need S |
| appLayerMeasConfig-r17 | AppLayerMeasConfig-r17 OPTIONAL, -- Need M |
| iab-BeamConfigurationList-r17 | IAB-BeamConfigurationList-r17 OPTIONAL, -- Need M |
| nonCriticalExtension | SEQUENCE { } OPTIONAL |

}

| | |
|---|---|
| MRDC-SecondaryCellGroupConfig ::= | SEQUENCE { |
| mrdc-ReleaseAndAdd | ENUMERATED {true} OPTIONAL, -- Need N |
| mrdc-SecondaryCellGroup | CHOICE { |
| nr-SCG | OCTET STRING (CONTAINING RRCReconfiguration), |
| eutra-SCG | OCTET STRING |

}
}

| | |
|---|---|
| BAP-Config-r16 ::= | SEQUENCE { |
| bap-Address-r16 | BIT STRING (SIZE (10)) OPTIONAL, -- Need M |
| defaultUL-BAP-RoutingID-r16 | BAP-RoutingID-r16 OPTIONAL, -- Need M |
| defaultUL-BH-RLC-Channel-r16 | BH-RLC-ChannelID-r16 OPTIONAL, -- Need M |
| flowControlFeedbackType-r16 | ENUMERATED {perBH-RLC-Channel, perRoutingID, |
| | both} OPTIONAL, -- Need R |

...
}

| | |
|---|---|
| MasterKeyUpdate ::= | SEQUENCE { |
| keySetChangeIndicator | BOOLEAN, |
| nextHopChainingCount | NextHopChainingCount, |
| nas-Container | OCTET STRING OPTIONAL, -- Cond securityNASC |

...
}

| | |
|---|---|
| OnDemandSIB-Request-r16 ::= | SEQUENCE { |
| onDemandSIB-RequestProhibitTimer-r16 | ENUMERATED {s0, s0dot5, s1, s2, s5, s10, |
| | s20, s30} |

}
T316-r16 ::= ENUMERATED {ms50, ms100, ms200, ms300, ms400, ms500, ms600,

ms1000, ms1500, ms2000}

IAB-IP-AddressConfigurationList-r16 ::= SEQUENCE {

| iab-IP-AddressToAddModList-r16 | SEQUENCE (SIZE(1..maxIAB-IP-Address-r16)) OF | |
|---|---|---|
| | IAB-IP-AddressConfiguration-r16 OPTIONAL, -- Need N | |
| iab-IP-AddressToReleaseList-r16 | SEQUENCE (SIZE(1..maxIAB-IP-Address-r16)) OF IAB- | |
| | IP-AddressIndex-r16 | OPTIONAL, -- Need N |

...
}
IAB-IP-AddressConfiguration-r16 ::= SEQUENCE {

| | |
|---|---|
| iab-IP-AddressIndex-r16 | IAB-IP-AddressIndex-r16, |
| iab-IP-Address-r16 | IAB-IP-Address-r16 OPTIONAL, -- Need M |
| iab-IP-Usage-r16 | IAB-IP-Usage-r16 OPTIONAL, -- Need M |
| iab-donor-DU-BAP-Address-r16 | BIT STRING (SIZE(10)) OPTIONAL, -- Need M |

...
}

| | |
|---|---|
| SL-ConfigDedicatedEUTRA-Info-r16 ::= | SEQUENCE { |
| sl-ConfigDedicatedEUTRA-r16 | OCTET STRING OPTIONAL, -- Need M |
| sl-TimeOffsetEUTRA-List-r16 | SEQUENCE (SIZE (8)) OF SL-TimeOffsetEUTRA- |
| | r16 OPTIONAL -- Need M |

}

| | |
|---|---|
| SL-TimeOffsetEUTRA-r16 ::= | ENUMERATED {ms0, ms0dot25, ms0dot5, ms0dot625, |
| | ms0dot75, ms1, ms1dot25, ms1dot5, ms1dot75, |
| | ms2, ms2dot5, ms3, ms4, ms5, ms6, ms8, ms10, ms20} |

-- TAG-RRCRECONFIGURATION-STOP
-- ASN1STOP

RRCReconfiguration-IEs field descriptions

bap-Config
This field is used to configure the BAP entity for IAB nodes.
bap-Address
Indicates the BAP address of an IAB-node. The BAP address of an IAB-node cannot be
changed once configured to the BAP entity.
conditionalReconfiguration
Configuration of candidate target SpCell(s) and execution condition(s) for conditional
handover, conditional PSCell addition or conditional PSCell change. The field is absent if any
DAPS bearer is configured or if the masterCellGroup includes ReconfigurationWithSync. For
conditional PSCell change, the field is absent if the secondaryCellGroup includes
ReconfigurationWithSync. The RRCReconfiguration message contained in
DLInformationTransferMRDC cannot contain the field conditionalReconfiguration for
conditional PSCell change and conditional PSCell addition.
daps-SourceRelease
Indicates to UE that the source cell part of DAPS operation is to be stopped and the source
cell part of DAPS configuration is to be released.
dedicatedNAS-MessageList
This field is used to transfer UE specific NAS layer information between the network and the
UE. The RRC layer is transparent for each PDU in the list.
dedicatedPagingDelivery
This field is used to transfer Paging message to the L2 Relay UE in RRC_CONNECTED.
dedicatedPosSysInfoDelivery
This field is used to transfer SIBPos to the UE in RRC_CONNECTED.
dedicatedSIB1-Delivery
This field is used to transfer SIB1 to the UE. The field has the same values as the
corresponding configuration in servingCellConfigCommon.
dedicatedSystemInformationDelivery
This field is used to transfer SIB6, SIB7, SIB8 to the UE with an active BWP with no common
serach space configured. For UEs in RRC_CONNECTED, this field is used to transfer the
SIBs requested on-demand.
defaultUL-BAP-RoutingID
This field is used for IAB-node to configure the default uplink Routing ID, which is used by
IAB-node during IAB-node bootstrapping, migration, IAB-MT RRC resume and IAB-MT RRC
re-establishment for F1-C and non-F1 traffic. The defaultUL-BAP-RoutingID can be
(re-)configured when IAB-node IP address for F1-C related traffic changes. This field is
mandatory only for IAB-node bootstrapping.
defaultUL-BH-RLC-Channel
This field is used for IAB-nodes to configure the default uplink BH RLC channel, which is used
by IAB-node during IAB-node bootstrapping, migration, IAB-MT RRC resume and IAB-MT
RRC re-establishment for F1-C and non-F1 traffic. The defaultUL-BH-RLC-Channel can be
(re-)configured when IAB-node IP address for F1-C related traffic changes, and the new IP
address is anchored at a different IAB-donor-DU. This field is mandatory for IAB-node
bootstrapping. If the IAB-MT is operating in EN-DC, the default uplink BH RLC channel is
referring to an RLC channel on the SCG; Otherwise, it is referring to an RLC channel on the
MCG.
flowControlFeedbackType
This field is only used for IAB-node that support hop-by-hop flow control to configure the type
of flow control feedback. Value perBH-RLC-Channel indicates that the IAB-node shall provide
flow control feedback per BH RLC channel, value perRoutingID indicates that the IAB-node
shall provide flow control feedback per routing ID, and value both indicates that the IAB-node
shall provide flow control feedback both per BH RLC channel and per routing ID.
fullConfig
Indicates that the full configuration option is applicable for the RRCReconfiguration message
for intra-system intra-RAT HO. For inter-RAT HO from E-UTRA to NR, fullConfig indicates
whether or not delta signalling of SDAP/PDCP from source RAT is applicable. This field is
absent if any DAPS bearer is configured or when the RRCReconfiguration message is
transmitted on SRB3, and in an RRCReconfiguration message for SCG contained in another
RRCReconfiguration message (or RRCConnectionReconfiguration message, see TS 36.331 [10])
transmitted on SRB1.
iab-IP-Address
This field is used to provide the IP address information for IAB-node.
iab-IP-AddressIndex
This field is used to identify a configuration of an IP address.
iab-IP-AddressToAddModList
List of IP addresses allocated for IAB-node to be added and modified.
iab-IP-AddressToReleaseList
List of IP address allocated for IAB-node to be released.
iab-IP-Usage
This field is used to indicate the usage of the assigned IP address. If this field is not
configured, the assigned IP address is used for all traffic.
iab-donor-DU-BAP-Address
This field is used to indicate the BAP address of the IAB-donor-DU where the IP address is
anchored.
keySetChangeIndicator
Indicates whether UE shall derive a new K_{gNB}. If reconfigurationWithSync is included, value
true indicates that a K_{gNB} key is derived from a K_{AMF} key taken into use through the latest
successful NAS SMC procedure, or N2 handover procedure with K_{AMF} change, as described
in TS 33.501 [11] for K_{gNB} re-keying. Value false indicates that the new K_{gNB} key is obtained
from the current K_{gNB} key or from the NH as described in TS 33.501.
masterCellGroup
Configuration of master cell group.
mrdc-ReleaseAndAdd
This field indicates that the current SCG configuration is released and a new SCG is added at
the same time.
mrdc-SecondaryCellGroup
Includes an RRC message for SCG configuration in NR-DC or NE-DC.
For NR-DC (nr-SCG), mrdc-SecondaryCellGroup contains the RRCReconfiguration message
as generated (entirely) by SN gNB. In this version of the specification, the RRC message can
only include fields secondaryCellGroup, otherConfig, conditionalReconfiguration, measConfig
and bap-Config.
For NE-DC (eutra-SCG), mrdc-SecondaryCellGroup includes the E-UTRA
RRCConnectionReconfiguration message as specified in TS 36.331. In this version of the
specification, the E-UTRA RRC message can only include the field scg-Configuration.
musim-GapConfig
Indicates the MUSIM gap configuration and controls setup/release of MUSIM gaps.
nas-Container
This field is used to transfer UE specific NAS layer information between the network and the
UE. The RRC layer is transparent for this field, although it affects activation of AS security
after inter-system handover to NR. The content is defined in TS 24.501.
needForGapsConfigNR
Configuration for the UE to report measurement gap requirement information of NR target
bands in the RRCReconfigurationComplete and RRCResumeComplete message.
needForNCSG-ConfigEUTRA
Configuration for the UE to report measurement gap and NCSG requirement information of
E-UTRA target bands in the RRCReconfigurationComplete and RRCResumeComplete
message.
needForNCSG-ConfigNR
Configuration for the UE to report measurement gap and NCSG requirement information of
NR target bands in the RRCReconfigurationComplete and RRCResumeComplete message.
nextHopChainingCount
Parameter NCC: See TS 33.501
onDemandSIB-Request
If the field is present, the UE is allowed to request SIB(s) on-demand while in
RRC_CONNECTED according to clause 5.2.2.3.5.
onDemandSIB-RequestProhibitTimer
Prohibit timer for requesting SIB(s) on-demand while in RRC_CONNECTED according to
clause 5.2.2.3.5. Value in seconds. Value s0 means prohibit timer is set to 0 seconds, value
s0dot5 means prohibit timer is set to 0.5 seconds, value s1 means prohibit timer is set to 1
second and so on.
otherConfig
Contains configuration related to other configurations. When configured for the SCG, only
fields drx-PreferenceConfig, maxBW-PreferenceConfig, maxBW-PreferenceConfigFR2-2,
maxCC-PreferenceConfig, maxMIMO-LayerPreferenceConfig, maxMIMO-
LayerPreferenceConfigFR2-2, minSchedulingOffsetPreferenceConfig,
minSchedulingOffsetPreferenceConfigExt, btNameList, wlanNameList, sensorNameList and
obtainCommonLocation can be included.
radioBearerConfig
Configuration of Radio Bearers (DRBs, SRBs, multicast MRBs) including SDAP/PDCP. In
EN-DC this field may only be present if the RRCReconfiguration is transmitted over SRB3.
radioBearerConfig2
Configuration of Radio Bearers (DRBs, SRBs) including SDAP/PDCP. This field can only be
used if the UE supports NR-DC or NE-DC.
scg-State
Indicates that the SCG is in deactivated state. This field is not used in an RRCReconfiguration
message received within mrdc-SecondaryCellGroup, E-UTRA
RRCConnectionReconfiguration or E-UTRA RRCConnectionResume message. The field is
absent if CPA or CPC is configured for the UE, or if the RRCReconfiguration message is
contained in CondRRCReconfig.
sl-L2RelayUEConfig
Contains L2 U2N relay operation related configurations used by L2 U2N Relay UE.
sl-L2RemoteUEConfig
Contains L2 U2N relay operation related configurations used by L2 U2N Remote UE.
secondaryCellGroup
Configuration of secondary cell group ((NG)EN-DC or NR-DC).
sk-Counter
A counter used upon initial configuration of S-K_{gNB} or S-K_{eNB}, as well as upon refresh of S-
K_{gNB} or S-K_{eNB}. This field is always included either upon initial configuration of an NR SCG or
upon configuration of the first RB with keyToUse set to secondary, whichever happens first.
This field is absent if there is neither any NR SCG nor any RB with keyToUse set to
secondary.
sl-ConfigDedicatedNR
This field is used to provide the dedicated configurations for NR sidelink
communication/discovery.
sl-ConfigDedicatedEUTRA-Info
This field includes the E-UTRA RRCConnectionReconfiguration as specified in TS 36.331 [10].
In this version of the specification, the E-UTRA RRCConnectionReconfiguration can only
includes sidelink related fields for V2X sidelink communication, i.e. sl-V2X-ConfigDedicated,
sl-V2X-SPS-Config, measConfig and/or otherConfig.
sl-TimeOffsetEUTRA
This field indicates the possible time offset to (de)activation of V2X sidelink transmission after
receiving DCI format 3_1 used for scheduling V2X sidelink communication. Value ms0dpt75
corresponds to 0.75 ms, ms1 corresponds to 1 ms and so on. The network includes this field
only when sl-ConfigDedicatedEUTRA is configured.
targetCellSMTC-SCG
The SSB periodicity/offset/duration configuration of target cell for NR PSCell addition and SN
change. When UE receives this field, UE applies the configuration based on the timing
reference of NR PCell for PSCell addition and PSCell change for the case of no
reconfiguration with sync of MCG, and UE applies the configuration based on the timing
reference of target NR PCell for the case of reconfiguration with sync of MCG. If both this field
and the smtc in secondaryCellGroup −> SpCellConfig −> reconfigurationWithSync are absent,
the UE uses the SMTC in the measObjectNR having the same SSB frequency and subcarrier
spacing, as configured before the reception of the RRC message.
t316
Indicates the value for timer T316 as described in clause 7.1. Value ms50 corresponds to 50
ms, value ms100 corresponds to 100 ms and so on. This field can be configured only if the
UE is configured with split SRB1 or SRB3.
ul-GapFR2-Config-r17
Indicates the FR2 UL gap configuration to UE. In EN-DC and NGEN-DC, the SN decides and
configures the FR2 UL gap pattern. In NE-DC, the MN decides and configures the FR2 UL
gap pattern. In NR-DC without FR2-FR2 band combination, the network entity which
configures FR2 bands to UE decides and configures the FR2 UL gap pattern.

| Conditional Presence | Explanation |
|---|---|
| nonHO | The field is absent in case of reconfiguration with sync |
| | within NR or to NR; otherwise it is optionally present, need |
| | N. |
| securityNASC | This field is mandatory present in case of inter system |
| | handover. Otherwise the field is optionally present, need |
| | N. |
| MasterKeyChange | This field is mandatory present in case masterCellGroup |
| | includes ReconfigurationWithSync and |
| | RadioBearerConfig includes SecurityConfig with |
| | SecurityAlgorithmConfig, indicating a change of the AS |
| | security algorithms associated to the master key. If |
| | ReconfigurationWithSync is included for other cases, this |
| | field is optionally present, need N. Otherwise the field is |
| | absent. |
| FullConfig | The field is mandatory present in case of inter-system |
| | handover from E-UTRA/EPC to NR. It is optionally |
| | present, Need N, during reconfiguration with sync and |
| | also in first reconfiguration after reestablishment; or for |
| | intra-system handover from E-UTRA/5GC to NR. It is |
| | absent otherwise. |
| SCG | The field is mandatory present in: |
| | an RRCReconfiguration message contained in an |
| | RRCResume message (or in an |
| | RRCConnectionResume message, see TS 36.331), |
| | an RRCReconfiguration message contained in an |
| | RRCConnectionReconfiguration message, see TS |
| | 36.331, which is contained in |
| | DLInformationTransferMRDC transmitted on SRB3 |
| | (as a response to ULInformationTransferMRDC |
| | including an MCGFailureInformation). |
| | The field is optional present, Need M, in: |
| | an RRCReconfiguration message transmitted on |
| | SRB3, |
| | an RRCReconfiguration message contained in |
| | another RRCReconfiguration message (or in an |
| | RRCConnectionReconfiguration message, see TS |
| | 36.331) transmitted on SRB1 |
| | an RRCReconfiguration message contained in |
| | another RRCReconfiguration message which is |
| | contained in DLInformationTransferMRDC |
| | transmitted on SRB3 (as a response to |
| | ULInformationTransferMRDC including an |
| | MCGFailureInformation) |
| | Otherwise, the field is absent |
| L2RelayUE | For L2 U2N Relay UE, the field is optionally present, Need |
| | M. Otherwise, it is absent. |
| L2RemoteUE | The field is optional present for L2 U2N Remote UE, need |
| | M; otherwise it is absent. |
| L2U2NRelay | For L2 U2N Relay UE, the field is optionally present, Need |
| | N. Otherwise, it is absent. |

### 6.3.2 Radio Resource Control Information Elements

### <Text Omitted>

The IE IAB-BeamConfigurationList is used to configure the beam configurations indicated in the Child IAB-DU Restricted Beam Indication MAC CE, in the IAB-MT Recommended Beam Indication MAC CE, in the Desired DL TX Power Adjustment MAC CE, in the DL TX Power Adjustment MAC CE, in the Desired IAB-MT PSD range MAC CE, as specified in TS 38.321.

IAB-BeamConfigurationList information element

-- ASN1START
-- TAG-IABBEAMCONFIGURATIONLIST-START

| | |
|---|---|
| IAB-BeamConfigurationList-r17 | SEQUENCE { |
| iab-BeamConfigurationToAddModList-r17 | SEQUENCE (SIZE(1..FFS)) OF IAB- |
| | BeamConfiguration-r17 OPTIONAL, -- Need N |
| iab-BeamConfigurationToReleaseList-r17 | SEQUENCE (SIZE(1..FFS)) OF IAB- |
| | BeamConfiguration-r17 OPTIONAL, -- Need N |

...
}

| | |
|---|---|
| IAB-BeamConfiguration-r17 | SEQUENCE { |
| beamConfigurationID | INTEGER (1..FFS), |
| duCellIndex | INTEGER (0.. maxNrofDUCells-r16-1), |
| MT-cellID | SEQUENCE (SIZE(1..maxNrofServingCells)) OF |
| | ServCellIndex OPTIONAL, -- Need R |
| multiplexingModeInfo-r17 | MultiplexingModeInfo-r17 OPTIONAL, -- Need M |
| nonOverlappingFreqResModeInfo-r17 | ENUMERATED {supported} OPTIONAL, -- Need R |
| slotConfig-r17 | SlotConfig-r17 OPTIONAL, -- Need M |
| du-BeamIndicationAssociation-r17 | ENUMERATED {RSID, SSBId, CSI-RSId, |
| | SSBIdAndSTCId} OPTIONAL, -- Need M |
| mt-BeamIndicationAssociation-r17 | ENUMERATED {tciState, SSBId, CSI-RSId, SRI, |
| | RSId} OPTIONAL, -- Need M |
| nonOverlappingFreqResPowerAdj-r17 | ENUMERATED {supported} OPTIONAL, -- Need R |

...
}

| | |
|---|---|
| MultiplexingModeInfo-r17 | SEQUENCE { |
| duRX-mtRX | ENUMERATED {supported, fdmRequired} OPTIONAL, -- Need R |
| duTX-mtTX | ENUMERATED {supported, fdmRequired} OPTIONAL, -- Need R |
| duTX-mtRX | ENUMERATED {supported, fdmRequired} OPTIONAL, -- Need R |
| duRX-mtTX | ENUMERATED {supported, fdmRequired} OPTIONAL -- Need R |

}

| | |
|---|---|
| SlotConfig-r17 | SEQUENCE { |
| slotList-r17 | SEQUENCE (SIZE (1..5120))OF INTEGER (0..5119) |
| | OPTIONAL, -- Need M |
| periodicitySlotList-r17 | ENUMERATED {16, 20, 32, 40, 64, 80, 160, 320, 640, 1280, |
| | 2560, 5120} OPTIONAL -- Need M |

}
-- TAG-IABBEAMCONFIGURATIONLIST-STOP
-- ASN1STOP

IAB-BeamConfigurationList field descriptions

du-BeamIndicationAssociation
Indicates whether the Downlink beam IDs included in the Desired DL TX Power Adjustment MAC
CE and in the DL TX Power Adjustment MAC CE, or in the Restricted beam ID in the Child IAB-DU
Restricted Beam Indication MAC CE, or in the Recommended Beam ID in the IAB-MT
Recommended Beam Indication MAC CE (as specified in the TS 38.321) are associated to the RS
ID, or SSB ID, or CSI-RS ID, or SSB ID plus STC Id.
beamConfigurationID
This ID is used to indicated the specific beam configuration addressed in the MAC CE, as specified
in TS 38.321.
duCellIndex
Indicates the index of the cell of the collocated IAB DU cell.
mt-BeamIndicationAssociation
Indicates whether the Uplink beam IDs included in the Desired IAB-MT PSD range MAC CE, or in
the Child IAB-DU Restricted Beam Indication MAC CE, or in the Recommended Beam ID in IAB-MT
Recommended Beam Indication MAC CE (as specified in the TS 38.321) are associated to the TCI
State ID, or SSB ID, or CSI-RS ID, or SRI or RS ID.
MT-cellID
Indicates the index of the serving cell of the IAB-MT. If the field is absent, the beam configuration is
applicable to all the serving cells of the IAB-MT for the collocated IAB DU cell.
multiplexingModeInfo
Indicates the multiplexing mode applied to the specific beam configuration. The duRX-mtRX field
indicates whether the IAB-node supports simultaneous reception at its DU and MT side; the duTX-
mtTX indicates whether the IAB-node supports simultaneous transmission at its DU and MT side;
the duTX-mtRX indicates whether the IAB-node supports simultaneous transmission at its DU and
reception at its MT side; the duRX-mtTX indicates whether the IAB-node supports simultaneous
reception at its DU and transmission at its MT side. When the fdmRequired is set, the
corresponding multiplexing mode is supported and FDM is required.
nonOverlappingFreqResModeInfo
Indicates whether the configured multiplexing mode is applicable to non-overlapping frequency
resources.
nonOverlappingFreqResPowerAdj
Indicates whether the desired power adjustment signalled in the MAC CE (as specified in TS
38.321 [3]) is applied on FDM resources where the simultaneous MT's and DU's signals are non-
overlapping in the frequency-domain for the beam configuration.
periodicitySlotList
Indicates the periodicity of the list of slots indicated in slotList.
slotList
Indicates the list of slots associated to the specific beam configuration. The entries of the slotList
are equal or less than the value set for the periodicitySlotList.

### Example MAC CE Implemented in Terms of Revisions to TS 38.321

### 6.1.3 MAC Control Elements (CEs)

### <Text Omitted>

The Child IAB-DU Restricted Beam Indication MAC CE is identified by MAC subheader with eLCID. It has a variable size with the fields shown in FIG. 19:

Beam Configuration IDᵢ: This field indicates the Beam Configuration ID identified by iab-BeamConfiguration within the IAB-DU-BeamConfigurationList as specified in TS 38.331. The length of the field is 16 bits.

Restricted Beam IDᵢ: An indication of the child IAB-DU's beam in the direction of which simultaneous operation is restricted when the Uplink Beam ID; is applied. The length of the field is 8 bits.

Uplink Beam IDᵢ: An indication of the IAB-MT's UL beam for which the downlink operations are restricted when it is used.

R: Reserved bit, set to 0.

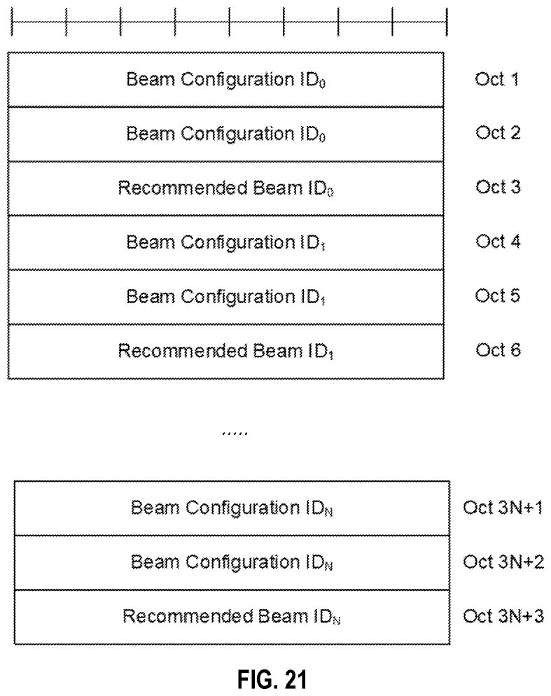

The IAB-MT Recommended Beam Indication MAC CE is identified by MAC subheader with eLCID. It has a variable size with the fields shown in FIG. 21:

Beam Configuration IDᵢ: This field indicates the Beam Configuration ID identified by iab-BeamConfiguration within the IAB-DU-BeamConfigurationList as specified in TS 38.331. The length of the field is 16 bits.

Recommended Beam IDᵢ: An indication of recommended beams of the IAB-MT to its parent node for downlink Rx beams or uplink Tx beams. The length of the field is 8 bits.

R: Reserved bit, set to 0.

### 6.1.3.z Desired DL TX Power Adjustment

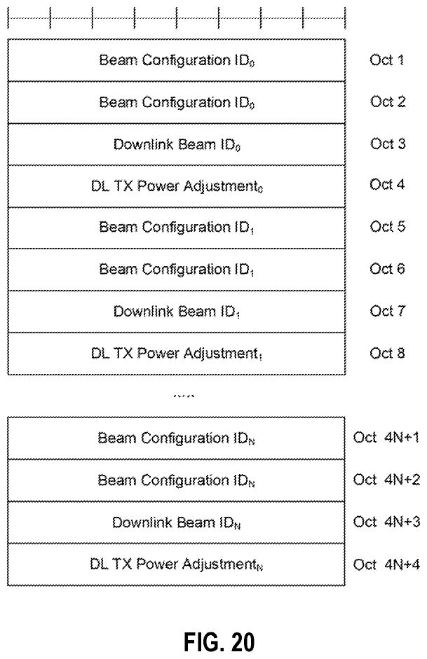

The Desired DL TX Power Adjustment MAC CE is identified by MAC subheader with eLCID. It has a variable size with the fields shown in FIG. 20:

Beam Configuration IDᵢ: This field indicates the Beam Configuration ID identified by iab-BeamConfiguration within the IAB-DU-BeamConfigurationList as specified in TS 38.331. The length of the field is 16 bits.

Downlink Beam IDᵢ: An indication of the IAB-MT's DL beam for which the desired downlink transmitting power adjustment is indicated in the Desired DL TX Power Adjustment; by the IAB-MT to its parent IAB node. The length of the field is 8 bits.

Desired DL TX Power Adjustment: The Desired DL TX Power Adjustment indicated by the child IAB node to its parent IAB node. The length of the field is 8 bits.

R: Reserved bit, set to 0.

The DL TX Power Adjustment MAC CE is identified by MAC subheader with eLCID. It has a variable size with the fields shown in FIG. 20:

Beam Configuration IDᵢ: This field indicates the Beam Configuration ID identified by iab-BeamConfiguration within the IAB-DU-BeamConfigurationList as specified in TS 38.331. The length of the field is 16 bits.

Downlink Beam IDᵢ: An indication of the IAB-MT's DL beam for which the downlink transmitting power adjustment of the parent IAB node is indicated in the DL TX Power Adjustmentᵢ. It is indicated by the parent IAB node to its child IAB node. The length of the field is 8 bits.

DL TX Power Adjustment: The DL TX Power Adjustment indicated by the parent IAB node to its child IAB node. The length of the field is 8 bits.

R: Reserved bit, set to 0.

6.1.3.v Desired IAB-MT PSD Range

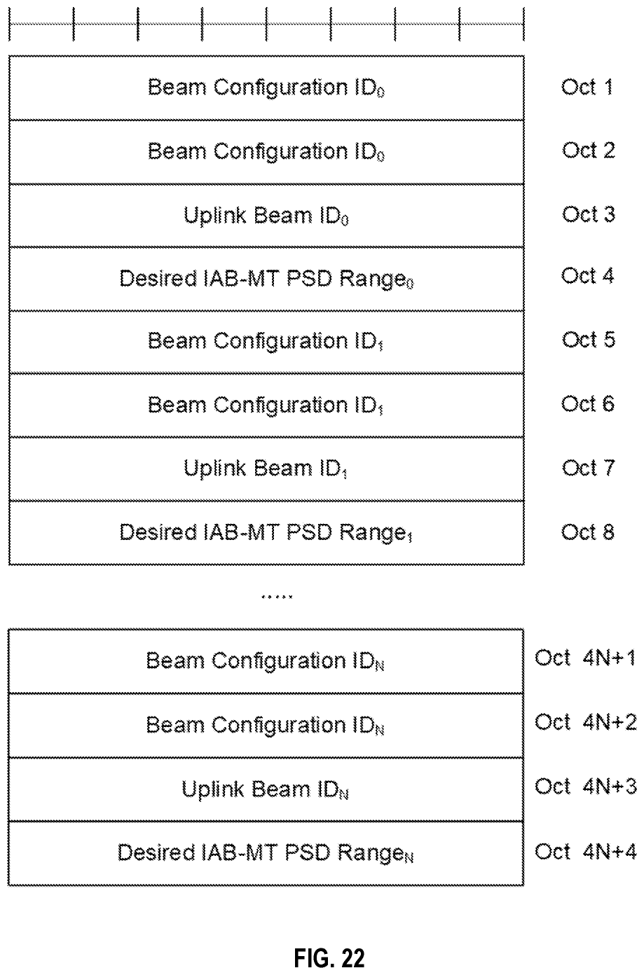

The Desired IAB-MT PSD range MAC CE is identified by MAC subheader with eLCID. It has a variable size with the fields shown in FIG. 22:

Beam Configuration IDᵢ: This field indicates the Beam Configuration ID identified by iab-BeamConfiguration within the IAB-DU-BeamConfigurationList as specified in TS 38.331. The length of the field is 16 bits.

Uplink Beam IDᵢ: An indication of the IAB-MT's UL beam for which the downlink transmitting power adjustment of the parent IAB node is indicated in the Desired IAB-MT PSD rangeᵢ. It is indicated by the IAB-MT to its parent IAB node. The length of the field is 8 bits.

Desired IAB-MT PSD rangeᵢ: The Desired IAB-MT PSD range for the UL power control indicated by the IAB-MT to its parent IAB node. The length of the field is 8 bits.

R: Reserved bit, set to 0.

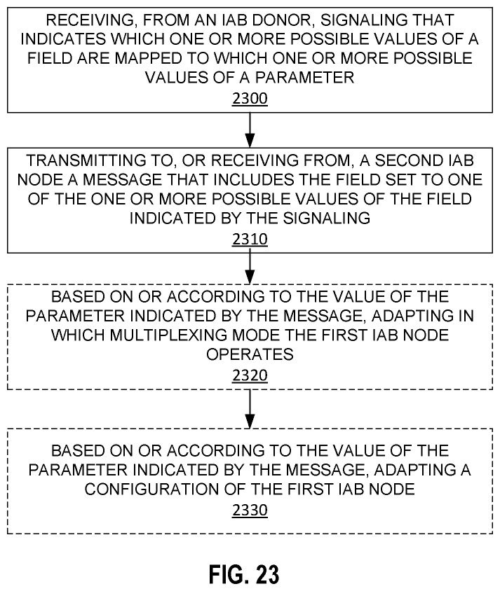

In view of the modifications and variations herein, FIG. 23 shows a method performed by a first integrated access backhaul, IAB, node 12A. The method comprises receiving, from an IAB donor 14, signaling 19 that indicates which one or more possible values 18-1 . . . 18-X of a field 18 are mapped to which one or more possible values 20-1 . . . 20-M of a parameter 20 (Block 2300). The method also comprises transmitting to, or receiving from, a second IAB node 12B a message 16 that includes the field 18 set to one of the one or more possible values 18-1 . . . 18-X of the field 18 indicated by the signaling 19 (Block 2310).

In some embodiments, the one or more possible values 20-1 . . . 20-M of the parameter 20 to which the one or more possible values 18-1 . . . 18-X of the field 18 are mapped comprise a subset 24 of a set 22 of N multiple possible values 20-1 . . . 20-N of the parameter 20.

In some embodiments, the signaling 19 is upper layer signaling received at an upper layer of a protocol stack. In this case, the upper layer is above a layer at which the message 16 is transmitted or received.

In some embodiments, the signaling is radio resource control signaling, F1 signaling, or operation and maintenance signaling.

In some embodiments, the signaling is received from a central unit, CU, of the IAB donor.

In some embodiments, the message is a medium access control, MAC, message or a downlink control information, DCI, message.

In some embodiments, the field is included in a MAC control element, CE, of a MAC message.

In some embodiments, the parameter indicates a configuration according to which the first IAB node or the second IAB node operates or is requested to operate.

In some embodiments, the parameter indicates a configuration according to which the first IAB node or the second IAB node operates, or is requested to operate, in order for a multiplexing IAB node to operate in a multiplexing mode. In some embodiments, a multiplexing mode is a mode in which the multiplexing IAB node multiplexes communication on a parent IAB link with communication on a child IAB link. In some embodiments, the multiplexing IAB node is the first IAB node or the second IAB node.

In some embodiments, the parameter is a multiplexing adaptation parameter that facilitates or governs adaptation of in which multiplexing mode, if any, a multiplexing IAB node operates. In some embodiments, the multiplexing IAB node is an IAB node capable of operating in a multiplexing mode. In some embodiments, a multiplexing mode is a mode in which the multiplexing IAB node multiplexes communication on a parent IAB link with communication on a child IAB link. In some embodiments, the parent IAB link is a link between the multiplexing IAB node and a parent IAB node. In some embodiments, the child IAB link is a link between the multiplexing IAB node and a child IAB node. In some embodiments, the multiplexing IAB node is the first IAB node or the second IAB node.

In one or more of these embodiments, the multiplexing adaptation parameter is a condition parameter indicating a condition that has been applied, or that is requested to be applied, in order for the multiplexing IAB node to operate in a multiplexing mode. In one or more of these embodiments, the multiplexing IAB node comprises a mobile termination, MT, and a distributed unit, DU. In some embodiments, the condition is restriction of simultaneous transmission at the multiplexing node in the direction of one or more beams of the DU. Alternatively, the condition is use of one or more specified beams by the MT for communication on the parent IAB link. Alternatively, the condition is adjustment of a downlink transmission power by the parent IAB node. Alternatively, the condition is power spectral density, PSD, of the MT being within a specified range. Alternatively, the condition is use of certain timing modes in certain respective time slots. Alternatively, the condition is a combination of any two or more of the above.

In other embodiments, the multiplexing adaptation parameter is an association parameter indicating one or more times, frequencies, and/or cells associated with a condition that has been applied, or that is requested to be applied, in order for the multiplexing IAB node to operate in a multiplexing mode. In one or more of these embodiments, the association parameter indicates one or more indices of one or more time slots associated with the condition. In one or more of these embodiments, the association parameter indicates one or more distributed unit, DU, resource configurations associated with the condition. In one or more of these embodiments, the association parameter indicates one or more carrier-cell pairs associated with the condition. In some embodiments, each of the one or more carrier-cell pairs is a pair of an IAB mobile termination component carrier and an IAB distributed unit cell. In one or more of these embodiments, the multiplexing adaptation parameter is an association parameter indicating a multiplexing mode associated with a condition that has been applied, or that is requested to be applied, in order for the multiplexing IAB node to operate in the indicated multiplexing mode.

In some embodiments, the multiplexing IAB node comprises a mobile termination, MT, and a distributed unit, DU. In some embodiments, the multiplexing IAB node is configured to multiplex communication by the MT on the parent IAB link towards the parent IAB node with communication by the DU on the child IAB link towards the child IAB node. In one or more of these embodiments, the multiplexing IAB node is capable of operating in any one of multiple possible multiplexing modes. In some embodiments, the multiple possible multiplexing modes include at least a TDM mode in which the multiplexing IAB node uses time-domain multiplexing, TDM, to multiplex communication by the MT on the parent IAB link towards the parent IAB node with communication by the DU on the child IAB link towards the child IAB node. Additionally or alternatively, the multiple possible multiplexing modes include at least an FDM mode in which the multiplexing IAB node uses frequency-domain multiplexing, FDM, to multiplex communication by the MT on the parent IAB link towards the parent IAB node with communication by the DU on the child IAB link towards the child IAB node. Additionally or alternatively, the multiple possible multiplexing modes include at least an SDM mode in which the multiplexing IAB node uses spatial-domain multiplexing, SDM, to multiplex communication by the MT on the parent IAB link towards the parent IAB node with communication by the DU on the child IAB link towards the child IAB node. Additionally or alternatively, the multiple possible multiplexing modes include at least a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

In some embodiments, the multiplexing IAB node is the first IAB node. In one or more of these embodiments, the method further comprises, based on or according to the value of the parameter indicated by the message, adapting in which multiplexing mode the first IAB node operates (Block 2320).

In some embodiments, the first IAB node is the parent IAB node. In one or more of these embodiments, the method further comprises, based on or according to the value of the parameter indicated by the message, adapting a configuration of the first IAB node (Block 2330).

In some embodiments, the field is an identity, ID, field or an index field.

In some embodiments, the message is a first message. In some embodiments, the method further comprises receiving, from the IAB donor, signaling that changes which one or more possible values of the field are mapped to which one or more possible values of the parameter. In some embodiments, the method further comprises transmitting to, or receiving from, the second IAB node a second message that includes the field set to one of the one or more possible values of the field indicated by the signaling.

In some embodiments, the field is a first field and the parameter is a first parameter. In some embodiments, the method further comprises receiving, from the IAB donor, signaling that indicates which one or more possible values of a second field are mapped to which one or more possible values of a second parameter. In some embodiments, the message further includes the second field set to one of the one or more possible values of the second field indicated by the signaling.

In some embodiments, the signaling comprises a mapping between the one or more possible values of the field to the one or more possible values of the parameter.

In some embodiments, the parameter is a beam configuration parameter.

In some embodiments, the parameter is a beam configuration for a certain distributed unit, DU, cell.

In some embodiments, the first IAB node is a parent IAB node with respect to the second IAB node.

In some embodiments, the first IAB node is a child IAB node with respect to the second IAB node.

In some embodiments, the IAB donor is the second IAB node.

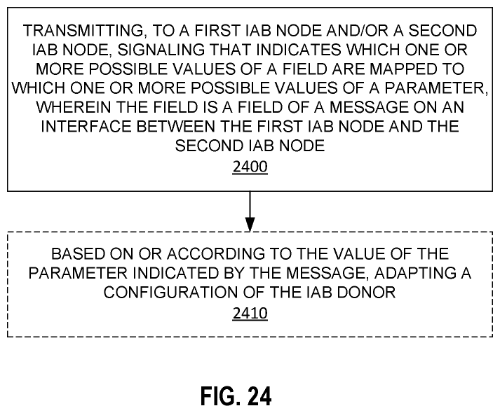

FIG. 24 shows a method performed by an integrated access backhaul, IAB, donor 14, e.g., configured for use in a communication network 10. The method comprises transmitting, to a first IAB node 12A and/or a second IAB node 12B, signaling 19 that indicates which one or more possible values 18-1 . . . 18-X of a field 18 are mapped to which one or more possible values 20-1 . . . 20-M of a parameter 20 (Block 2400). In some embodiments, the field 18 is a field 18 of a message 16 on an interface between the first IAB node 12A and the second IAB node 12B.

In some embodiments, the one or more possible values of the parameter to which the one or more possible values of the field are mapped comprise a subset of multiple possible values of the parameter.

In some embodiments, the signaling is upper layer signaling transmitted at an upper layer of a protocol stack. In some embodiments, the upper layer is above a layer at which the message is transmitted or received on the interface between the first and second IAB nodes.

In some embodiments, the signaling is radio resource control signaling, F1 signaling, or operation and maintenance signaling.

In some embodiments, the signaling is transmitted by a central unit, CU, of the IAB donor.

In some embodiments, the message is a medium access control, MAC, message or a downlink control information, DCI, message.

In some embodiments, the field is included in a MAC control element, CE, of a MAC message.

In some embodiments, the parameter indicates a configuration according to which the first IAB node or the second IAB node operates or is requested to operate.

In some embodiments, the parameter indicates a configuration according to which the first IAB node or the second IAB node operates, or is requested to operate, in order for a multiplexing IAB node to operate in a multiplexing mode. In some embodiments, a multiplexing mode is a mode in which the multiplexing IAB node multiplexes communication on a parent IAB link with communication on a child IAB link. In some embodiments, the multiplexing IAB node is the first IAB node or the second IAB node.

In some embodiments, the parameter is a multiplexing adaptation parameter that facilitates or governs adaptation of in which multiplexing mode, if any, a multiplexing IAB node operates. In some embodiments, the multiplexing IAB node is an IAB node capable of operating in a multiplexing mode. In some embodiments, a multiplexing mode is a mode in which the multiplexing IAB node multiplexes communication on a parent IAB link with communication on a child IAB link. In some embodiments, the parent IAB link is a link between the multiplexing IAB node and a parent IAB node. In some embodiments, the child IAB link is a link between the multiplexing IAB node and a child IAB node. In some embodiments, the multiplexing IAB node is the first IAB node or the second IAB node.

In one or more of these embodiments, the multiplexing adaptation parameter is a condition parameter indicating a condition that has been applied, or that is requested to be applied, in order for the multiplexing IAB node to operate in a multiplexing mode. In one or more of these embodiments, the multiplexing IAB node comprises a mobile termination, MT, and a distributed unit, DU. In some embodiments, the condition is restriction of simultaneous transmission at the multiplexing node in the direction of one or more beams of the DU. Alternatively, the condition is use of one or more specified beams by the MT for communication on the parent IAB link. Alternatively, the condition is adjustment of a downlink transmission power by the parent IAB node. Alternatively, the condition is power spectral density, PSD, of the MT being within a specified range. Alternatively, the condition is use of certain timing modes in certain respective time slots. Alternatively, the condition is a combination of any two or more of the above.

In other embodiments, the multiplexing adaptation parameter is an association parameter indicating one or more times, frequencies, and/or cells associated with a condition that has been applied, or that is requested to be applied, in order for the multiplexing IAB node to operate in a multiplexing mode. In one or more of these embodiments, the association parameter indicates one or more indices of one or more time slots associated with the condition. In one or more of these embodiments, the association parameter indicates one or more distributed unit, DU, resource configurations associated with the condition. In one or more of these embodiments, the association parameter indicates one or more carrier-cell pairs associated with the condition. In some embodiments, each of the one or more carrier-cell pairs is a pair of an IAB mobile termination component carrier and an IAB distributed unit cell.

In some embodiments, the multiplexing adaptation parameter is an association parameter indicating a multiplexing mode associated with a condition that has been applied, or that is requested to be applied, in order for the multiplexing IAB node to operate in the indicated multiplexing mode.

In one or more of these embodiments, the multiplexing IAB node comprises a mobile termination, MT, and a distributed unit, DU. In some embodiments, the multiplexing IAB node is configured to multiplex communication by the MT on the parent IAB link towards the parent IAB node with communication by the DU on the child IAB link towards the child IAB node. In one or more of these embodiments, the multiplexing IAB node is capable of operating in any one of multiple possible multiplexing modes. In some embodiments, the multiple possible multiplexing modes include at least a TDM mode in which the multiplexing IAB node uses time-domain multiplexing, TDM, to multiplex communication by the MT on the parent IAB link towards the parent IAB node with communication by the DU on the child IAB link towards the child IAB node. In some embodiments, the multiple possible multiplexing modes include at least an FDM mode in which the multiplexing IAB node uses frequency-domain multiplexing, FDM, to multiplex communication by the MT on the parent IAB link towards the parent IAB node with communication by the DU on the child IAB link towards the child IAB node. In some embodiments, the multiple possible multiplexing modes include at least an SDM mode in which the multiplexing IAB node uses spatial-domain multiplexing, SDM, to multiplex communication by the MT on the parent IAB link towards the parent IAB node with communication by the DU on the child IAB link towards the child IAB node. In some embodiments, the multiple possible multiplexing modes include at least a combination mode in which the multiplexing IAB node uses a combination of two or more of TDM, FDM, and SDM to multiplex communication by the MT on the parent IAB link towards the parent IAB node with communication by the DU on the child IAB link towards the child IAB node. In one or more of these embodiments, the multiplexing IAB node is configured to multiplex transmission by the MT on the parent IAB link towards the parent IAB node with transmission by the DU on the child IAB link towards the child IAB node. In some embodiments, the multiplexing IAB node is configured to multiplex transmission by the MT on the parent IAB link towards the parent IAB node with reception by the DU on the child IAB link towards the child IAB node.

In one or more of these embodiments, the multiplexing IAB node is the first IAB node. In one or more of these embodiments, the IAB donor is the parent IAB node. In one or more of these embodiments, the method further comprises, based on or according to the value of the parameter indicated by the message, adapting a configuration of the IAB donor (Block 2410).

In some embodiments, the field is an identity, ID, field or an index field.

In some embodiments, the message is a first message. In some embodiments, the method further comprises transmitting, to the first IAB node and/or the second IAB node, signaling that changes which one or more possible values of the field are mapped to which one or more possible values of the parameter.

In some embodiments, the field is a first field and the parameter is a first parameter. In some embodiments, the method further comprises transmitting, to the first IAB node and/or the second IAB node, signaling that indicates which one or more possible values of a second field of the message are mapped to which one or more possible values of a second parameter.

In some embodiments, the signaling comprises a mapping between the one or more possible values of the field to the one or more possible values of the parameter.

In some embodiments, the parameter is a beam configuration parameter.

In some embodiments, the parameter is a beam configuration for a certain distributed unit, DU, cell.

In some embodiments, the first IAB node is a parent IAB node with respect to the second IAB node.

In some embodiments, the first IAB node is a child IAB node with respect to the second IAB node.

In some embodiments, the IAB donor is the second IAB node.

Embodiments herein also include corresponding apparatuses. Embodiments herein for instance include a first IAB node 12A configured to perform any of the steps of any of the embodiments described above for the first IAB node 12A.

Embodiments also include a first IAB node 12A comprising processing circuitry and power supply circuitry. The processing circuitry is configured to perform any of the steps of any of the embodiments described above for the first IAB node 12A. The power supply circuitry is configured to supply power to the first IAB node 12A.

Embodiments further include a first IAB node 12A comprising processing circuitry. The processing circuitry is configured to perform any of the steps of any of the embodiments described above for the first IAB node 12A. In some embodiments, the first IAB node 12A further comprises communication circuitry.

Embodiments further include a first IAB node 12A comprising processing circuitry and memory. The memory contains instructions executable by the processing circuitry whereby the first IAB node 12A is configured to perform any of the steps of any of the embodiments described above for the first IAB node 12A.

Embodiments herein also include an IAB donor 14 configured to perform any of the steps of any of the embodiments described above for the IAB donor 14.

Embodiments also include a IAB donor 14 comprising processing circuitry and power supply circuitry. The processing circuitry is configured to perform any of the steps of any of the embodiments described above for the IAB donor 14. The power supply circuitry is configured to supply power to the IAB donor 14.

Embodiments further include a IAB donor 14 comprising processing circuitry. The processing circuitry is configured to perform any of the steps of any of the embodiments described above for the IAB donor 14. In some embodiments, the IAB donor 14 further comprises communication circuitry.

Embodiments further include a IAB donor 14 comprising processing circuitry and memory. The memory contains instructions executable by the processing circuitry whereby the IAB donor 14 is configured to perform any of the steps of any of the embodiments described above for the IAB donor 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

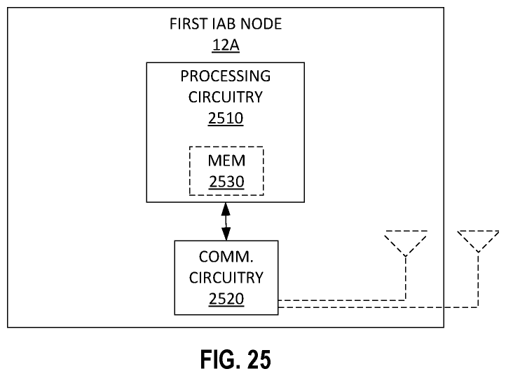

FIG. 25 for example illustrates a first IAB node 12A as implemented in accordance with one or more embodiments. As shown, the first IAB node 12A includes processing circuitry 2510 and communication circuitry 2520. The communication circuitry 2520 (e.g., radio circuitry) is configured to transmit and/or receive information to and/or from one or more other nodes, e.g., via any communication technology. Such communication may occur via one or more antennas that are either internal or external to the first IAB node 12A. The processing circuitry 2510 is configured to perform processing described above, e.g., in FIG. 23, such as by executing instructions stored in memory 2530. The processing circuitry 2510 in this regard may implement certain functional means, units, or modules.

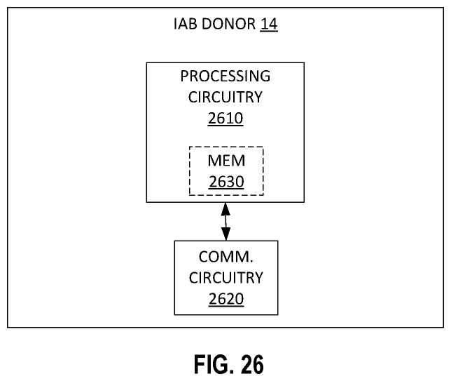

FIG. 26 illustrates a IAB donor 14 as implemented in accordance with one or more embodiments. As shown, the IAB donor 14 includes processing circuitry 2610 and communication circuitry 2620. The communication circuitry 2620 is configured to transmit and/or receive information to and/or from one or more other nodes, e.g., via any communication technology. The processing circuitry 2610 is configured to perform processing described above, e.g., in FIG. 24, such as by executing instructions stored in memory 2630. The processing circuitry 2610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

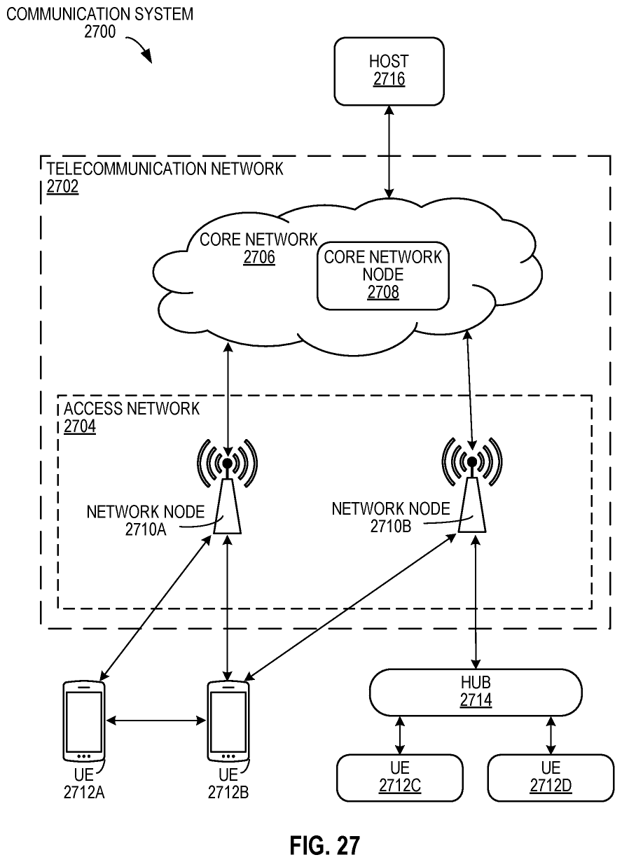

FIG. 27 shows an example of a communication system 2700 in accordance with some embodiments.

In the example, the communication system 2700 includes a telecommunication network 2702 that includes an access network 2704, such as a radio access network (RAN), and a core network 2706, which includes one or more core network nodes 2708. The access network 2704 includes one or more access network nodes, such as network nodes 2710a and 2710b (one or more of which may be generally referred to as network nodes 2710), or any other similar 3^{rd} Generation Partnership Project (3GPP) access node or non-3GPP access point. The network nodes 2710 facilitate direct or indirect connection of user equipment (UE), such as by connecting UEs 2712a, 2712b, 2712c, and 2712d (one or more of which may be generally referred to as UEs 2712) to the core network 2706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2700 may include any number of wired or wireless networks, network nodes, UEs, and/or any other components or systems that may facilitate or participate in the communication of data and/or signals whether via wired or wireless connections. The communication system 2700 may include and/or interface with any type of communication, telecommunication, data, cellular, radio network, and/or other similar type of system.

The UEs 2712 may be any of a wide variety of communication devices, including wireless devices arranged, configured, and/or operable to communicate wirelessly with the network nodes 2710 and other communication devices. Similarly, the network nodes 2710 are arranged, capable, configured, and/or operable to communicate directly or indirectly with the UEs 2712 and/or with other network nodes or equipment in the telecommunication network 2702 to enable and/or provide network access, such as wireless network access, and/or to perform other functions, such as administration in the telecommunication network 2702.

In the depicted example, the core network 2706 connects the network nodes 2710 to one or more hosts, such as host 2716. These connections may be direct or indirect via one or more intermediary networks or devices. In other examples, network nodes may be directly coupled to hosts. The core network 2706 includes one more core network nodes (e.g., core network node 2708) that are structured with hardware and software components. Features of these components may be substantially similar to those described with respect to the UEs, network nodes, and/or hosts, such that the descriptions thereof are generally applicable to the corresponding components of the core network node 2708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2716 may be under the ownership or control of a service provider other than an operator or provider of the access network 2704 and/or the telecommunication network 2702, and may be operated by the service provider or on behalf of the service provider. The host 2716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2700 of FIG. 27 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2702 is a cellular network that implements 3GPP standardized features. Accordingly, the telecommunications network 2702 may support network slicing to provide different logical networks to different devices that are connected to the telecommunication network 2702. For example, the telecommunications network 2702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs. In some examples, the UEs 2712 are configured to transmit and/or receive information without direct human interaction. For instance, a UE may be designed to transmit information to the access network 2704 on a predetermined schedule, when triggered by an internal or external event, or in response to requests from the access network 2704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2714 communicates with the access network 2704 to facilitate indirect communication between one or more UEs (e.g., UE 2712c and/or 2712d) and network nodes (e.g., network node 2710b). In some examples, the hub 2714 may be a controller, router, content source and analytics, or any of the other communication devices described herein regarding UEs. For example, the hub 2714 may be a broadband router enabling access to the core network 2706 for the UEs. As another example, the hub 2714 may be a controller that sends commands or instructions to one or more actuators in the UEs. Commands or instructions may be received from the UEs, network nodes 2710, or by executable code, script, process, or other instructions in the hub 2714. As another example, the hub 2714 may be a data collector that acts as temporary storage for UE data and, in some embodiments, may perform analysis or other processing of the data. As another example, the hub 2714 may be a content source. For example, for a UE that is a VR headset, display, loudspeaker or other media delivery device, the hub 2714 may retrieve VR assets, video, audio, or other media or data related to sensory information via a network node, which the hub 2714 then provides to the UE either directly, after performing local processing, and/or after adding additional local content. In still another example, the hub 2714 acts as a proxy server or orchestrator for the UEs, in particular in if one or more of the UEs are low energy IoT devices.

The hub 2714 may have a constant/persistent or intermittent connection to the network node 2710b. The hub 2714 may also allow for a different communication scheme and/or schedule between the hub 2714 and UEs (e.g., UE 2712c and/or 2712d), and between the hub 2714 and the core network 2706. In other examples, the hub 2714 is connected to the core network 2706 and/or one or more UEs via a wired connection. Moreover, the hub 2714 may be configured to connect to an M2M service provider over the access network 2704 and/or to another UE over a direct connection. In some scenarios, UEs may establish a wireless connection with the network nodes 2710 while still connected via the hub 2714 via a wired or wireless connection. In some embodiments, the hub 2714 may be a dedicated hub—that is, a hub whose primary function is to route communications to/from the UEs from/to the network node 2710b. In other embodiments, the hub 2714 may be a non-dedicated hub—that is, a device which is capable of operating to route communications between the UEs and network node 2710b, but which is additionally capable of operating as a communication start and/or end point for certain data channels.

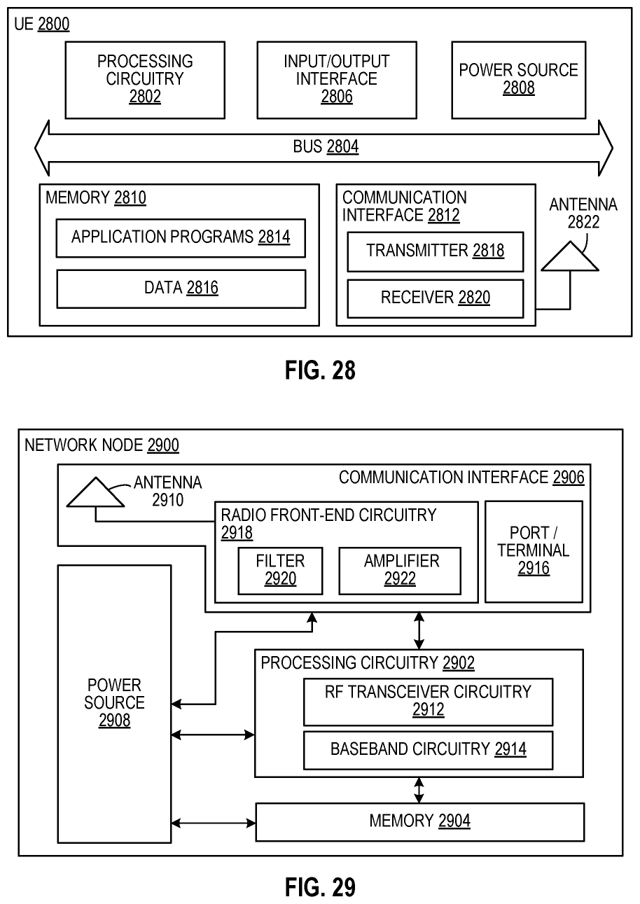

FIG. 28 shows a UE 2800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2800 includes processing circuitry 2802 that is operatively coupled via a bus 2804 to an input/output interface 2806, a power source 2808, a memory 2810, a communication interface 2812, and/or any other component, or any combination thereof. Certain UEs may utilize all or a subset of the components shown in FIG. 28. The level of integration between the components may vary from one UE to another UE. Further, certain UEs may contain multiple instances of a component, such as multiple processors, memories, transceivers, transmitters, receivers, etc.

The processing circuitry 2802 is configured to process instructions and data and may be configured to implement any sequential state machine operative to execute instructions stored as machine-readable computer programs in the memory 2810. The processing circuitry 2802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2802 may include multiple central processing units (CPUs).

In the example, the input/output interface 2806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2808 is structured as a battery or battery pack. Other types of power sources, such as an external power source (e.g., an electricity outlet), photovoltaic device, or power cell, may be used. The power source 2808 may further include power circuitry for delivering power from the power source 2808 itself, and/or an external power source, to the various parts of the UE 2800 via input circuitry or an interface such as an electrical power cable. Delivering power may be, for example, for charging of the power source 2808. Power circuitry may perform any formatting, converting, or other modification to the power from the power source 2808 to make the power suitable for the respective components of the UE 2800 to which power is supplied.

The memory 2810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2810 includes one or more application programs 2814, such as an operating system, web browser application, a widget, gadget engine, or other application, and corresponding data 2816. The memory 2810 may store, for use by the UE 2800, any of a variety of various operating systems or combinations of operating systems.

The memory 2810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2810 may allow the UE 2800 to access instructions, application programs and the like, stored on transitory or non-transitory memory media, to off-load data, or to upload data. An article of manufacture, such as one utilizing a communication system may be tangibly embodied as or in the memory 2810, which may be or comprise a device-readable storage medium.

The processing circuitry 2802 may be configured to communicate with an access network or other network using the communication interface 2812. The communication interface 2812 may comprise one or more communication subsystems and may include or be communicatively coupled to an antenna 2822. The communication interface 2812 may include one or more transceivers used to communicate, such as by communicating with one or more remote transceivers of another device capable of wireless communication (e.g., another UE or a network node in an access network). Each transceiver may include a transmitter 2818 and/or a receiver 2820 appropriate to provide network communications (e.g., optical, electrical, frequency allocations, and so forth). Moreover, the transmitter 2818 and receiver 2820 may be coupled to one or more antennas (e.g., antenna 2822) and may share circuit components, software or firmware, or alternatively be implemented separately.

In the illustrated embodiment, communication functions of the communication interface 2812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2800 shown in FIG. 28.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 29 shows a network node 2900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2900 includes a processing circuitry 2902, a memory 2904, a communication interface 2906, and a power source 2908. The network node 2900 may be composed of multiple physically separate components (e.g., a NodeB component and a RNC component, or a BTS component and a BSC component, etc.), which may each have their own respective components. In certain scenarios in which the network node 2900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2900 may be configured to support multiple radio access technologies (RATs). In such embodiments, some components may be duplicated (e.g., separate memory 2904 for different RATs) and some components may be reused (e.g., a same antenna 2910 may be shared by different RATs). The network node 2900 may also include multiple sets of the various illustrated components for different wireless technologies integrated into network node 2900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2900.

The processing circuitry 2902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2900 components, such as the memory 2904, to provide network node 2900 functionality.

In some embodiments, the processing circuitry 2902 includes a system on a chip (SOC). In some embodiments, the processing circuitry 2902 includes one or more of radio frequency (RF) transceiver circuitry 2912 and baseband processing circuitry 2914. In some embodiments, the radio frequency (RF) transceiver circuitry 2912 and the baseband processing circuitry 2914 may be on separate chips (or sets of chips), boards, or units, such as radio units and digital units. In alternative embodiments, part or all of RF transceiver circuitry 2912 and baseband processing circuitry 2914 may be on the same chip or set of chips, boards, or units.

The memory 2904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2902. The memory 2904 may store any suitable instructions, data, or information, including a computer program, software, an application including one or more of logic, rules, code, tables, and/or other instructions capable of being executed by the processing circuitry 2902 and utilized by the network node 2900. The memory 2904 may be used to store any calculations made by the processing circuitry 2902 and/or any data received via the communication interface 2906. In some embodiments, the processing circuitry 2902 and memory 2904 is integrated.

The communication interface 2906 is used in wired or wireless communication of signaling and/or data between a network node, access network, and/or UE. As illustrated, the communication interface 2906 comprises port(s)/terminal(s) 2916 to send and receive data, for example to and from a network over a wired connection. The communication interface 2906 also includes radio front-end circuitry 2918 that may be coupled to, or in certain embodiments a part of, the antenna 2910. Radio front-end circuitry 2918 comprises filters 2920 and amplifiers 2922. The radio front-end circuitry 2918 may be connected to an antenna 2910 and processing circuitry 2902. The radio front-end circuitry may be configured to condition signals communicated between antenna 2910 and processing circuitry 2902. The radio front-end circuitry 2918 may receive digital data that is to be sent out to other network nodes or UEs via a wireless connection. The radio front-end circuitry 2918 may convert the digital data into a radio signal having the appropriate channel and bandwidth parameters using a combination of filters 2920 and/or amplifiers 2922. The radio signal may then be transmitted via the antenna 2910. Similarly, when receiving data, the antenna 2910 may collect radio signals which are then converted into digital data by the radio front-end circuitry 2918. The digital data may be passed to the processing circuitry 2902. In other embodiments, the communication interface may comprise different components and/or different combinations of components.

In certain alternative embodiments, the network node 2900 does not include separate radio front-end circuitry 2918, instead, the processing circuitry 2902 includes radio front-end circuitry and is connected to the antenna 2910. Similarly, in some embodiments, all or some of the RF transceiver circuitry 2912 is part of the communication interface 2906. In still other embodiments, the communication interface 2906 includes one or more ports or terminals 2916, the radio front-end circuitry 2918, and the RF transceiver circuitry 2912, as part of a radio unit (not shown), and the communication interface 2906 communicates with the baseband processing circuitry 2914, which is part of a digital unit (not shown).

The antenna 2910 may include one or more antennas, or antenna arrays, configured to send and/or receive wireless signals. The antenna 2910 may be coupled to the radio front-end circuitry 2918 and may be any type of antenna capable of transmitting and receiving data and/or signals wirelessly. In certain embodiments, the antenna 2910 is separate from the network node 2900 and connectable to the network node 2900 through an interface or port.

The antenna 2910, communication interface 2906, and/or the processing circuitry 2902 may be configured to perform any receiving operations and/or certain obtaining operations described herein as being performed by the network node. Any information, data and/or signals may be received from a UE, another network node and/or any other network equipment. Similarly, the antenna 2910, the communication interface 2906, and/or the processing circuitry 2902 may be configured to perform any transmitting operations described herein as being performed by the network node. Any information, data and/or signals may be transmitted to a UE, another network node and/or any other network equipment.

The power source 2908 provides power to the various components of network node 2900 in a form suitable for the respective components (e.g., at a voltage and current level needed for each respective component). The power source 2908 may further comprise, or be coupled to, power management circuitry to supply the components of the network node 2900 with power for performing the functionality described herein. For example, the network node 2900 may be connectable to an external power source (e.g., the power grid, an electricity outlet) via an input circuitry or interface such as an electrical cable, whereby the external power source supplies power to power circuitry of the power source 2908. As a further example, the power source 2908 may comprise a source of power in the form of a battery or battery pack which is connected to, or integrated in, power circuitry. The battery may provide backup power should the external power source fail.

Embodiments of the network node 2900 may include additional components beyond those shown in FIG. 29 for providing certain aspects of the network node's functionality, including any of the functionality described herein and/or any functionality necessary to support the subject matter described herein. For example, the network node 2900 may include user interface equipment to allow input of information into the network node 2900 and to allow output of information from the network node 2900. This may allow a user to perform diagnostic, maintenance, repair, and other administrative functions for the network node 2900.

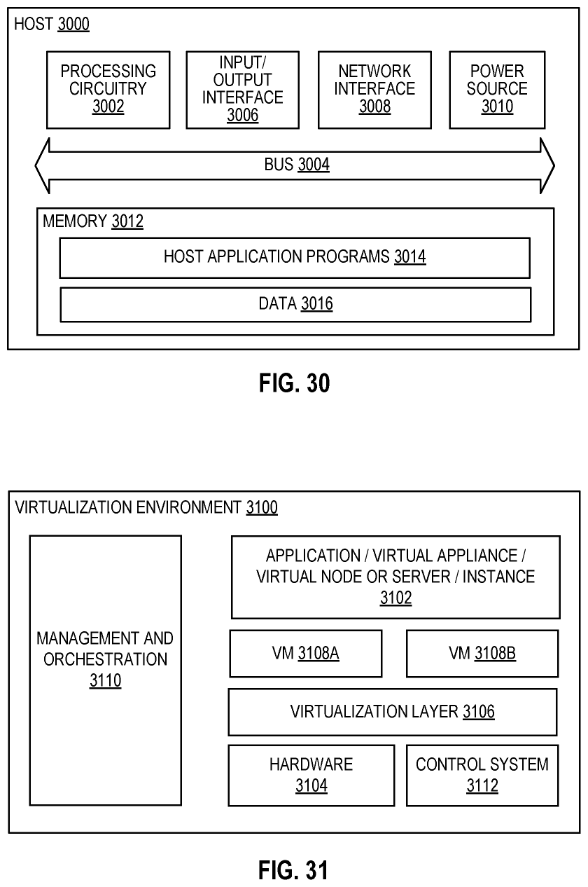

FIG. 30 is a block diagram of a host 3000, which may be an embodiment of the host 2716 of FIG. 27, in accordance with various aspects described herein. As used herein, the host 3000 may be or comprise various combinations hardware and/or software, including a standalone server, a blade server, a cloud-implemented server, a distributed server, a virtual machine, container, or processing resources in a server farm. The host 3000 may provide one or more services to one or more UEs.

The host 3000 includes processing circuitry 3002 that is operatively coupled via a bus 3004 to an input/output interface 3006, a network interface 3008, a power source 3010, and a memory 3012. Other components may be included in other embodiments. Features of these components may be substantially similar to those described with respect to the devices of previous figures, such as FIGS. 28 and 29, such that the descriptions thereof are generally applicable to the corresponding components of host 3000.

The memory 3012 may include one or more computer programs including one or more host application programs 3014 and data 3016, which may include user data, e.g., data generated by a UE for the host 3000 or data generated by the host 3000 for a UE. Embodiments of the host 3000 may utilize only a subset or all of the components shown. The host application programs 3014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3014 may also provide for user authentication and licensing checks and may periodically report health, routes, and content availability to a central node, such as a device in or on the edge of a core network. Accordingly, the host 3000 may select and/or indicate a different host for over-the-top services for a UE. The host application programs 3014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 31 is a block diagram illustrating a virtualization environment 3100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3106 (also referred to as hypervisors or virtual machine monitors (VMMs)), provide VMs 3108a and 3108b (one or more of which may be generally referred to as VMs 3108), and/or perform any of the functions, features and/or benefits described in relation with some embodiments described herein. The virtualization layer 3106 may present a virtual operating platform that appears like networking hardware to the VMs 3108.

The VMs 3108 comprise virtual processing, virtual memory, virtual networking or interface and virtual storage, and may be run by a corresponding virtualization layer 3106. Different embodiments of the instance of a virtual appliance 3102 may be implemented on one or more of VMs 3108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3108 may be a software implementation of a physical machine that runs programs as if they were executing on a physical, non-virtualized machine. Each of the VMs 3108, and that part of hardware 3104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3108 on top of the hardware 3104 and corresponds to the application 3102.

Hardware 3104 may be implemented in a standalone network node with generic or specific components. Hardware 3104 may implement some functions via virtualization. Alternatively, hardware 3104 may be part of a larger cluster of hardware (e.g. such as in a data center or CPE) where many hardware nodes work together and are managed via management and orchestration 3110, which, among others, oversees lifecycle management of applications 3102. In some embodiments, hardware 3104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3112 which may alternatively be used for communication between hardware nodes and radio units.

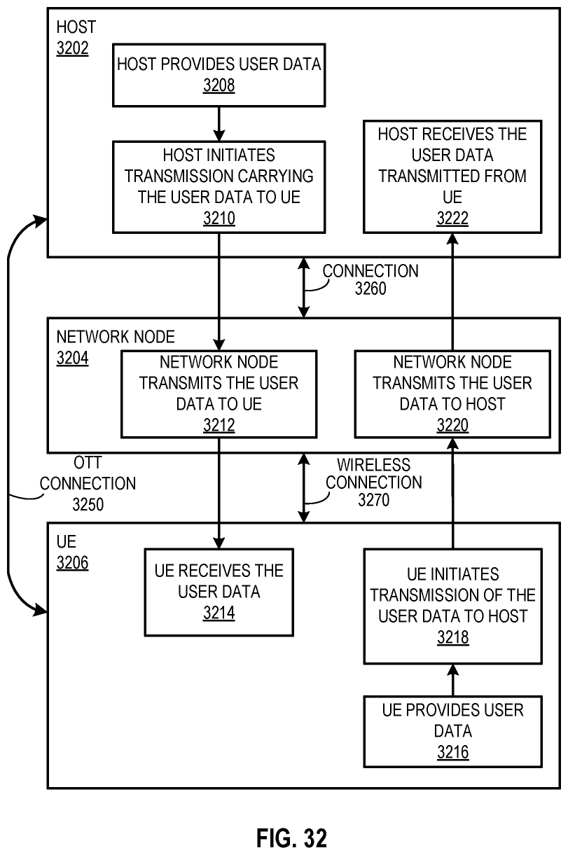

FIG. 32 shows a communication diagram of a host 3202 communicating via a network node 3204 with a UE 3206 over a partially wireless connection in accordance with some embodiments. Example implementations, in accordance with various embodiments, of the UE (such as a UE 2712a of FIG. 27 and/or UE 2800 of FIG. 28), network node (such as network node 2710a of FIG. 27 and/or network node 2900 of FIG. 29), and host (such as host 2716 of FIG. 27 and/or host 3000 of FIG. 30) discussed in the preceding paragraphs will now be described with reference to FIG. 32.

Like host 3000, embodiments of host 3202 include hardware, such as a communication interface, processing circuitry, and memory. The host 3202 also includes software, which is stored in or accessible by the host 3202 and executable by the processing circuitry. The software includes a host application that may be operable to provide a service to a remote user, such as the UE 3206 connecting via an over-the-top (OTT) connection 3250 extending between the UE 3206 and host 3202. In providing the service to the remote user, a host application may provide user data which is transmitted using the OTT connection 3250.

The network node 3204 includes hardware enabling it to communicate with the host 3202 and UE 3206. The connection 3260 may be direct or pass through a core network (like core network 2706 of FIG. 27) and/or one or more other intermediate networks, such as one or more public, private, or hosted networks. For example, an intermediate network may be a backbone network or the Internet.

The UE 3206 includes hardware and software, which is stored in or accessible by UE 3206 and executable by the UE's processing circuitry. The software includes a client application, such as a web browser or operator-specific “app” that may be operable to provide a service to a human or non-human user via UE 3206 with the support of the host 3202. In the host 3202, an executing host application may communicate with the executing client application via the OTT connection 3250 terminating at the UE 3206 and host 3202. In providing the service to the user, the UE's client application may receive request data from the host's host application and provide user data in response to the request data. The OTT connection 3250 may transfer both the request data and the user data. The UE's client application may interact with the user to generate the user data that it provides to the host application through the OTT connection 3250.

The OTT connection 3250 may extend via a connection 3260 between the host 3202 and the network node 3204 and via a wireless connection 3270 between the network node 3204 and the UE 3206 to provide the connection between the host 3202 and the UE 3206. The connection 3260 and wireless connection 3270, over which the OTT connection 3250 may be provided, have been drawn abstractly to illustrate the communication between the host 3202 and the UE 3206 via the network node 3204, without explicit reference to any intermediary devices and the precise routing of messages via these devices.

As an example of transmitting data via the OTT connection 3250, in step 3208, the host 3202 provides user data, which may be performed by executing a host application. In some embodiments, the user data is associated with a particular human user interacting with the UE 3206. In other embodiments, the user data is associated with a UE 3206 that shares data with the host 3202 without explicit human interaction. In step 3210, the host 3202 initiates a transmission carrying the user data towards the UE 3206. The host 3202 may initiate the transmission responsive to a request transmitted by the UE 3206. The request may be caused by human interaction with the UE 3206 or by operation of the client application executing on the UE 3206. The transmission may pass via the network node 3204, in accordance with the teachings of the embodiments described throughout this disclosure. Accordingly, in step 3212, the network node 3204 transmits to the UE 3206 the user data that was carried in the transmission that the host 3202 initiated, in accordance with the teachings of the embodiments described throughout this disclosure. In step 3214, the UE 3206 receives the user data carried in the transmission, which may be performed by a client application executed on the UE 3206 associated with the host application executed by the host 3202.

In some examples, the UE 3206 executes a client application which provides user data to the host 3202. The user data may be provided in reaction or response to the data received from the host 3202. Accordingly, in step 3216, the UE 3206 may provide user data, which may be performed by executing the client application. In providing the user data, the client application may further consider user input received from the user via an input/output interface of the UE 3206. Regardless of the specific manner in which the user data was provided, the UE 3206 initiates, in step 3218, transmission of the user data towards the host 3202 via the network node 3204. In step 3220, in accordance with the teachings of the embodiments described throughout this disclosure, the network node 3204 receives user data from the UE 3206 and initiates transmission of the received user data towards the host 3202. In step 3222, the host 3202 receives the user data carried in the transmission initiated by the UE 3206.

One or more of the various embodiments improve the performance of OTT services provided to the UE 3206 using the OTT connection 3250, in which the wireless connection 3270 forms the last segment.

In an example scenario, factory status information may be collected and analyzed by the host 3202. As another example, the host 3202 may process audio and video data which may have been retrieved from a UE for use in creating maps. As another example, the host 3202 may collect and analyze real-time data to assist in controlling vehicle congestion (e.g., controlling traffic lights). As another example, the host 3202 may store surveillance video uploaded by a UE. As another example, the host 3202 may store or control access to media content such as video, audio, VR or AR which it can broadcast, multicast or unicast to UEs. As other examples, the host 3202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3250 between the host 3202 and UE 3206, in response to variations in the measurement results. The measurement procedure and/or the network functionality for reconfiguring the OTT connection may be implemented in software and hardware of the host 3202 and/or UE 3206. In some embodiments, sensors (not shown) may be deployed in or in association with other devices through which the OTT connection 3250 passes; the sensors may participate in the measurement procedure by supplying values of the monitored quantities exemplified above, or supplying values of other physical quantities from which software may compute or estimate the monitored quantities. The reconfiguring of the OTT connection 3250 may include message format, retransmission settings, preferred routing etc.; the reconfiguring need not directly alter the operation of the network node 3204. Such procedures and functionalities may be known and practiced in the art. In certain embodiments, measurements may involve proprietary UE signaling that facilitates measurements of throughput, propagation times, latency and the like, by the host 3202. The measurements may be implemented in that software causes messages to be transmitted, in particular empty or ‘dummy’ messages, using the OTT connection 3250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a first integrated access backhaul, IAB, node, the method comprising:
receiving, from an IAB donor, signaling that indicates which one or more possible values of a field are mapped to which one or more possible values of a parameter; and
transmitting to, or receiving from, a second IAB node a message that includes the field set to one of the one or more possible values of the field indicated by the signaling.

A2. The method of embodiment A1, wherein the one or more possible values of the parameter to which the one or more possible values of the field are mapped comprise a subset of a set of multiple possible values of the parameter.

A3. The method of any of embodiments A1-A2, wherein the signaling is upper layer signaling received at an upper layer of a protocol stack, wherein the upper layer is above a layer at which the message is transmitted or received.

A4. The method of any of embodiments A1-A3, wherein the signaling is radio resource control signaling, F1 signaling, or operation and maintenance signaling.

A5. The method of any of embodiments A1-A4, wherein the signaling is received from a central unit, CU, of the IAB donor.

A6. The method of any of embodiments A1-A5, wherein the message is a medium access control, MAC, message or a downlink control information, DCI, message.

A7. The method of any of embodiments A1-A6, wherein the field is included in a MAC control element, CE, of a MAC message.

A8. The method of any of embodiments A1-A7, wherein the parameter indicates a configuration according to which the first IAB node or the second IAB node operates or is requested to operate.

A9. The method of any of embodiments A1-A7, wherein the parameter indicates a configuration according to which the first IAB node or the second IAB node operates, or is requested to operate, in order for a multiplexing IAB node to operate in a multiplexing mode, wherein a multiplexing mode is a mode in which the multiplexing IAB node multiplexes communication on a parent IAB link with communication on a child IAB link, wherein the multiplexing IAB node is the first IAB node or the second IAB node.

A10. The method of any of embodiments A1-A9, wherein the parameter is a multiplexing adaptation parameter that facilitates or governs adaptation of in which multiplexing mode, if any, a multiplexing IAB node operates, wherein the multiplexing IAB node is an IAB node capable of operating in a multiplexing mode, wherein a multiplexing mode is a mode in which the multiplexing IAB node multiplexes communication on a parent IAB link with communication on a child IAB link, wherein the parent IAB link is a link between the multiplexing IAB node and a parent IAB node, wherein the child IAB link is a link between the multiplexing IAB node and a child IAB node, and wherein the multiplexing IAB node is the first IAB node or the second IAB node.

A11. The method of embodiment A10, wherein the multiplexing adaptation parameter is a condition parameter indicating a condition that has been applied, or that is requested to be applied, in order for the multiplexing IAB node to operate in a multiplexing mode.

A12. The method of embodiment A11, wherein the multiplexing IAB node comprises a mobile termination, MT, and a distributed unit, DU, wherein the condition is:
restriction of simultaneous transmission at the multiplexing node in the direction of one or more beams of the DU;
use of one or more specified beams by the MT for communication on the parent IAB link;
adjustment of a downlink transmission power by the parent IAB node;
power spectral density, PSD, of the MT being within a specified range;
use of certain timing modes in certain respective time slots; or a combination of any two or more of the above.

A13. The method of embodiment A10, wherein the multiplexing adaptation parameter is an association parameter indicating one or more times, frequencies, and/or cells associated with a condition that has been applied, or that is requested to be applied, in order for the multiplexing IAB node to operate in a multiplexing mode.

A14. The method of embodiment A13, wherein the association parameter indicates one or more indices of one or more time slots associated with the condition.

A15. The method of any of embodiments A13-A14, wherein the association parameter indicates one or more distributed unit, DU, resource configurations associated with the condition.

A16. The method of any of embodiments A13-A15, wherein the association parameter indicates one or more carrier-cell pairs associated with the condition, wherein each of the one or more carrier-cell pairs is a pair of an IAB mobile termination component carrier and an IAB distributed unit cell.

A17. The method of any of embodiments A10-A16, wherein the multiplexing adaptation parameter is an association parameter indicating a multiplexing mode associated with a condition that has been applied, or that is requested to be applied, in order for the multiplexing IAB node to operate in the indicated multiplexing mode.

A18. The method of any of embodiments A9-A17, wherein the multiplexing IAB node comprises a mobile termination, MT, and a distributed unit, DU, wherein the multiplexing IAB node is configured to multiplex communication by the MT on the parent IAB link towards the parent IAB node with communication by the DU on the child IAB link towards the child IAB node.

A19. The method of embodiment A18, wherein the multiplexing IAB node is capable of operating in any one of multiple possible multiplexing modes, wherein the multiple possible multiplexing modes include two or more of:
a TDM mode in which the multiplexing IAB node uses time-domain multiplexing, TDM, to multiplex communication by the MT on the parent IAB link towards the parent IAB node with communication by the DU on the child IAB link towards the child IAB node;
an FDM mode in which the multiplexing IAB node uses frequency-domain multiplexing, FDM, to multiplex communication by the MT on the parent IAB link towards the parent IAB node with communication by the DU on the child IAB link towards the child IAB node;
an SDM mode in which the multiplexing IAB node uses spatial-domain multiplexing, SDM, to multiplex communication by the MT on the parent IAB link towards the parent IAB node with communication by the DU on the child IAB link towards the child IAB node; and
a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

A20. The method of any of embodiments A18-A19, wherein the multiplexing IAB node is configured to multiplex any one of:
transmission by the MT on the parent IAB link towards the parent IAB node with transmission by the DU on the child IAB link towards the child IAB node;
transmission by the MT on the parent IAB link towards the parent IAB node with reception by the DU on the child IAB link towards the child IAB node;
reception by the MT on the parent IAB link towards the parent IAB node with transmission by the DU on the child IAB link towards the child IAB node; and
reception by the MT on the parent IAB link towards the parent IAB node with reception by the DU on the child IAB link towards the child IAB node.

A21. The method of any of embodiments A9-A20, wherein the multiplexing IAB node is the first IAB node.

A22. The method of embodiment A21, further comprising, based on or according to the value of the parameter indicated by the message, adapting in which multiplexing mode the first IAB node operates.

A23. The method of any of embodiments A9-A20, wherein the first IAB node is the parent IAB node.

A24. The method of embodiment A23, further comprising, based on or according to the value of the parameter indicated by the message, adapting a configuration of the first IAB node.

A25. The method of any of embodiments A1-A24, wherein the field is an identity, ID, field or an index field.

A26. The method of any of embodiments A1-A25, wherein the message is a first message, wherein the method further comprises:
receiving, from the IAB donor, signaling that changes which one or more possible values of the field are mapped to which one or more possible values of the parameter; and
transmitting to, or receiving from, the second IAB node a second message that includes the field set to one of the one or more possible values of the field indicated by the signaling.

A27. The method of any of embodiments A1-A25, wherein the field is a first field and the parameter is a first parameter, wherein the method further comprises receiving, from the IAB donor, signaling that indicates which one or more possible values of a second field are mapped to which one or more possible values of a second parameter, and wherein the message further includes the second field set to one of the one or more possible values of the second field indicated by the signaling.

A28. The method of any of embodiments A1-A27, wherein the signaling comprises a mapping between the one or more possible values of the field to the one or more possible values of the parameter.

A29. The method of any of embodiments A1-A28, wherein the parameter is a beam configuration parameter.

A30. The method of any of embodiments A1-A28, wherein the parameter is a beam configuration for a certain distributed unit, DU, cell.

A31. The method of any of embodiments A1-A30, wherein the first IAB node is a parent IAB node with respect to the second IAB node.

A32. The method of any of embodiments A1-A30, wherein the first IAB node is a child IAB node with respect to the second IAB node.

A33. The method of any of embodiments A1-A32, wherein the IAB donor is the second IAB node.

### Group B Embodiments

B1. A method performed by an integrated access backhaul, IAB, donor, the method comprising:
transmitting, to a first IAB node and/or a second IAB node, signaling that indicates which one or more possible values of a field are mapped to which one or more possible values of a parameter, wherein the field is a field of a message on an interface between the first IAB node and the second IAB node.

B2. The method of embodiment B1, wherein the one or more possible values of the parameter to which the one or more possible values of the field are mapped comprise a subset of a set of multiple possible values of the parameter.

B3. The method of any of embodiments B1-B2, wherein the signaling is upper layer signaling transmitted at an upper layer of a protocol stack, wherein the upper layer is above a layer at which the message is transmitted or received on the interface between the first and second IAB nodes.

B4. The method of any of embodiments B1-B3, wherein the signaling is radio resource control signaling, F1 signaling, or operation and maintenance signaling.

B5. The method of any of embodiments B1-B4, wherein the signaling is transmitted by a central unit, CU, of the IAB donor.

B6. The method of any of embodiments B1-B5, wherein the message is a medium access control, MAC, message or a downlink control information, DCI, message.

B7. The method of any of embodiments B1-B6, wherein the field is included in a MAC control element, CE, of a MAC message.

B8. The method of any of embodiments B1-B7, wherein the parameter indicates a configuration according to which the first IAB node or the second IAB node operates or is requested to operate.

B9. The method of any of embodiments B1-B7, wherein the parameter indicates a configuration according to which the first IAB node or the second IAB node operates, or is requested to operate, in order for a multiplexing IAB node to operate in a multiplexing mode, wherein a multiplexing mode is a mode in which the multiplexing IAB node multiplexes communication on a parent IAB link with communication on a child IAB link, wherein the multiplexing IAB node is the first IAB node or the second IAB node.

B10. The method of any of embodiments B1-B9, wherein the parameter is a multiplexing adaptation parameter that facilitates or governs adaptation of in which multiplexing mode, if any, a multiplexing IAB node operates, wherein the multiplexing IAB node is an IAB node capable of operating in a multiplexing mode, wherein a multiplexing mode is a mode in which the multiplexing IAB node multiplexes communication on a parent IAB link with communication on a child IAB link, wherein the parent IAB link is a link between the multiplexing IAB node and a parent IAB node, wherein the child IAB link is a link between the multiplexing IAB node and a child IAB node, and wherein the multiplexing IAB node is the first IAB node or the second IAB node.

B11. The method of embodiment B10, wherein the multiplexing adaptation parameter is a condition parameter indicating a condition that has been applied, or that is requested to be applied, in order for the multiplexing IAB node to operate in a multiplexing mode.

B12. The method of embodiment B11, wherein the multiplexing IAB node comprises a mobile termination, MT, and a distributed unit, DU, wherein the condition is:
restriction of simultaneous transmission at the multiplexing node in the direction of one or more beams of the DU;
use of one or more specified beams by the MT for communication on the parent IAB link;
adjustment of a downlink transmission power by the parent IAB node;
power spectral density, PSD, of the MT being within a specified range;
use of certain timing modes in certain respective time slots; or
a combination of any two or more of the above.

B13. The method of embodiment B10, wherein the multiplexing adaptation parameter is an association parameter indicating one or more times, frequencies, and/or cells associated with a condition that has been applied, or that is requested to be applied, in order for the multiplexing IAB node to operate in a multiplexing mode.

B14. The method of embodiment B13, wherein the association parameter indicates one or more indices of one or more time slots associated with the condition.

B15. The method of any of embodiments B13-B14, wherein the association parameter indicates one or more distributed unit, DU, resource configurations associated with the condition.

B16. The method of any of embodiments B13-B15, wherein the association parameter indicates one or more carrier-cell pairs associated with the condition, wherein each of the one or more carrier-cell pairs is a pair of an IAB mobile termination component carrier and an IAB distributed unit cell.

B17. The method of any of embodiments B10-B16, wherein the multiplexing adaptation parameter is an association parameter indicating a multiplexing mode associated with a condition that has been applied, or that is requested to be applied, in order for the multiplexing IAB node to operate in the indicated multiplexing mode.

B18. The method of any of embodiments B9-B17, wherein the multiplexing IAB node comprises a mobile termination, MT, and a distributed unit, DU, wherein the multiplexing IAB node is configured to multiplex communication by the MT on the parent IAB link towards the parent IAB node with communication by the DU on the child IAB link towards the child IAB node.

B19. The method of embodiment B18, wherein the multiplexing IAB node is capable of operating in any one of multiple possible multiplexing modes, wherein the multiple possible multiplexing modes include two or more of:
a TDM mode in which the multiplexing IAB node uses time-domain multiplexing, TDM, to multiplex communication by the MT on the parent IAB link towards the parent IAB node with communication by the DU on the child IAB link towards the child IAB node;
an FDM mode in which the multiplexing IAB node uses frequency-domain multiplexing, FDM, to multiplex communication by the MT on the parent IAB link towards the parent IAB node with communication by the DU on the child IAB link towards the child IAB node;
an SDM mode in which the multiplexing IAB node uses spatial-domain multiplexing, SDM, to multiplex communication by the MT on the parent IAB link towards the parent IAB node with communication by the DU on the child IAB link towards the child IAB node; and
a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

B20. The method of any of embodiments B18-B19, wherein the multiplexing IAB node is configured to multiplex any one of:
transmission by the MT on the parent IAB link towards the parent IAB node with transmission by the DU on the child IAB link towards the child IAB node;
transmission by the MT on the parent IAB link towards the parent IAB node with reception by the DU on the child IAB link towards the child IAB node;
reception by the MT on the parent IAB link towards the parent IAB node with transmission by the DU on the child IAB link towards the child IAB node; and
reception by the MT on the parent IAB link towards the parent IAB node with reception by the DU on the child IAB link towards the child IAB node.

B21. The method of any of embodiments B9-B20, wherein the multiplexing IAB node is the first IAB node.

B22. Reserved.

B23. The method of any of embodiments B9-B20, wherein the IAB donor is the parent IAB node.

B24. The method of embodiment B23, further comprising, based on or according to the value of the parameter indicated by the message, adapting a configuration of the IAB donor.

B25. The method of any of embodiments B1-B24, wherein the field is an identity, ID, field or an index field.

B26. The method of any of embodiments B1-B25, wherein the message is a first message, wherein the method further comprises:
transmitting, to the first IAB node and/or the second IAB node, signaling that changes which one or more possible values of the field are mapped to which one or more possible values of the parameter.

B27. The method of any of embodiments B1-B25, wherein the field is a first field and the parameter is a first parameter, wherein the method further comprises transmitting, to the first IAB node and/or the second IAB node, signaling that indicates which one or more possible values of a second field of the message are mapped to which one or more possible values of a second parameter.

B28. The method of any of embodiments B1-B27, wherein the signaling comprises a mapping between the one or more possible values of the field to the one or more possible values of the parameter.

B29. The method of any of embodiments B1-B28, wherein the parameter is a beam configuration parameter.

B30. The method of any of embodiments B1-B28, wherein the parameter is a beam configuration for a certain distributed unit, DU, cell.

B31. The method of any of embodiments B1-B30, wherein the first IAB node is a parent IAB node with respect to the second IAB node.

B32. The method of any of embodiments B1-B30, wherein the first IAB node is a child IAB node with respect to the second IAB node.

B33. The method of any of embodiments B1-B32, wherein the IAB donor is the second IAB node.

### Group C Embodiments

C1. A first IAB node configured to perform any of the steps of any of the Group A embodiments.

C2. A first IAB node comprising processing circuitry configured to perform any of the steps of any of the Group A embodiments.

C3. A first IAB node comprising:
communication circuitry; and
processing circuitry configured to perform any of the steps of any of the Group A embodiments.

C4. A first IAB node comprising:
processing circuitry configured to perform any of the steps of any of the Group A embodiments; and
power supply circuitry configured to supply power to the first IAB node.

C5. A first IAB node comprising:
processing circuitry and memory, the memory containing instructions executable by the processing circuitry whereby the first IAB node is configured to perform any of the steps of any of the Group A embodiments.

C6. Reserved

C7. Reserved

C8. A computer program comprising instructions which, when executed by at least one processor of a first IAB node, causes the first IAB node to carry out the steps of any of the Group A embodiments.

C9. A carrier containing the computer program of embodiment C7, wherein the carrier is one of an electronic signal, optical signal, radio signal, or computer readable storage medium.

C10. An IAB donor configured to perform any of the steps of any of the Group B embodiments.

C11. A IAB donor comprising processing circuitry configured to perform any of the steps of any of the Group B embodiments.

C12. A IAB donor comprising:
communication circuitry; and
processing circuitry configured to perform any of the steps of any of the Group B embodiments.

C13. A IAB donor comprising:
processing circuitry configured to perform any of the steps of any of the Group B embodiments;
power supply circuitry configured to supply power to the IAB donor.

C14. A IAB donor comprising:
processing circuitry and memory, the memory containing instructions executable by the processing circuitry whereby the IAB donor is configured to perform any of the steps of any of the Group B embodiments.

C15. Reserved

C16. A computer program comprising instructions which, when executed by at least one processor of a IAB donor, causes the IAB donor to carry out the steps of any of the Group B embodiments.

C17. Reserved

C18. A carrier containing the computer program of any of embodiments C16-C17, wherein the carrier is one of an electronic signal, optical signal, radio signal, or computer readable storage medium.

### Group D Embodiments

### Parent IAB-Node Aspects

1. A method in a parent IAB-node for indicating multiplexing adaptation parameters regarding simultaneous operation, the method comprising
a. (Optionally) Receiving multiplexing capability from the IAB-node
b. Receiving upper-layer configured adaptation condition parameters from donor-CU
c. (Optionally) Receiving IAB-node TDM and FDM configuration from donor-CU
d. (Optionally) Receiving request on multiplexing adaptation conditions from the IAB-node
e. Indicating provided multiplexing adaptation conditions to IAB-node
f. Configuring IAB-MT according to the determined FDM or TDM operation modes

2. 1 and where the upper-layer configuration of the multiplexing adaptation condition parameters is using e.g., RRC signaling or F1 signaling or OAM signaling

3. 1-2 and where the upper layers configured multiplexing adaptation parameters (1b) includes one or more of condition parameters in the selection of
a. IAB-MT recommended UL/DL beams
b. IAB-DU restricted TX beams
c. IAB-DU DL power control
d. IAB-MT UL power control
e. IAB-DU and/or IAB-MT timing mode
f. . . .

4. 1-3 and where the upper layers configured multiplexing adaptation parameters (1b) includes one or more of association parameters in the selection of
a. IAB-MT CC vs IAB-DU cell relation
b. Multiplexing mode information
c. A sequence of slot indication including periodicity and slot indices
d. IAB-DU resource configuration,
e. IAB-MT and IAB-DU carrier relationship
f. . . .

5. 4 and where the upper layers configured multiplexing adaptation parameter (1b) may comprise a set of combinations of selected association parameters

6. 4-5 and where each combination of selected association parameters is associated to an ID/index

7. All above and where the multiplexing adaptation association parameter {MT CC, DU cell} pairs (4a) may comprise of one or more of
a. a state ID
b. none, or one, or multiple of {MT CC, DU cell} pairs
c. none, or one, or multiple of MT CCs
d. none, or one, or multiple of DU cells
e . . .

8. All above and where the multiplexing adaptation association parameter multiplexing mode (4b) may comprise of one or more of
a. a state ID
b. MT TX/DU TX, or MT TX/DU RX, or MT RX/DU TX, or MT RX/DU RX
c. FDM required, or FDM not required
d. TDM required, or TDM not required
e. . . .

9. All above and where the multiplexing adaptation association parameter slot index indication (4c) may comprise of one or more of
a. a state ID
b. None or one or multiple slot indices
c. Associated period
d. . . .

10. All above and where the multiplexing adaptation association parameter IAB-DU resource configuration (4d) can comprise of one or more of
a. Associated to Soft resources
b. Not associated to Soft resources
c. . . .

11. All above and where the multiplexing adaptation association parameter IAB-MT/IAB-DU carrier relation (4e) can comprise of one or more of
a. Frequency resource which is overlapping in the frequency domain
b. Frequency resource which is not overlapping in the frequency domain
c. . . .

12. All above and where the condition parameter (3) can have one or multiple association parameters (4)

13. All above and where the request on the multiplexing adaptation conditions (1d) can be selected from one or more of the upper layers configured parameters (1b)

14. All above and where the request on the multiplexing adaptation conditions (1d) can use e.g., MAC-CE, or DCI signaling

15. All above and where the request on the multiplexing adaptation condition (1d) contains pointers to the donor-CU configured upper-layer multiplexing adaption parameters (1b)

16. All above and where the indication of the provided multiplexing adaptation conditions (1e) can be selected from one or more of the upper layers configured parameters (1b)

17. All above and where the indication of the provided multiplexing adaptation conditions (1e) can use e.g., MAC-CE, or DCI signaling.

18. All above and where the indication of the provided multiplexing adaptation condition (1d) contains pointers to the donor-CU configured upper-layer multiplexing adaption parameters (1b)

### Group E Embodiments

### IAB-Node Aspects

1. A method in an IAB-node for indication of multiplexing adaptation parameters regarding simultaneous operation, the method comprising
a. (Optionally) Signaling a multiplexing capability to a parent IAB-node
b. Receiving upper-layer configured adaptation condition parameters from donor-CU
c. Receiving IAB-node TDM and FDM configuration from donor-CU
d. (Optionally) Signaling request on multiplexing adaptation conditions to a parent IAB-node
e. Receiving provided multiplexing adaptation conditions to IAB-node
f. Configuring IAB-DU according to the determined FDM or TDM operation modes

2. 1 and where the upper-layer configuration of the multiplexing adaptation condition parameters is using e.g., RRC signaling

3. 1-2 and where the upper layers configured multiplexing adaptation parameters (1b) includes one or more of condition parameters in the selection of
a. IAB-MT recommended UL/DL beams
b. IAB-DU restricted TX beams
c. IAB-DU DL power control
d. IAB-MT UL power control
e. IAB-DU and/or IAB-MT timing mode
f. . . .

4. 1-3 and where the upper layers configured multiplexing adaptation parameters (1b) includes one or more of association parameters in the selection of
a. IAB-MT CC vs IAB-DU cell relation
b. Multiplexing mode information
c. A sequence of slot indication including periodicity and slot indices
d. IAB-DU resource configuration,
e. IAB-MT and IAB-DU carrier relationship
f. . . .

5. 4 and where the upper layers configured multiplexing adaptation parameter (1b) may comprise a set of combinations of selected association parameters

6. 4-5 and where each combination of selected association parameters is associated to an ID/index

7. All above and where the multiplexing adaptation association parameter {MT CC, DU cell} pairs (4a) may comprise of one or more of
a. a state ID
b. none, or one, or multiple of {MT CC, DU cell} pairs
c. none, or one, or multiple of MT CCs
d. none, or one, or multiple of DU cells
e. . . .

8. All above and where the multiplexing adaptation association parameter multiplexing mode (4b) may comprise of one or more of
a. a state ID
b. MT TX/DU TX, or MT TX/DU RX, or MT RX/DU TX, or MT RX/DU RX
c. FDM required, or FDM not required
d. TDM required, or TDM not required
e. . . .

9. All above and where the multiplexing adaptation association parameter slot index indication (4c) may comprise of one or more of
a. a state ID
b. None or one or multiple slot indices
c. Associated period
d. . . .

10. All above and where the multiplexing adaptation association parameter IAB-DU resource configuration (4d) can comprise of one or more of
a. Associated to Soft resources
b. Not associated to Soft resources
c. . . .

11. All above and where the multiplexing adaptation association parameter IAB-MT/IAB-DU carrier relation (4e) can comprise of one or more of
a. Frequency resource which is overlapping in the frequency domain
b. Frequency resource which is not overlapping in the frequency domain
c. . . .

12. All above and where the condition parameter (3) can have one or multiple association parameters (4)

13. All above and where the request on the multiplexing adaptation conditions (1d) can be selected from one or more of the upper layers configured parameters (1b)

14. All above and where the request on the multiplexing adaptation conditions (1d) can use e.g., MAC-CE, or DCI signaling

15. All above and where the request on the multiplexing adaptation condition (1d) contains pointers to the donor-CU configured upper-layer multiplexing adaption parameters (1b)

16. All above and where the receiving of the provided multiplexing adaptation conditions (1e) can be selected from one or more of the upper layers configured parameters (1b)

17. All above and where the receiving of the provided multiplexing adaptation conditions (1e) can use e.g., MAC-CE, or DCI signaling.

18. All above and where the receiving of the provided multiplexing adaptation condition (1d) contains pointers to the donor-CU configured upper-layer multiplexing adaption parameters (1b)

### REFERENCES

1. RP-201293, “New WID on Enhancements to Integrated Access and Backhaul,” Qualcomm, RAN #88e, June 2020.
2. 3GPP TS 38.473, “Technical Specification Group Radio Access Network; NG-RAN; F1 application protocol (F1AP),” January 2021.
3. 3GPP R2-22040212 (R1-2202737), LS on upper layers parameters for Rel-17 elAB, Qualcomm, TSG RAN WG2 #117-e, March 2022

1.-32. (canceled)

33. A method performed by a first integrated access backhaul (IAB) node, the method comprising:
receiving, from an IAB donor, signaling that indicates which one or more possible values of a field are mapped to which one or more possible values of a multiplexing adaptation parameter, wherein the multiplexing adaptation parameter facilitates or governs adaptation of in which multiplexing mode, if any, a multiplexing IAB node operates for multiplexing communication on a parent IAB link with communication on a child IAB link; and
transmitting to, or receiving from, a second IAB node a message that includes the field set to one of the one or more possible values of the field indicated by the signaling, wherein the multiplexing IAB node is the first IAB node or the second IAB node.

34. The method of claim 33, wherein the one or more possible values of the multiplexing adaptation parameter to which the one or more possible values of the field are mapped comprise a subset of a set of multiple possible values of the multiplexing adaptation parameter.

35. The method of claim 33, wherein the signaling is upper layer signaling transmitted at an upper layer of a protocol stack, wherein the upper layer is above a layer at which the message is transmitted or received on the interface between the first and second IAB nodes.

36. The method of claim 33, wherein the signaling is radio resource control signaling, and wherein the message is a medium access control (MAC) message.

37. The method of claim 33, wherein the multiplexing IAB node is the first IAB node, wherein the method further comprises, based on or according to the value of the multiplexing adaptation parameter to which the value of the field included in the message is mapped, adapting in which multiplexing mode the first IAB node operates.

38. The method of claim 33, wherein the multiplexing adaptation parameter is an association parameter indicating one or more indices of one or more time slots associated with a condition that has been applied, or that is requested to be applied, in order for the multiplexing IAB node to operate in a multiplexing mode.

39. The method of claim 38, wherein the multiplexing IAB node comprises a mobile termination (MT) and a distributed unit (DU), and wherein the condition is:
restriction of simultaneous transmission at the multiplexing IAB node in the direction of one or more beams of the DU;
use of one or more specified beams by the MT for communication on the parent IAB link;
adjustment of a downlink transmission power by the parent IAB node;
power spectral density (PSD) of the MT being within a specified range;
use of certain timing modes in certain respective time slots; or
a combination of any two or more of the above.

40. The method of claim 33, wherein the multiplexing adaptation parameter is a condition parameter indicating a condition that has been applied, or that is requested to be applied, in order for the multiplexing IAB node to operate in a multiplexing mode, wherein the multiplexing IAB node comprises a mobile termination (MT) and a distributed unit (DU), wherein the condition is:
restriction of simultaneous transmission at the multiplexing IAB node in the direction of one or more beams of the DU;
use of one or more specified beams by the MT for communication on the parent IAB link;
adjustment of a downlink transmission power by the parent IAB node;
power spectral density (PSD) of the MT being within a specified range;
use of certain timing modes in certain respective time slots; or
a combination of any two or more of the above.

41. The method of claim 33, wherein the message is a first message, wherein the method further comprises:
receiving, from the IAB donor, signaling that changes which one or more possible values of the field are mapped to which one or more possible values of the multiplexing adaptation parameter; and
transmitting to, or receiving from, the second IAB node a second message that includes the field set to one of the one or more possible values of the field as changed by the signaling.

42. The method of claim 33, wherein the parent IAB link is a link between the multiplexing IAB node and a parent IAB node, wherein the child IAB link is a link between the multiplexing IAB node and a child IAB node, wherein the multiplexing IAB node is capable of operating in any one of multiple possible multiplexing modes, wherein the multiple possible multiplexing modes include two or more of:
a time-domain multiplexing (TDM) mode in which the multiplexing IAB node uses TDM to multiplex communication by the MT on the parent IAB link towards the parent IAB node with communication by the DU on the child IAB link towards the child IAB node;
a frequency-domain multiplexing (FDM) mode in which the multiplexing IAB node uses FDM to multiplex communication by the MT on the parent IAB link towards the parent IAB node with communication by the DU on the child IAB link towards the child IAB node;
a spatial-domain multiplexing (SDM) mode in which the multiplexing IAB node uses SDM to multiplex communication by the MT on the parent IAB link towards the parent IAB node with communication by the DU on the child IAB link towards the child IAB node; and
a combination mode in which the multiplexing IAB node uses a combination of two or more of TDM, FDM, and SDM to multiplex communication by the MT on the parent IAB link towards the parent IAB node with communication by the DU on the child IAB link towards the child IAB node.

43. A method performed by an integrated access backhaul (IAB) donor, the method comprising:
transmitting, to a first IAB node and/or a second IAB node, signaling that indicates which one or more possible values of a field are mapped to which one or more possible values of a multiplexing adaptation parameter, wherein the multiplexing adaptation parameter governs adaptation of in which multiplexing mode, if any, a multiplexing IAB node operates for multiplexing communication on a parent IAB link with communication on a child IAB link, and wherein the field is a field of a message on an interface between the first IAB node and the second IAB node.

44. The method of claim 43, wherein the one or more possible values of the multiplexing adaptation parameter to which the one or more possible values of the field are mapped comprise a subset of a set of multiple possible values of the multiplexing adaptation parameter.

45. The method of claim 43, wherein the signaling is upper layer signaling transmitted at an upper layer of a protocol stack, wherein the upper layer is above a layer at which the message is transmitted or received on the interface between the first and second IAB nodes.

46. The method of claim 43, wherein the signaling is radio resource control signaling, and wherein the message is a medium access control (MAC) message.

47. The method of claim 43, wherein the multiplexing adaptation parameter is an association parameter indicating one or more indices of one or more time slots associated with a condition that has been applied, or that is requested to be applied, in order for the multiplexing IAB node to operate in a multiplexing mode.

48. The method of claim 47, wherein the multiplexing IAB node comprises a mobile termination (MT) and a distributed unit (DU), and wherein the condition is:
restriction of simultaneous transmission at the multiplexing IAB node in the direction of one or more beams of the DU;
use of one or more specified beams by the MT for communication on the parent IAB link;
adjustment of a downlink transmission power by the parent IAB node;
power spectral density (PSD) of the MT being within a specified range;
use of certain timing modes in certain respective time slots; or
a combination of any two or more of the above.

49. A first integrated access backhaul (IAB) node, the first IAB node comprising:
communication circuitry; and
processing circuitry configured to:
receive, from an IAB donor, signaling that indicates which one or more possible values of a field are mapped to which one or more possible values of a multiplexing adaptation parameter, wherein the multiplexing adaptation parameter governs adaptation of in which multiplexing mode, if any, a multiplexing IAB node operates for multiplexing communication on a parent IAB link with communication on a child IAB link; and
transmit to, or receiving from, a second IAB node a message that includes the field set to one of the one or more possible values of the field indicated by the signaling, wherein the multiplexing IAB node is the first IAB node or the second IAB node.

50. The first IAB node of claim 49, wherein the one or more possible values of the multiplexing adaptation parameter to which the one or more possible values of the field are mapped comprise a subset of a set of multiple possible values of the multiplexing adaptation parameter.

51. An integrated access backhaul (IAB) donor, the IAB donor comprising:
communication circuitry; and
processing circuitry configured to transmit, to a first IAB node and/or a second IAB node, signaling that indicates which one or more possible values of a field are mapped to which one or more possible values of a multiplexing adaptation parameter, wherein the multiplexing adaptation parameter governs adaptation of in which multiplexing mode, if any, a multiplexing IAB node operates for multiplexing communication on a parent IAB link with communication on a child IAB link, and wherein the field is a field of a message on an interface between the first IAB node and the second IAB node.

52. The IAB donor of claim 51, wherein the one or more possible values of the multiplexing adaptation parameter to which the one or more possible values of the field are mapped comprise a subset of a set of multiple possible values of the multiplexing adaptation parameter.
